(19) United States
(12) Patent Application Publication
(10) Pub. No.: US 2025/0209297 A1
(43) Pub. Date: Jun. 26, 2025

(54) CHATBOT PLATFORM

(71) Applicant: Intercom, Inc., San Francisco, CA (US)

(72) Inventors: Fergal Charles REID, San Francisco, CA (US); Mario KOSTELAC, San Francisco, CA (US); David BRODIGAN, San Francisco, CA (US); Molly MAHAR, San Francisco, CA (US)

(21) Appl. No.: 18/990,937

(22) Filed: Dec. 20, 2024

Related U.S. Application Data
(60) Provisional application No. 63/564,879, filed on Mar. 13, 2024.
(60) Provisional application No. 63/613,969, filed on Dec. 22, 2023.
(60) Provisional application No. 63/705,435, filed on Oct. 9, 2024.

(51) Int. Cl. G06N 3/006; G06N 3/042

(52) U.S. Cl. CPC G06N 3/006; G06N 3/042

(57) ABSTRACT

Technology is disclosed for programmatically implementing a chatbot that utilizes a language model to determine answers from a knowledge base or external resource. In one implementation, a conversation with a user is accessed. A representation summarizing the conversation is generated based on applying the conversation to a language model. An embedding corresponding to the representation is generated. A response is determined based on computing similarity of the embedding corresponding to the representation to embeddings corresponding to sentences of documents in a knowledge base. A corresponding representation of the response is communicated to the user. In one implementation, in response to a user input received in the conversation, an external resource, such as a third-party website or application is accessed and chatbot output is generated in response to a user input in a chat session.

### CROSS-REFERENCE TO RELATED APPLICATIONS

This application claims the benefit of U.S. Provisional Application No. 63/564,879, filed on Mar. 13, 2024. The entire contents of which are incorporated herein.

### BACKGROUND

Chatbots are a useful tool to help customer support teams. For example, chatbots can include rules to route users to correct units of customer support/success organizations. As another example, chatbots can directly handle simple user queries based on explicit rules where a specific intent (e.g., a distinct user goal or request in the query) can be identified in the query. However, in order to implement chatbots that can directly handle simple user queries, chatbots require a significant amount of configuration prior to implementation.

### SUMMARY

Various aspects of the technology described herein are generally directed to systems, methods, and computer storage media for, among other things, programmatically implementing a specialized chatbot platform that uses language models to determine answers from semantically similar documents of knowledge bases. In this regard, embodiments described herein facilitate using a language model to determine aspects of a conversation with a user in order to compute the semantic similarity of the conversation to answers provided in documents of a knowledge base (e.g., manually curated files, historical conversation files, extracted snippets from conversations, Uniform Resource Locators (“URLs”), and/or any other data within a knowledge base). For example, aspects of a conversation, such as a query occurring within the conversation or a summary of the conversation or portions thereof, can be programmatically identified and extracted from conversations between a user (e.g., an existing customer, a potential customer or any individual providing questions to customer support) and a chatbot. The similarity of sentence embeddings between the aspects of the conversation and sentences of documents in the knowledge base can be computed in order to determine whether the answer within a threshold semantic similarity is provided in a document in the database. The language model can then utilize the semantically similar document(s) in the database to generate an answer to the user query through the chatbot.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an example computing system in which one or more embodiments of the present disclosure can be practiced, in accordance with various embodiments of the present disclosure;

FIG. 2 depicts an example diagram of a model implementing a specialized chatbot platform that uses language models to determine answers from knowledge bases, in accordance with various embodiments of the present disclosure;

FIG. 3 depicts an example diagram of a model implementing a start state agent of a specialized chatbot platform that uses a language model to determine answers from a knowledge base, in accordance with various embodiments of the present disclosure;

FIG. 4 depicts an example diagram of a model implementing an answer search component of a specialized chatbot platform that uses language models to determine answers from knowledge bases, in accordance with various embodiments of the present disclosure;

FIG. 5 depicts an example diagram of a model implementing a feedback state agent of a specialized chatbot platform that uses a language model to determine answers from a knowledge base, in accordance with various embodiments of the present disclosure;

FIG. 6A provides an example chat interface between a chatbot and a user, in accordance with embodiments of the present disclosure;

FIG. 6B provides an example chat interface between a chatbot and a user showing the delivery of responses word by word from the chatbot to the user, in accordance with embodiments of the present disclosure;

FIG. 6C provides an example chat interface between a chatbot and a user showing a response from the chatbot with a corresponding source of the response, in accordance with embodiments of the present disclosure;

FIG. 6D provides an example chat interface between a chatbot and a user showing responses from the chatbot including a request for feedback, request for clarification, and a response with a prompt to route to a human, in accordance with embodiments of the present disclosure;

FIG. 6E provides an example chat interface between a chatbot and a user showing a response from the chatbot that routes the chat with the user to a human, in accordance with embodiments of the present disclosure;

FIG. 6F depicts an example diagram of a specialized chatbot platform facilitating the handling of multimedia input in the end-user input, in accordance with various embodiments of the present disclosure;

FIG. 6G depicts an example diagram of a specialized chatbot platform facilitating the handling of multimedia input in the ingested content, in accordance with various embodiments of the present disclosure;

FIG. 6H depicts another example diagram of a specialized chatbot platform facilitating the handling of multimedia input in the end-user input, in accordance with various embodiments of the present disclosure;

FIG. 6I depicts an example diagram of a specialized chatbot platform facilitating the augmenting of the user context utilizing data from external systems, in accordance with various embodiments of the present disclosure;

FIG. 6J depicts another example diagram of a specialized chatbot platform facilitating the augmenting of the user context utilizing data from external systems, in accordance with various embodiments of the present disclosure;

FIG. 6K depicts another example diagram of a specialized chatbot platform facilitating the augmentation of the user context utilizing data from external systems, in accordance with various embodiments of the present disclosure;

FIGS. 6L, 6M, and 6N, depict aspects of another example diagram of a specialized chatbot platform facilitating the augmentation of the user context utilizing data from external systems, in accordance with various embodiments of the present disclosure;

FIG. 7A provides an example interface of a customer support application, including, among other things, an inbox and a chat interface, in accordance with embodiments of the present disclosure;

FIG. 7B provides an example chat interface of a customer support application, including an AI-assisted chat tool, in accordance with embodiments of the present disclosure;

FIG. 7C provides an example chat interface of a customer support application implementing the AI-assisted chat tool on the chat interface of FIG. 7B, in accordance with embodiments of the present disclosure;

FIG. 7D provides an example chat interface of a customer support application implementing an AI-assisted chat tool to search for answers in knowledge base using a language model, in accordance with embodiments of the present disclosure;

FIG. 7E provides an example interface for adding a conversational snippet from a communication record to a knowledge base, in accordance with embodiments of the present disclosure;

FIG. 8A provides an example interface of a chatbot tool of a customer support application, in accordance with embodiments of the present disclosure;

FIG. 8B provides an example interface of an audience selection tool of a chatbot tool of a customer support application, in accordance with embodiments of the present disclosure;

FIG. 8C provides another example interface of an audience selection tool of a chatbot tool of a customer support application, in accordance with embodiments of the present disclosure;

FIG. 8D provides an example interface of a content management tool of a chatbot tool of a customer support application, in accordance with embodiments of the present disclosure;

FIG. 8E provides an example interface of a communication channel selection tool of a chatbot tool of a customer support application, in accordance with embodiments of the present disclosure;

FIG. 8F provides an example interface of a chatbot behavior settings tool of a chatbot tool of a customer support application, in accordance with embodiments of the present disclosure;

FIG. 8G provides another example interface of a chatbot behavior settings tool of a chatbot tool of a customer support application, in accordance with embodiments of the present disclosure;

FIG. 8H provides an example interface of a custom answers tool of a chatbot tool of a customer support application, in accordance with embodiments of the present disclosure;

FIG. 8I provides an example interface of a chatbot introduction customization tool and a language settings tool of a chatbot tool of a customer support application, in accordance with embodiments of the present disclosure;

FIG. 8J provides an example interface of a chatbot identity customization tool of a chatbot tool of a customer support application, in accordance with embodiments of the present disclosure;

FIG. 8K provides an example interface of a scheduling tool of a chatbot tool of a customer support application, in accordance with embodiments of the present disclosure;

FIG. 8L provides an example interface of a chat workflow design tool of a chatbot tool of a customer support application for setting up a handover from the chatbot to human support, in accordance with embodiments of the present disclosure;

FIG. 8M provides another example interface of a chat workflow design tool of a chatbot tool of a customer support application for setting up a handover from the chatbot to a chat workflow, in accordance with embodiments of the present disclosure;

FIG. 8N provides another example interface of a chat workflow design tool of a chatbot tool of a customer support application for designing a chat workflow, in accordance with embodiments of the present disclosure;

FIG. 8O provides another example interface of a chat workflow design tool of a chatbot tool of a customer support application for designing a chat workflow that implements the chatbot at a later block in the chat workflow instead of an initial block of a chat workflow, in accordance with embodiments of the present disclosure;

FIG. 8P provides an example interface of an inactive conversations settings tool of a chat workflow design tool of a chatbot tool of a customer support application for designing a chat workflow, in accordance with embodiments of the present disclosure;

FIG. 8Q provides an example chat interface between a chatbot and a user showing a request for feedback, in accordance with embodiments of the present disclosure;

FIG. 8R provides an example interface of output from a chatbot analysis tool of a chatbot tool of a customer support application, in accordance with embodiments of the present disclosure;

FIG. 8S provides another example interface of output from a chatbot analysis tool of a chatbot tool of a customer support application, in accordance with embodiments of the present disclosure;

FIG. 8T provides another example interface of a chatbot analysis tool of a chatbot tool of a customer support application, in accordance with embodiments of the present disclosure;

FIG. 8U provides another example interface of output from a chatbot analysis tool of a chatbot tool of a customer support application, in accordance with embodiments of the present disclosure;

FIG. 8V provides another example interface of output from a chatbot analysis tool of a chatbot tool of a customer support application, in accordance with embodiments of the present disclosure;

FIG. 8W provides another example interface of output from a chatbot analysis tool of a chatbot tool of a customer support application, in accordance with embodiments of the present disclosure;

FIG. 8X provides another example interface of output from a chatbot analysis tool of a chatbot tool of a customer support application, in accordance with embodiments of the present disclosure;

FIG. 8Y provides another example interface of output from a chatbot analysis tool of a chatbot tool of a customer support application, in accordance with embodiments of the present disclosure;

FIG. 8Z provides another example interface of output from a chatbot analysis tool of a chatbot tool of a customer support application, in accordance with embodiments of the present disclosure;

FIG. 8AA provides another example interface of output from a chatbot analysis tool of a chatbot tool of a customer support application, in accordance with embodiments of the present disclosure;

FIG. 8BB provides another example interface of output from a chatbot analysis tool of a chatbot tool of a customer support application, in accordance with embodiments of the present disclosure;

FIG. 8CC provides an example interface for general guidance of a chatbot tool of a customer support application, in accordance with embodiments of the present disclosure;

FIG. 8DD provides an example interface for external systems configuration of a chatbot tool of a customer support application, in accordance with embodiments of the present disclosure;

FIG. 8EE provides an example interface for tone of voice configuration of a chatbot tool of a customer support application, in accordance with embodiments of the present disclosure;

FIG. 9 is a flow diagram showing a method for implementing a specialized chatbot platform that uses language models to determine answers from knowledge bases, in accordance with embodiments of the present disclosure;

FIG. 10 is a flow diagram showing a method for implementing a chatbot using a language model to determine a subset of documents from a knowledge base in response to a user's query, in accordance with embodiments of the present disclosure;

FIG. 11 is a flow diagram showing a method for implementing a specialized chatbot platform that uses language models to determine answers from knowledge bases and handing off the conversation to a human, in accordance with embodiments of the present disclosure;

FIG. 12 is a flow diagram showing a method for implementing a specialized chatbot platform that uses language models to determine answers from knowledge bases based on customer data of the user, in accordance with embodiments of the present disclosure;

FIG. 13 is a flow diagram showing a method for using a language model to extract conversational snippets, in accordance with embodiments of the present disclosure; and

FIG. 14 is a block diagram of an example computing device in which embodiments of the present disclosure can be employed.

### DETAILED DESCRIPTION

### Overview

Chatbots are a useful tool to help customer support teams. For example, chatbots can include rules to route users to correct units of customer support/success organizations. As another example, chatbots can directly handle simple user queries based on explicit rules where a specific intent (e.g., a distinct user goal or request in the query) can be identified in the query. However, in order to implement chatbots that can directly handle simple user queries, chatbots require a significant amount of configuration prior to implementation.

For example, in order to configure intent so that a specific intent can be identified, examples of previous user interactions representing the specific problem/intent must be manually curated by a developer so that the rules or patterns associated with the intent can be manually input into the system. The developer must then manually hard code the response that the chatbot delivers once the intent is identified. In this regard, after the intents and associated responses of the chatbot are configured, the developer must continually update the intents and responses to match up-to-date knowledge and policies.

Currently, in order to implement a chatbot, humans, such as a developer, must manually configure intents through predefined rules or patterns associated with specific user queries and must manually define the response to the intent. In this regard, a human must manually curate examples of user interactions to match the intent, manually define the rules or patterns for each intent, manually write predefined responses to the intent, and manually update each intent to match any changes to the intent and/or predefined responses. Accordingly, unnecessary computing resources are utilized during the manually intensive process of defining intents and/or responses in conventional implementations. For example, the increase in the number of computer input/output operations related to the manually intensive process of defining intents and/or responses is computationally intensive and unnecessarily consumes computing resources. Similarly, when the information is located over a network, network resources are unnecessarily consumed, thereby decreasing throughput, increasing latency, and increasing packet generation costs.

As such, embodiments of the present disclosure are directed to programmatically implementing a specialized chatbot platform that uses language models to determine answers from semantically similar documents of knowledge bases in an efficient and effective manner. In this regard, a language model can be efficiently and effectively utilized by a specialized chatbot platform in order to retrieve answers to queries from customers from an existing knowledge base without having to manually curate examples of user interactions to match the intent, manually define the rules or patterns for each intent, manually write predefined responses to the intent, and manually update each intent to match any changes to the intent and/or predefined responses.

Generally, and at a high level, embodiments described herein facilitate programmatically implementing a specialized chatbot platform that uses language models to determine answers from semantically similar documents of knowledge bases. In this regard, embodiments described herein facilitate using a language model to determine aspects of a conversation with a user in order to compute the semantic similarity of the conversation to answers provided in documents of a knowledge base (e.g., manually curated files, historical conversation files, extracted snippets from conversations, Uniform Resource Locators (“URLs”), and/or any other data within a knowledge base). The user may comprise a customer interacting with the chatbot platform, such as a user visiting a website or app and engaging in a chat session with a chatbot, or a customer support agent (“CSA”). For example, aspects of a conversation, such as a query occurring within the conversation or a summary of the conversation or portions thereof, can be programmatically identified and extracted from conversations between a user (e.g., an existing customer, a potential customer or any individual providing questions to customer support) and a chatbot. The similarity of sentence embeddings between the aspects of the conversation and sentences of documents in the knowledge base can be computed in order to determine whether the answer within a threshold semantic similarity is provided in a document in the database. The language model can then utilize the semantically similar document(s) in the database to generate an answer to the user query through the chatbot.

In some embodiments, the specialized chatbot platform, utilizing prompts to the language model, disambiguates (e.g., request clarification of) the question and answers user questions only if the question and answers are relevant to the domain of the business and can be answered from sources provided by a business implementing the chatbot. In some embodiments, utilizing prompts to the language model, the specialized chatbot platform is able to determine when the user wants to talk to a human, and escalates to the human, such as a CSA (e.g., or any support personnel). In some embodiments, the specialized chatbot platform collects feedback from users on their interactions to understand whether the delivered answer was useful and to generate reports presenting metrics regarding the implementation of the chatbot.

Advantageously, efficiencies of computing and network resource utilization can be enhanced using implementations described herein. In particular, the use of a language model by a specialized chatbot platform in order to retrieve answers to queries from customers from semantically similar documents of an existing knowledge base provides for a more efficient use of computing and network resources than conventional methods of manually curating examples of user interactions to match the intent, manually defining the rules or patterns for each intent, manually writing predefined responses to the intent, and manually updating each intent to match any changes to the intent and/or predefined responses. The technology described herein decreases the number of computer input/output operations related to otherwise manually intensive process of manually defining intents and/or responses, thereby decreasing computation costs and decreasing network resource utilization (e.g., higher throughput, lower latency, and decreasing packet generation costs due to fewer packets being sent) when the information is located over a computer network.

### Example Embodiments of Chatbot Communication Environments

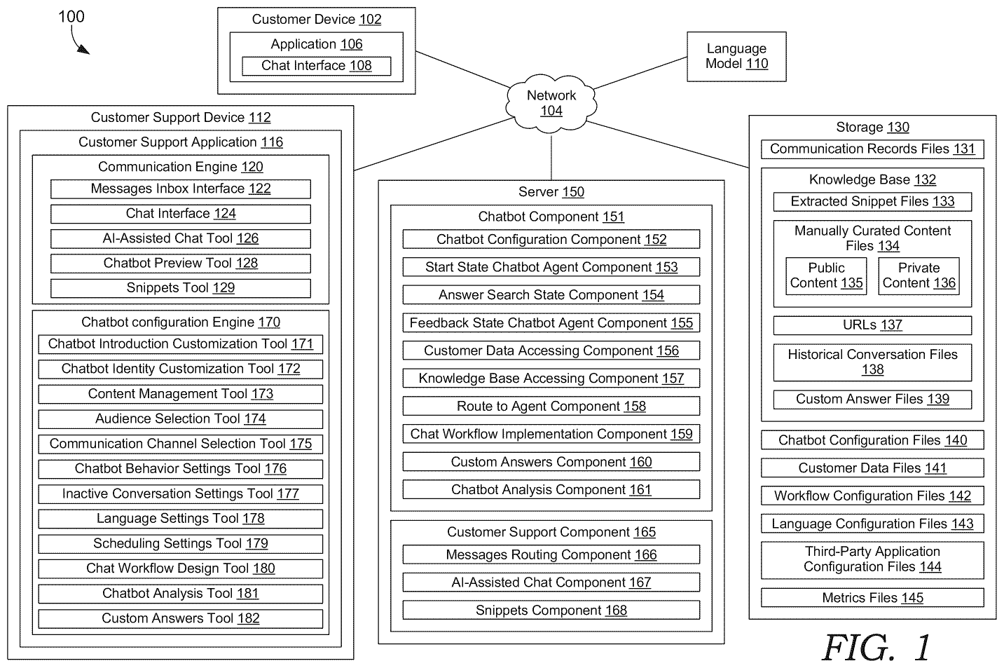

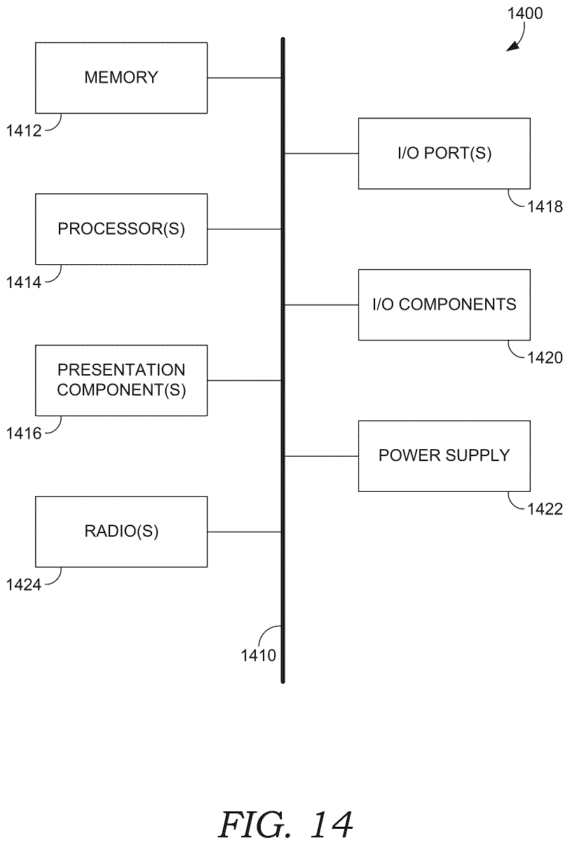

Turning to FIG. 1, a block diagram of example system architecture 100 suitable for use in implementing embodiments of the disclosure is shown. Generally, system architecture 100 is suitable for, among other things, facilitating conversations between a customer (e.g., an existing customer, a potential customer or any individual providing questions to customer support), a chatbot (e.g., as implemented by chatbot component 151) and/or a CSA (e.g., or any support personnel), facilitating configuration of a chatbot for communication with customers, facilitating configuration of a knowledge base of the chatbot, such as knowledge base 132 of FIG. 1, facilitating the design of chat workflows for customers, and facilitating the analysis of chatbot conversations. System architecture 100 includes customer device 102, customer support device 112, and server 150. In various embodiments, customer device 102, customer support device 112, and/or server 150 are any kind of computing device, such as computing device 1400 described below with reference to FIG. 14. Examples of computing devices include a personal computer (PC), a laptop computer, a mobile or mobile device, a smartphone, a tablet computer, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, some combination thereof, or any other suitable computer device.

In various implementations, the components of system architecture 100 include computer storage media that stores information including data, data structures, computer instructions (e.g., software program instructions, routines, or services), and/or models (e.g., machine learning models) used in some embodiments of the technologies described herein. For example, in some implementations, customer device 102, customer support device 112, language model 110, server 150, and/or storage 130 may comprise one or more data stores (or computer data memory). Further, although customer device 102, customer support device 112, server 150, language model 110, and storage 130 are each depicted as a single component in FIG. 1, in some embodiments, customer device 102, customer support device 112, server 150, language model 110, and/or storage 130 are implemented using any number of data stores, and/or are implemented using cloud storage.

The components of system architecture 100 communicate with each other via a network 104. In some embodiments, network 104 includes one or more local area networks (LANs), wide area networks (WANs), and/or other networks. Such networking environments are commonplace in offices, enterprise-wide computer networks, intranets, and the Internet.

In the example illustrated in FIG. 1, customer device 102 includes application 106, customer support device 112 includes customer support application 116, and server 150 includes chatbot component 151 and customer support component 165. In various embodiments, application 106, customer support application 116, chatbot component 151, customer support component 165, and/or any of the elements illustrated in FIG. 1 are incorporated, or integrated, into an application(s) (e.g., a corresponding application on customer device 102, customer support device 112, and/or server 150, respectively), or an add-on(s) or plug-in(s) to an application(s). In some embodiments, the application(s) 106 and/or 116 is any application capable of facilitating a chat between a customer, a chatbot (e.g., chatbot component 151), and/or a CSA, such as a stand-alone application, a mobile application, a web application, and/or the like. In some implementations, the application(s) 106 and/or 116 comprises a web application, for example, that may be accessible through a web browser, hosted at least partially server-side, and/or the like.

In various embodiments, the functionality described herein is allocated across any number of devices. In some embodiments, application(s) 106 and/or 116 are hosted at least partially server-side, such that chat interface 108, communication tool 120, chatbot tool 170, chatbot component 151, customer support component 165, and/or any of the elements illustrated in FIG. 1 coordinate (e.g., via network 104) to perform the functionality described herein. In another example, communication tool 120, chatbot tool 170, chatbot component 151, customer support component 165, and/or any of the elements illustrated in FIG. 1 (or some portion thereof) are integrated into a common application executable on a single device. Although some embodiments are described with respect to an application(s), in some embodiments, any of the functionality described herein is additionally or alternatively integrated into an operating system (e.g., as a service), a server (e.g., a remote server), a distributed computing environment (e.g., as a cloud service), and/or otherwise. These are just examples, and any suitable allocation of functionality among these or other devices may be implemented within the scope of the present disclosure. For example, some embodiments of system architecture 100 comprise a multi-agent system (MAS) that may include one or more physically or logically distributed agents operating on the computer system of system architecture 100. An agent comprises an autonomous (or semi-autonomous) program capable of perceiving its environment, making decisions based on its observations, and performing actions to achieve specific goals, either independently or in collaboration with other agents. Accordingly, in some embodiments, various components or subcomponents of system architecture 100 are implemented as agents in a MAS.

An example workflow of the configuration illustrated in FIG. 1 includes customer device 102, such as a desktop, laptop, or mobile device such as a tablet or smart phone, and application 106 provides one or more user interfaces. A customer accesses application 106, such as a web browser or mobile application, and navigates to a website or application of a business. The customer navigates to a chat interface 108 through application 106 allowing the customer to chat with a chatbot and/or customer support of the business. In this regard, the customer is able to communicate with the business, such as through a chatbot associated with the business via chatbot component 151 and/or a CSA of the business (e.g., where the CSA utilizes a corresponding chat interface 124 of the customer support device 112). In some embodiments, the chat interface 108 of application 106 may be implemented through an application programming interface (API), software development kit (SDK), webhooks, and/or the like of chatbot component 151 and/or customer support component 165. In some embodiments, chat interface 108 is an application, such as a React.js application, that is embedded into application 106.

Customer support device 112 is a desktop, laptop, or mobile device such as a tablet or smart phone, and application 116 provides one or more user interfaces. In some embodiments, an end user, such as a CSA of the business, chats, or accesses a chat (e.g., a conversation with the customer), with a customer through chat interface 124 of communication tool 120. Additionally or alternatively, a chatbot via chatbot component 151 chats, or accesses a chat (e.g., a conversation) with a customer through chat interface 108 of application 106 and an end user, such as a CSA of the business, chats, or accesses a chat between the chatbot and the customer through chat interface 124 of communication tool 120.

In some embodiments, chatbot component 151 facilitates programmatically implements a specialized chatbot platform that uses language models to determine answers from semantically similar documents of knowledge bases. For example, chatbot component 151 facilitates using a language model 110 to determine aspects of a conversation with a user in order to compute the semantic similarity of the conversation to answers provided in documents of a knowledge base 132 (e.g., extracted snippet files 133, manually curated files 134, such as public content 135 and/or private content 136, URLs 137, historical conversation files 138, and/or the like) and provide responses to the customer through chat interface 108.

In some embodiments, chatbot component 151 facilitates providing multimodal responses to the customer through chat interface 108. For example, chatbot component 151 facilitates using language model 110 as a multimodal language model to determine semantically similar images, audio, and/or video provided in documents of a knowledge base 132 (e.g., images, audio, and/or video stored in extracted snippet files 133, manually curated files 134, such as public content 135 and/or private content 136, URLs 137, historical conversation files 138, and/or the like). In another example, chatbot component 151 facilitates providing responses that include images, audio, and/or video that are included in the semantically similar answers of documents of a knowledge base 132. In another example, chatbot component 151 can provide responses that include images, audio, and/or video, generated by language model 110 where the language model is a multimodal generative language model.

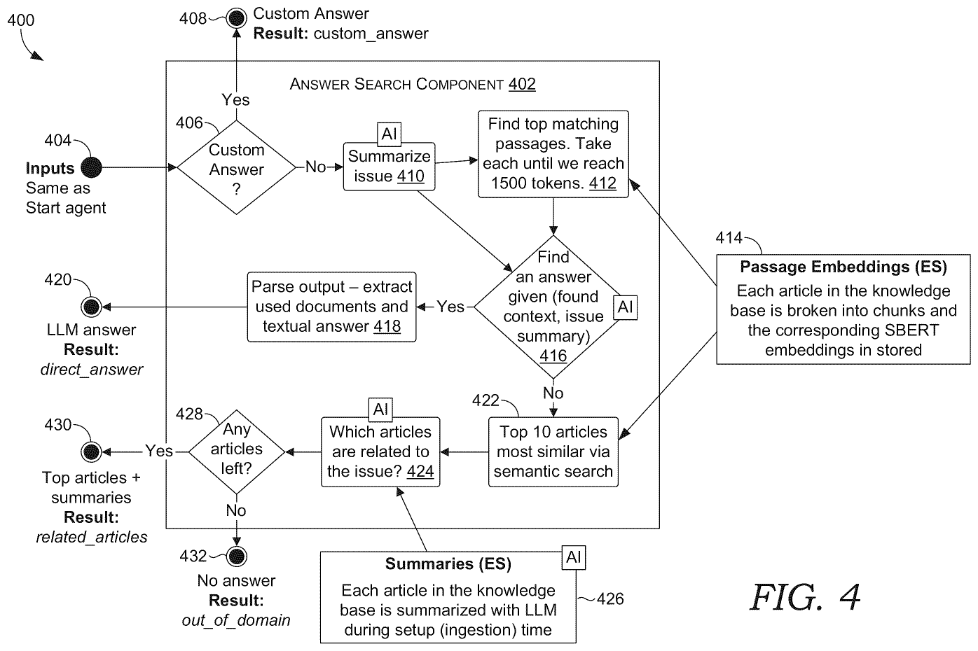

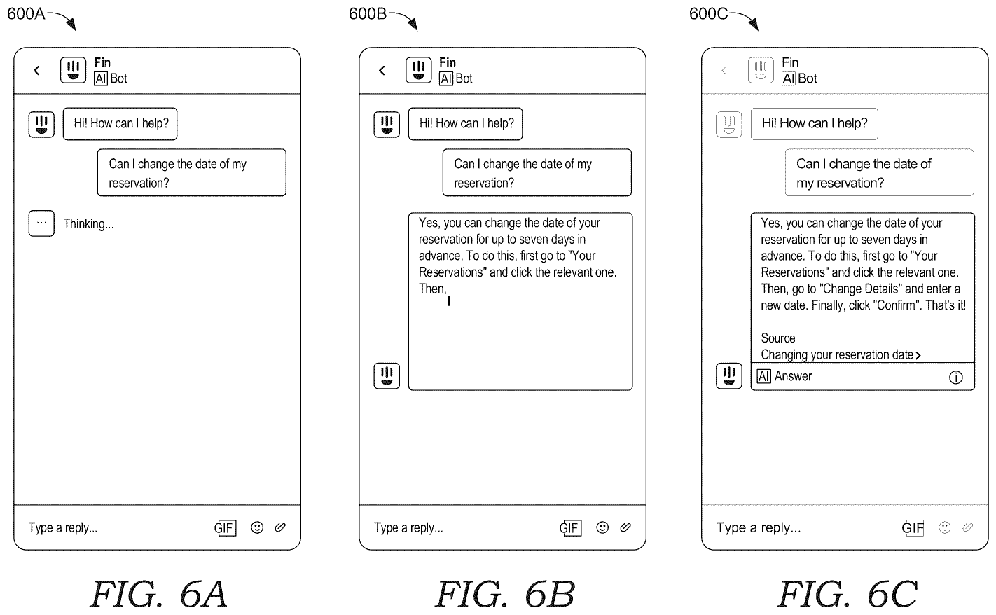

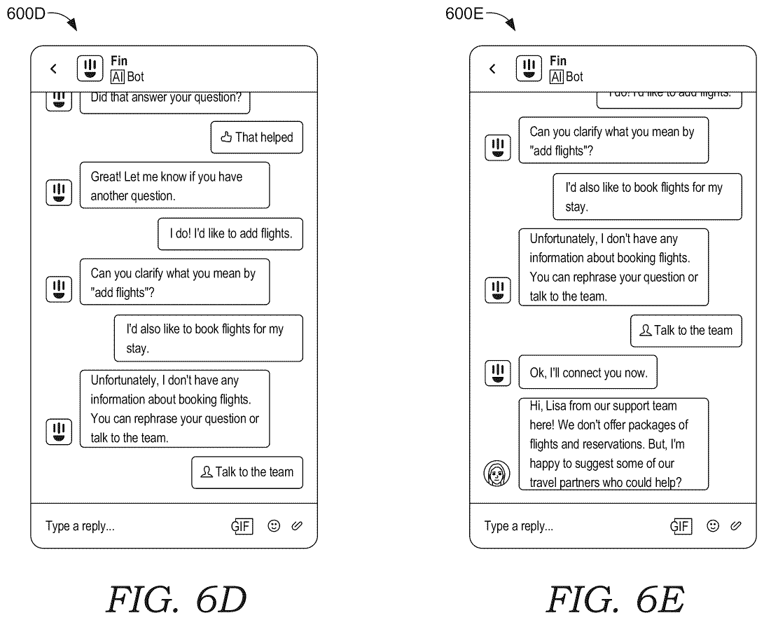

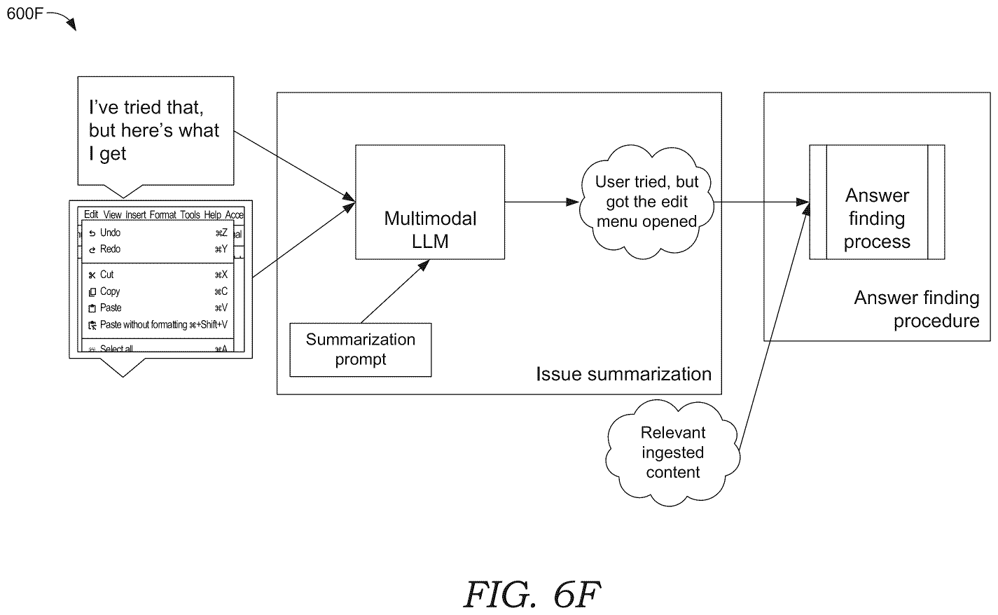

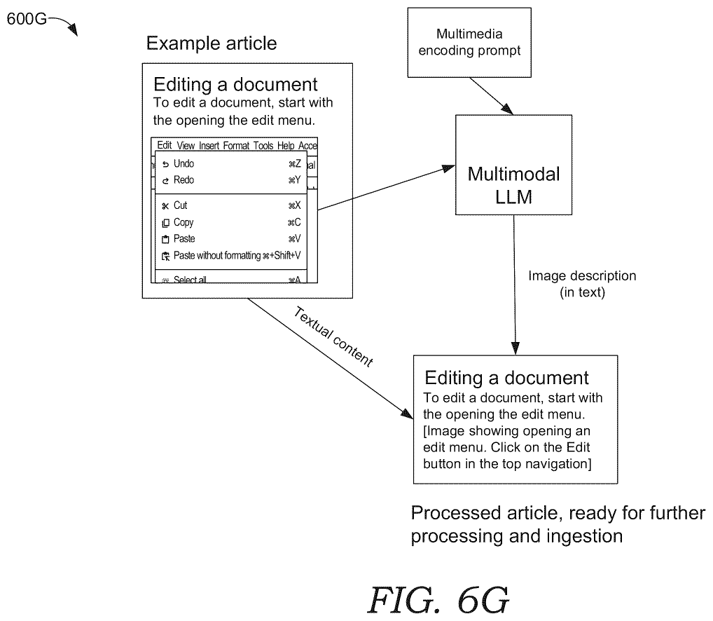

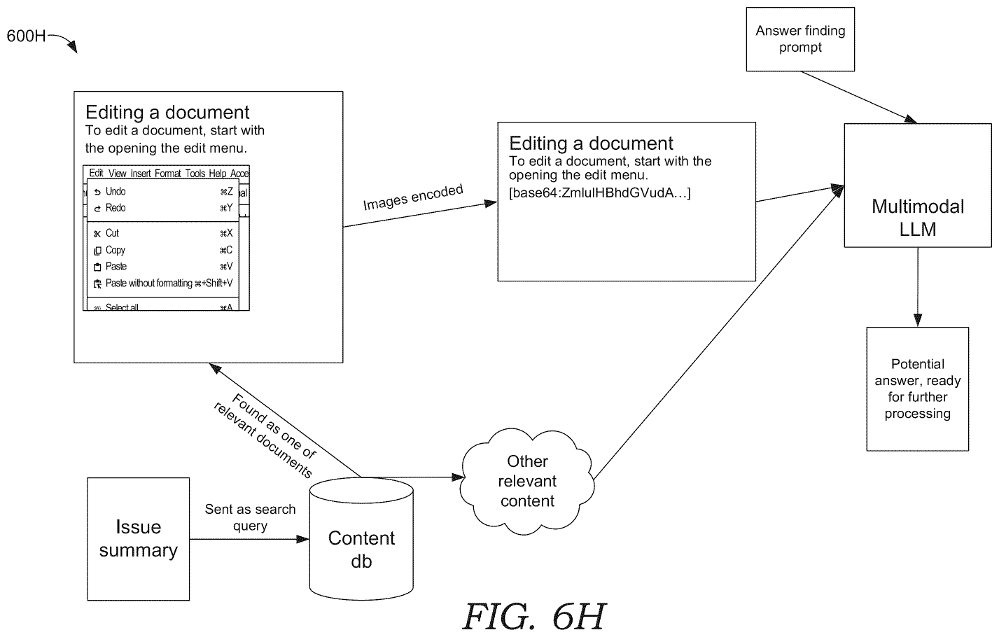

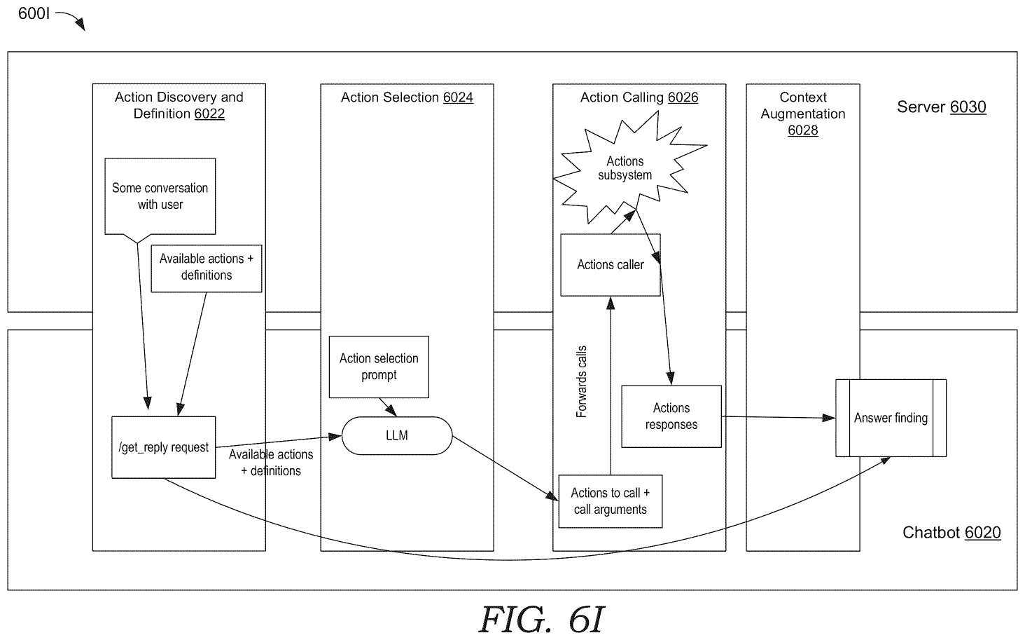

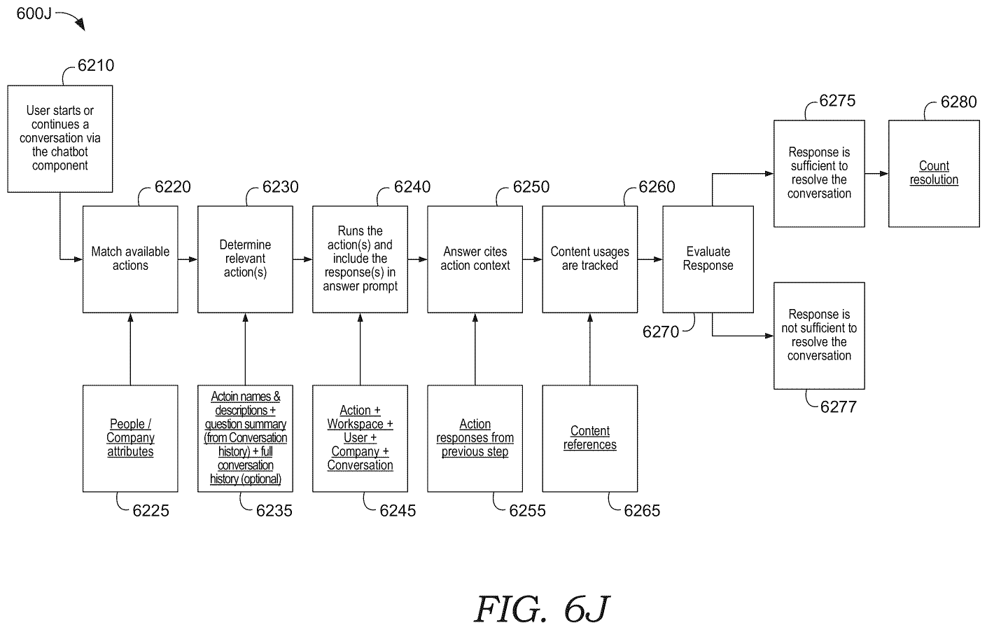

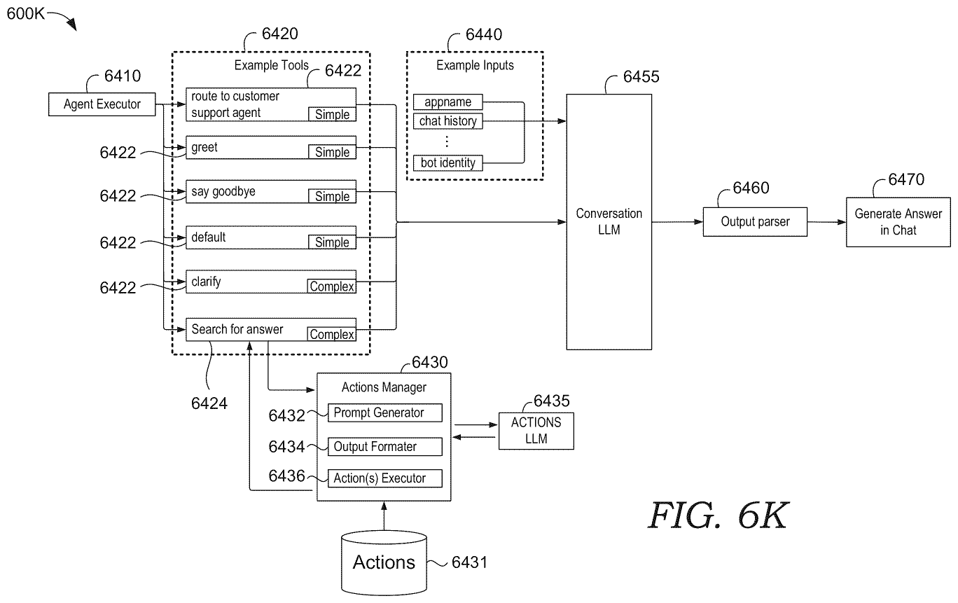

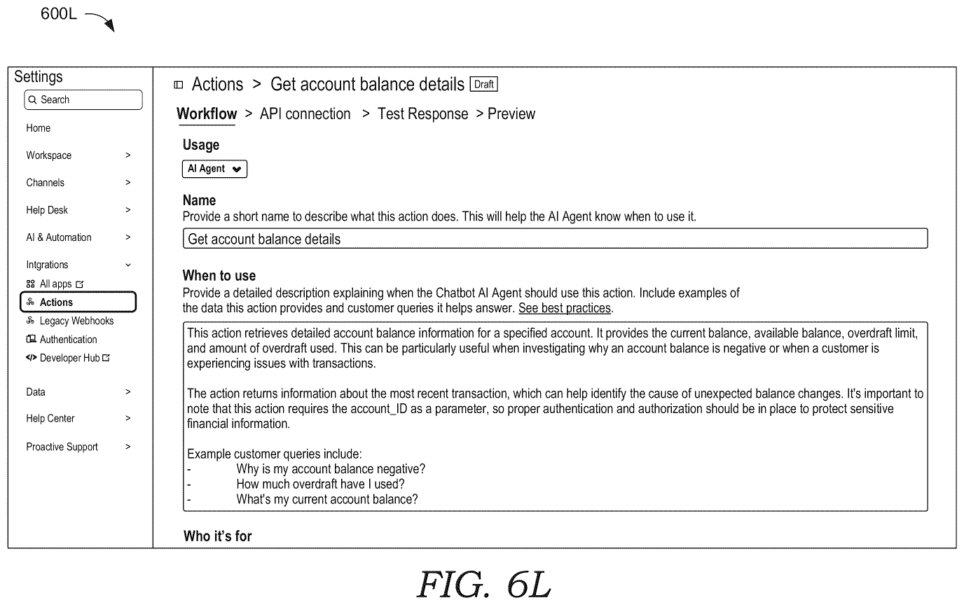

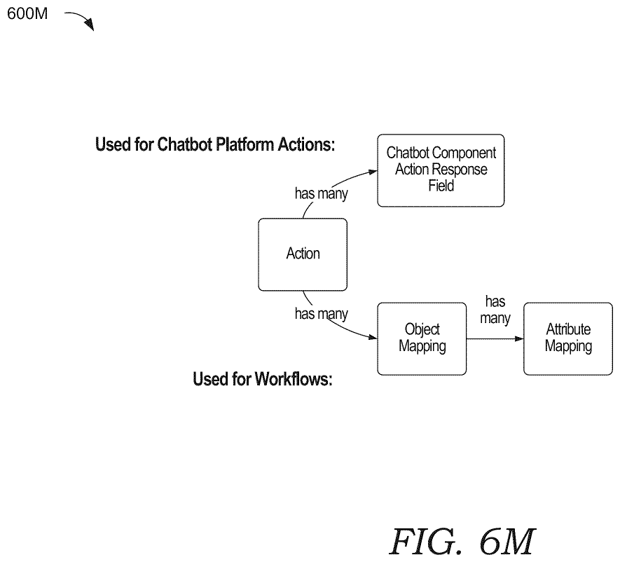

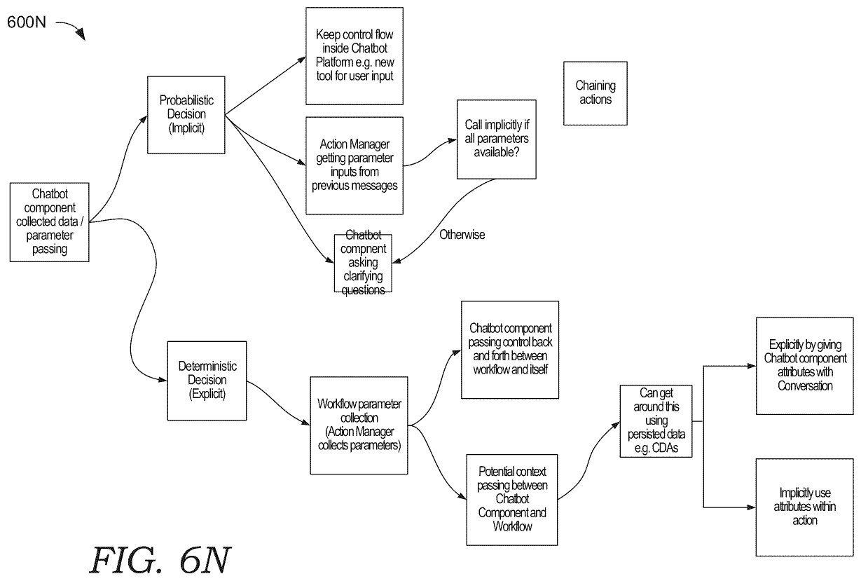

In some embodiments, chatbot component 151 facilitates handling multimedia input (e.g., images, videos, gifs, voice notes, etc.), both in the ingested content and/or as the end-user input. An example of chatbot component 151 facilitating the handling of multimedia input in the end-user input is shown in diagram 600F of FIG. 6F. As shown in diagram 600F, handling the multimedia in the end-user input can be performed during the issue summary phase (e.g., as described with respect to answer search state component 154 of FIG. 1, block 410 of FIG. 4, etc.). For example, when an end-user sends a message with some multimedia (e.g., with or without additional text), the multimedia (e.g., and/or additional text) is sent to a multimodal language model, such as a large language model (LLM) to generate a textual representation of the user issue, which is then fed into the rest of the pipeline (e.g., as described with respect to answer search state component 154 of FIG. 1).

An example of chatbot component 151 facilitating the handling of multimedia input in the ingested content is shown in diagram 600G of FIG. 6G. As shown in diagram 600G, handling the multimedia in the ingested content can be performed during the ingestion process (e.g., via knowledge base accessing component 157). For example, when a multimedia object is encountered during the ingestion process (e.g., or accessed by knowledge base accessing component 157), the multimedia object can be transformed (e.g., a representation of the multimedia object can be generated and stored and associated with the multimedia object) into a textual representation of the multimedia object by leveraging the multimodal language model. In this regard, in some embodiments, textual representation of the multimedia object can be generated by the multimodal language model as a part of a preprocessing pipeline before the ingestion happens.

Another example of chatbot component facilitating the handling of multimedia input in the end-user input is shown in diagram 600H of FIG. 6H. As shown in diagram 600H, the image of diagram 600G of FIG. 6G when encountered during the “answer finding” process (e.g., as described with respect to answer search state component 154 of FIG. 1, block 410 of FIG. 4, etc.), is transformed into a textual representation that the multimodal language model recognizes as an image. In this regard, the multimodal language model, such as an LLM, can provide the image as a part of the answer and/or the textual representation of the image as a part of the answer to the query.

In some embodiments, chatbot component 151 facilitates using a language model 110 to determine aspects of a conversation with a user in order to interact with external systems (e.g., external sources), such as an external application through third-party application configuration files 144, in order to provide a response or take an action with respect to the user. For example, chatbot component 151 may retrieve information from an ecommerce store, such as a price of an item or an answer to the user that allows the user to purchase an item, and provide the relevant response to the user. As another example, chatbot component 151 may retrieve information from an ecommerce system to determine whether historical customer data of the user indicates whether the customer qualifies for a particular offer or discount.

In some embodiments, chatbot component 151 facilitates augmenting the user context by utilizing data from external systems; for example, reading a user's order information from an ecommerce platform, or accessing tracking information for user's order. An example of chatbot component 151 facilitating the augmenting of the user context by reading the data from external sources is shown in diagram 600I of FIG. 6I. With reference to FIG. 6I and continuing reference to FIG. 1, diagram 600I depicts aspects of a chatbot component 6020, which can be implemented as an embodiment of chatbot 151 described in FIG. 1, and server 6030, which can be implemented as an embodiment of server 150 described in FIG. 1. As further shown in diagram 600I, in some embodiments, there can be a number of processes connected to chatbot component 6020 to facilitate using external data, such as action discovery and definition 6022, action selection 6024, action calling 6026, and context augmentation 6028. In some embodiments, action discovery and definition 6022 can be performed as part of an application calling a subsystem to the chatbot component 6020. For example, during a call to the subsystem of chatbot component 6020, the actions that are available for use are determined based on a current context and customer settings. (Accordingly, not all users may have access to all actions). The list of available actions can include action definitions, with names, IDs, descriptions and parameter definitions such as API parameters, and can be sent along other conversation data. In some embodiments, the list of available actions can be retrieved using a get_reply call. A specific example of a get_reply call is as follows:

```
search_for_answer
{
  “conversation”: {
    ...
    “parts”: [
      ...
      {
        “author”: {
          “id”: “5103890”,
          “type”: “bot”
        },
        “text”: “Alright, how can I help you?”
      },
      {
        “author”: {
          “id”: “641c08a73463b681f342960d”,
          “type”: “user”
        },
        “text”: “I dont remember if I have a PRODUCT NAME 1 or a PRODUCT
NAME 2. Could you let me know which one do I have?”
      }
    ],
    ...
    “available actions”: [
      {
        “id”: 44539,
        “name”: “Get ECOMMERCE PLATFORM Orders”,
        “description”: “Use this action to lookup recent ECOMMERCE PLATFORM
orders for this user”,
        “parameters”: [ ]
      }
    ],
    ...
  },
  ...
}
```

In the specific example of the get_reply call above, there is one action defined. However, a get_reply call can be generated with any number of actions available. In some embodiments, if action has parameters, the action can be described with the following fields: name: text; description: text; type: enum (data type); required: boolean (true/false); and default_value: any value.

Continuing with diagram 600I, in some embodiments, the action selection process can include chatbot component 6020 facilitating choosing which actions to call in order to augment the user's context based on the user's issue summary, current conversation, and available actions. In this regard, the action selection process can choose to call 0, 1, or more actions of the given conversation state. The output of the action selection process, performed by action selections 6024, can comprise a list of actions to call, and arguments for each action call (e.g., call action “Get ECOMMERCE PLATFORM Order” with “order_id: <some_order_id_from_conversation>”). In some embodiments, the action calling process performed by action calling 6026, can include chatbot component 6020 facilitating calling back into server 6030, asking for the response of called actions (e.g., after action selection is performed). Server 6030 can call external system (e.g., via third-party application configuration files 144) and proxy the response. In some embodiments the response is redacted as users (e.g., teammates) can define which fields are returned back in the response. In some embodiments, the context augmentation process can include chatbot component 6020 facilitating augmenting the context in the “answer finding” stage (e.g., as described herein with respect to answer search state component 154 of FIG. 1 and block 410 of FIG. 4, among other components of the drawings) with received responses (e.g., after a response is received from the action calling process). In this regard, action responses can be included in the same prompt as relevant passages from the knowledge base in order to facilitate utilizing data from external systems to provide an answer to a query.

In some embodiments, by connecting with external tools, information from the external tools can be retrieved to provide more personalized replies. For example, actions can include, without limitation: (1) get order info from an ecommerce platform, (2) get subscription status from a payment processing platform, (3) check for ongoing incidents in a communication platform, and/or the like. Customer support teams of a business can also set up an action that connects to the business's own backend system. In some embodiments, actions are API calls that can be manually set up (e.g., read actions) to retrieve data from external systems. In some embodiments, actions can include write actions to update data in external systems.

In some embodiments, read actions (e.g., and/or write actions) for external systems can include a set of functionalities designed to enhance customer control, security, and monitoring capabilities to allow customers to define, monitor, and control the operations that the chatbot (e.g., chatbot component 151) can perform, ensuring a secure and customizable experience. In this regard, a read action can allow the gathering of data from an external system, returning relevant information to the AI Agent (e.g., chatbot component 151) to allow for personalized and contextual responses to end users.

In some embodiments, read actions (e.g., and/or write actions) for external systems can include customization and/or control configurations, such as (1) action specification where users can specify which actions chatbot component 151 is allowed to initiate and under what circumstances; (2) frequency and limits where users have control over how often and/or how much resources or money, chatbot component 151 can handle; (3) custom actions setup where users are required to use Identity Verification (IdV) and other secure defaults to prevent unauthorized updates; and/or the like.

In some embodiments, read actions (e.g., and/or write actions) for external systems can include security measure configurations, such as (1) where IdV is mandatory for setting up custom actions, ensuring that only verified users can configure sensitive operations; (2) attribute protection where attributes that are not protected can be hidden, and updates from the messenger can be disabled to prevent abuse; (3) logging and monitoring where comprehensive logging is in place to track actions and interrogate incidents where chatbot component 151 might take unauthorized actions; and/or the like.

In some embodiments, read actions (e.g., and/or write actions) for external systems can include monitoring configurations, such as where users can monitor the actions that chatbot component 151 is taking through an inbox view (e.g., messages inbox interface 122) that can be filtered to show conversations where actions, such as custom actions, were used.

In some embodiments, read actions (e.g., and/or write actions) for external systems can include security recommendations, such as (1) risk awareness where users setting up chatbot component 151 to take custom actions are made aware of the risks of attribute abuse and are prompted to disable unnecessary updates from the messenger; (2) workspace security where the system can track which workspaces are in insecure states, ensuring that users are informed and can take necessary actions to secure their environments; (3) custom authentication models that can be deleted upon uninstall or workspace deletion to prevent unauthorized access; and/or the like.

With references to FIGS. 6J-6N, and continuing reference to FIG. 1, various example diagrams are depicted including process flow 600J, process flow 600K, user interface 600L, and diagrams 600M-N. The example diagrams, process flows, and user interface of FIGS. 6J-6N depict aspects of various implementations of a specialized chatbot platform for facilitating the augmenting of a user context utilizing data from external systems, in accordance with various embodiments of the present disclosure. As can be understood from process flow 600J, process flow 600K, user interface 600L and diagrams 600M-N, read actions (e.g., and/or write actions) for external systems can include a set of functionalities designed to enhance customer control, security, and monitoring capabilities to allow customers to define, monitor, and control the operations that the chatbot (e.g., chatbot component 151) can perform, ensuring a secure and customizable experience.

In some embodiments, read actions (e.g., and/or write actions) for external systems can include security features, such as (1) attribute protection to implement attribute protection mechanisms; (2) IdV enforcement to enforce identity verification; (3) drop available actions if IdV is disabled to disable actions if IdV is not enabled; (4) API update for attribute protection to update APIs to enable attribute protection on create/update; (5) protected attributes for an ecommerce platform to ensure all existing attributes of the ecommerce platform are protected; (6) teammate activity log to log teammate activities related to action creation and updates; and/or the like.

In some embodiments, read actions (e.g., and/or write actions) for external systems can include action preview features, such as (1) mocked responses to generate and provide mocked responses for actions; (2) action level preview to preview actions at the action level; (3) user journey to define user journeys to inform whether only draft actions should have their responses mocked in preview; (4) action configuration to allow users to configure actions, including adding audience rules and mocked responses; (5) interaction with redaction/formatting to determine how mocked responses interact with redaction and formatting; and/or the like.

In some embodiments, read actions (e.g., and/or write actions) for external systems can include data controls features, such as (1) trusted identity and data to ensure data reliability by requiring IdV and controlling which data can be used; (2) namespace application data to isolate application-specific data and restrict updates via messenger; (3) data source tracking to track the source of data updates to improve reliability; (4) API default update to implement default updates for APIs to enhance data security; and/or the like.

In some embodiments, read actions (e.g., and/or write actions) for external systems can include IdV and attribute abuse protection features, such as (1) IdV enforcement to enforce IdV for all messenger installations; (2) attribute protection to protect attributes from being updated via messenger and ensure they are managed securely; (3) error messaging to provide error messages for actions using unprotected attributes; (4) inform beta customers to notify beta customers about the enforcement of IdV and attribute protection; and/or the like.

In some embodiments, read actions (e.g., and/or write actions) for external systems can include action access control features, such as (1) control access to actions to manage the ability of chatbot component 151 to access and use actions based on user and company data; (2) audience management to define audience predicates to control which users can trigger specific actions; (3) action availability to set actions to be available to chatbot component 151 by default or restrict them based on audience rules; and/or the like.

In some embodiments, read actions (e.g., and/or write actions) for external systems can include secure by default features, such as (1) secure defaults to implement secure defaults for IdV and data usage; (2) namespace application data to restrict updates to application-specific data via messenger; (3) data validation to validate input fields and add allow lists to control data updates; (4) detailed webhooks to capture detailed information about data updates for better security and auditing; and/or the like.

In some embodiments, read actions (e.g., and/or write actions) for external systems can include action agent flow change features, such as (1) answerbot flow (e.g., answer search state component 154) to integrate actions into the answerbot flow; (2) conversation funnel to track the conversation funnel from start to resolution; (3) security to ensure secure handling of data and actions; (4) LangChain integration to use LangChain for LLM prompts and action execution; (5) write actions; (6) parameter extraction; (7) action chaining; and/or the like.

With reference to FIGS. 6J and 6K and continuing reference to FIG. 1, process flows 600J and 600K depict aspects of embodiments of a chatbot component 151 facilitating using a language model 110 to determine aspects of a conversation with a user wherein external systems, such as third-party applications, are utilized to provide a response or perform an operation with respect to the user. Process flow 600J begins at block 6210 where a user starts (or continues) a conversation in a chatbot application session, such as via a chat interface 108 and chatbot component 151, among other components of FIG. 1.

At block 6220, based on user input from the chat session, an available action is determined. The available action may be determined based on the user's input, such as an input reflecting a query or action to be performed. For example, the user may ask about tracking information regarding an order or the status of a refund. In both of these examples, the user is requesting information, thus the user request represents a query. In some embodiments of block 6220, chatbot component 151 or a subcomponent, such as described in connection with FIG. 6K, determines that an action is needed to respond to the user's input. Accordingly, in block 6220, one or more actions available to this user are matched or otherwise determined. In some embodiments, the available actions are accessed via a database of actions (e.g., actions database 6431 described in FIG. 6K). In some embodiments, at block 6225, various attributes of the company, the user (e.g., a particular customer) or others are used in block 6220 to determine available actions.

At block 6230, one or more of the available actions that are relevant to the user's input (e.g., a query representing the user's input) are determined. For example, chatbot component 151 may determine relevant actions that are responsive to a query representing the user's input, based on information provided at block 6235 including information about the available actions, question summaries from conversation history, recent passages in the user's chat session, the entire chat record of the chat session, and/or full conversation history with the user.

At block 6240, the one or more actions determined at block 6230 are executed, and the responses to the actions are provided in an answer prompt to a language model. In some embodiments, action, workspace, user, company, and conversation data from block 6245 is also utilized. The language model may comprise an LLM that is used to generate a conversational response from the chatbot to the user in the chat session.

At block 6250, it is determined that the answer cites the context of the action(s). Block 6250 uses, at block 6255, action responses determined from block 6250. At block 6260, content uses in the answer are tracked. Block 6260 uses content references of block 6265. At block 6270, the conversational response is evaluated to determine whether the response is sufficient to resolve the conversation with the user. For example, the response is evaluated to determine whether it is responsive to the user's query. At block 6277, the conversation response is determined not to resolve the conversation. In some instances, block 6277 (or processes occurring subsequent to block 6277) of process flow 600J includes generating a subsequent response to the user in the chat session requesting clarification or additional information in order to more accurately resolve the conversation. In some instances, block 6277 (or processes occurring subsequent to block 6277) includes escalating the chat session to a human CSA to assist the user. On the other hand, if the conversation response is determined at block 6270 to resolve the conversation, then process flow 600J proceeds to block 6275 indicating the response has resolved the conversation. At block 6280 a resolution is counted.

Turning to FIG. 6K with continuing reference to FIG. 1, process flow 600K depicts aspects of an example chatbot platform that facilitates the augmentation of the user context utilizing data from external systems. Process flow 600K represents one example of a suitable computing system architecture for programmatically determining a query from a passage in a chat session with a user, addressing the query, and providing a response. Other arrangements and elements can be used in addition to or instead of those shown, and some elements may be omitted for the sake of clarity. Further, as with operating system architecture 100 of FIG. 1, some of the elements described herein are functional entities that may be implemented as discrete or distributed components or in conjunction with other components, and in any suitable combination and location. In some embodiments, process flow 600K is performed in operating system architecture 100, and the specific components and operations of process flow 600K are embodied by components or subcomponents of operating system architecture 100. In particular, embodiments of process flow 600K are performed on a MAS computing system comprising one or more software agents.

As shown in FIG. 6K, example process flow 600k is carried out using components including agent executor 6410, tool agents 6420, language models (e.g., actions LLM 6435 and conversation LLM 6455), components or operations to prepare and provide an answer in a user chat (e.g., output parser 6460 and generate answer in chat 6470). The various components depicted in process flow 600K or used to perform operations of process flow 600K communicate via a network (not shown), such as network 104 of FIG. 1.

Agent executor 6410 is generally responsible for determining and facilitating execution of a tool agent 6420 to call, based on information regarding a chat session such as a context of the conversation with a user who is interacting with a chatbot and/or recent passages of the chat inputted by the user. In some embodiments, agent executor 6410 determines or facilitates determining a query from the user chat session, based on recent passage(s) of user input in the chat. For example, a user request for information corresponds to a query for the requested information. Similarly, a user request for help to solve a problem may correspond to a query for information needed to address the problem. Tool agents 6420 include various software agents operating in an MAS, such as, by way of example and without limitation, agents 6422 for routing the user to a customer support agent, greeting the customer, saying goodbye, and other actions. Tool agents 6420 also includes Search for Answers Agent 6424.

Search for answers agent 6424 is generally responsible for determining retrieval of information for answering a particular query corresponding to the user input in the chat session. For example, search for answers agent 6424 can access a knowledge base (e.g., knowledge base 132 of FIG. 1), such as help center or internal record of the company operating the chatbot platform, as well as facilitate calls to external systems using APIs or third-party templates (e.g., third-party application configuration files 144). In some scenarios, depending on the context and/or user query, search for answers agent 6424 first performs a Retrieval-Augmented Generation (RAG) to one or more knowledge bases to retrieve information regarding the user (e.g., a customer), an issue related to the user's query, or other relevant information. If additional information or actions are needed to address the query, the search for answers agent 6424 communicates with the actions manager 6430 to call a specific action for obtaining the additional information or performing an operation for the user.

Actions manager 6430 is generally responsible for planning and managing one or more actions needed to address the user's query. In some scenarios or contexts, multiple actions are used to address a user's query. Accordingly, actions manager 6430 determines or facilitates determining (e.g., using Actions LLM 6435) which actions are needed. Actions manager 6430 receives from search for answers agent 6424 information relating to the user query, such as recent passage(s) in the chat or a query reflecting recent passages, and may also receive information regarding the user and/or context, and information retrieved from knowledge based by search for answers agent 6424. As shown in example process flow 600K, actions manager 6430 also receives available actions, which may be accessed from actions database 6431. In some instances, actions manager 6430 determines which actions are available to the user based on the context or other information regarding the user.

Using the received information, actions manager 6430 generates a prompt for the Actions LLM 6435 using a prompt generator, such as prompt generator 6432. Prompt generator 6432 includes computer logic for formulating a prompt to a particular language model, such as Actions LLM 6435 regarding actions to be performed to address the user's query. For example, the prompt generated by prompt generator 6432 can include information received from the Search for Answers Agent 6424, such as information about the user and the query, as well as available actions to consider using to address the query.

Actions LLM 6435 comprises a language model configured or use for determining one or more actions based on an input regarding a user query. Although the embodiment of actions LLM 6435 shown in process flow 600K comprises an LLM, other embodiments may use a medium or small language model. Actions LLM 6435 receives the prompt from prompt generator 6432 (or more generally from actions manager 6430) and determines one or more specific actions or other external applications or other resources to use in order to generate an answer to address the user's query. For example, actions LLM 6435 may provide an output, in response to the prompt, that indicates a particular action to call and API (or third-party template) parameters or formatting information used for calling the particular action.

The output of actions LLM 6435 is received by Actions manager 6430. In some instances, the output of actions LLM 6435 is parsed or formatted using output formatter 6434. In particular, output formatter 6434 (or more generally actions manager 6430) uses the output of actions LLM 6435 and the data received from search for answers agent 6424 to format API parameters (or third-party template parameters) for an API call (or to access a third-party resource using a template) to an action identified in the output of actions LLM 6435. For example, if the output of actions LLM 6435 includes an explanation and JSON formatted data, output formatter 6434 may parse the output to extract the necessary information and then format it in a way suitable for the API call corresponding to an action indicated in the output.

Next, with the formatted parameters for an API call, action(s) executor 6436 (or more generally actions manager 6430) executes the action(s) by calling the API(s) (or third-party resource) corresponding to the action(s). Action(s) executor 6436 (or more generally actions manager 6430) receives a response from the API call (or third-party resource), such as information regarding the user's query, and provides the response (or a portion thereof) to search for answers agent 6424.

Continuing the process flow 600K, search for answers agent 6424 provides the information received from actions manager 6430 as a prompt to conversation LLM 6455. Search for answers agent 6424 also may provide other data it received from knowledge bases or internal sources and/or information about from the chat session, such as a recent passage inputted by the user.

Conversation LLM 6455 comprises a language model that generates a chat response to the user that is responsive to the user's input. Conversation LLM 6455 receives a prompt from a tool agent 6420, such as search for answers agent 6424. In some embodiments, conversation LLM 6455 also receives other information as input such as user chat history, chatbot information, app information or other contextual information. Although the embodiment of conversation LLM 6455 shown in process flow 600K comprises an LLM, other embodiments may use a medium or small language model.

In some embodiments, the output of conversation LLM 6455 is parsed before being presented to the user in the chat session. Accordingly, process flow 6K shows the output of conversation LLM 6455 being received by output parser 6460. Output parser 6460 is generally responsible for parsing the output of the conversation LLM 6455, as needed, to provide an answer that is responsive to the user input. For example, where the output of conversation LLM 6455 includes content in addition to a response to the user, then output parser 6460 parses out the portion of the output that is responsive.

At block 6470 of process flow 600K, the output of conversation LLM 6455 (which may have been parsed, in some scenarios) is provided to the user. In particular, the output is used to generate an answer to the user's input in the chat session. In some embodiments, the output is provided from chatbot component 151 via a chat interface 108, as described in connection to FIG. 1.

In some embodiments of process flow 600K, actions manager 6430 performs parameter collection for the API call or template to access a third-party resource. For example, action manager 6430 determines that a call to an action needs a particular parameter, and that parameter is not available. So actions manager 6430 communicates the needed parameter to search for answers agent 6424. Search for answers agent 6424 then may perform a search for data corresponding to the parameter, such as a RAG on internal databases, or may determine to request from the user the data corresponding to the parameter. If the user is asked for the data, then search for answers agent 6424 may generate a request to be provided directly in the chat session or may prompt conversation LLM 6455 to generate a request for the user to provide the data. For example, if a customer ID is needed as an API parameter for calling a particular action, and the customer ID data is not available, then action manager 6430 may request the data from search for answers agent 6424, which can cause a chatbot request to be provided to the user in the chatbot session requesting the customer ID. The parameter collection operations performed by actions manager 6430 are useful for planning chaining actions, as described below.

In some embodiments, action manager 6430 accesses a risk setting indicating to a risk level associated with a particular transaction corresponding to the user input or user query. In particular, certain queries or operations requested by the user may have varying risks, such as requesting a refund for a very expensive item, or making a payment for a very large amount of money. Accordingly in some embodiments, an administrator, such as a teammate, can configure an indication of a risk-level associated with certain transaction or certain types of transactions. Based on the risk level, action manager 6430 may determine not to invoke an action, but instead to facilitate implementation of a deterministic workflow. Specifically, in some instances, an action may result in a probabilistic outcome that potentially could be detrimental in certain high-risk transactions. In contrast, a deterministic workflow will always have an outcome that is known or certain. By way of example, in one embodiment, where a user requests a payment exceeding a certain dollar amount (e.g., $5000.00) action manager 6430, accessing a risk setting and determining that there an indication of a risk level is sufficiently high, determines to implement a workflow with a certain outcome such as passing the user onto to a human CSA to verify the payment, rather than perform an action where the outcome could be the chatbot approving a payment that should not occur given a context associated with the user. An example of a process flow of an action manager 6430 deciding to follow a deterministic workflow or a probabilistic path using an action is illustratively depicted in diagram 600N of FIG. 6N.

Turning back to FIG. 6K and with continuing reference to FIG. 1, an example is now described using process flow 600K to programmatically determine a query from a passage in a chat session with a user, address the query, and providing a response. Example scenario: suppose a user has return shipped a product to a merchant and is asking, via a chatbot, when they will receive their refund. In this example, agent executor 6410 determines a query based on the user's input received in the chat session. For example, the user has asked when they will receive their refund. The query corresponding to the user's input includes determining information about the customer's order, returning a product, and return shipping tracking. The agent executor 6410 determines that information is needed to address the user query and invokes the search for answers agent 6424 to address the user's problem.

In this example, search for answers agent 6424 first performs a Retrieval-Augmented Generation (RAG) to one or more knowledge bases of the merchant company in order to retrieve information regarding the customer, such as a return process that has started, information about the customer such as their address, prior communication, and order details. If this information is available, the search for answers agent 6424 retrieves it (e.g., using RAG) provides it, along with the query or passage(s) inputted by the user in the chat session, to actions manager 6430.

Actions manager 6430 receives the information from search for answers agent 6424 and determines one or more actions and a plan for addressing the issue. For example, actions manager 6430 leverages actions LLM 6435 to determine an action that will address the user's query. In some embodiments or situations, actions manager 6430 facilitates action chaining, where multiple actions are sequentially called. For instance, action chaining may be used where output from calling a first action is needed as input for a second action. Further and as described herein, where the output of LLM 6435 indicates a chain of actions to be performed, actions manager 6430 performs planning to determine that data, as API parameters, is available for the actions.

Actions manager 6430 generates a prompt for the actions LLM 6435 using prompt generator 6432. The prompt includes information received from the search for answers agent 6424, such as information about the user and the query, as well as available actions to consider using to address the query, which may be received from an actions database 6431.

The Actions LLM 6435 receives the prompt from actions manager 6430 and in response, outputs one or more specific actions to address the query. The output from the Actions LLM 6435 is formatted by the Output formatter 6434 to be usable to call an API corresponding to the action. The formatted API parameter information is then passed to the action(s) executor 6436, which calls the API(s) to execute the action(s) and receives from the API(s) a response comprising the information. For instance, here a first API may be called to provide tracking details for the customer's return shipment, and a second API may be called to provide information regarding the payment for the order so that an appropriate refund can be issued to the user.

The information returned from the API call(s) is then used to generate a response for the user in the chat session. In particular, continuing this example, actions manager 6430 returns the API output to the search for answers Agent 6424, which takes that information and generates a prompt for the conversation LLM 6455. The conversation LLM 6455 generates a conversational response for the chat that is responsive to the user's query. The response is then provided to the user through the Generate Answer in Chat component 6470. In some instances, the output of conversation LLM 6455 is parsed by output parser 6460 before it the parsed portion is provided as a response to the user in the chat session.

Turning briefly to FIG. 6L, user interface 600L depicts aspects of a computer user interface for creating an action, to be used in accordance with the example process flow 600K described in FIG. 6K. In this example, a user-administrator, such as a teammate, is creating an action for “get account balance details” from an external system or resource. The user interface 600L prompts the user-administrator to provide details about when and how (e.g., under what circumstances) the action is to be used. In this way, an action manager 6430 of FIG. 6K can facilitate determining whether an action is available and/or relevant and Actions LLM 6435 can provide an outcome indicating that the action should be used and how to use the action.

Turning to FIG. 6M, aspects are depicted of mapping objects to attributes (such as attributes needed for an API call). In some instances, external resources accessed via an API call will return information that is nested, such a nested list of topics. Particular data that is nested may be needed for a particular parameter or response to the user, thus a mapping is used to extract the particular data from the response of the API call. For example, an action response may have many object mappings, and within those mappings there are attributes that are assigned to the answer to be provided to the user, when the action response of nested information is flattened out.

Returning back to FIG. 1, as described herein, various embodiment of chatbot component 151 facilitate using language models for other functionality. In some embodiments, chatbot component 151 facilitates using a language model 110 to customize the tone of voice and/or answer length of chatbot component 151. In some embodiments, chatbot component 151 facilitates using a language model 110 to facilitate email correspondence. In some embodiments, chatbot component 151 facilitates using a language model 110 to automatically translate support content. In some embodiments, chatbot component 151 facilitates using a language model 110 to facilitate automatically categorizing categories into topics and/or sentiments. For example, if a customer is frustrated, chatbot component 151 can determine that the customer is frustrated or angry and automatically pass the conversation to a human team member. In some embodiments, chatbot component 151 and/or content management tool 173 facilitates using a language model 110 to facilitate providing general guidance to the chatbot component 151, such as based on general company principles and/or values.

In some embodiments, chatbot component 151 and/or chatbot analysis tool 181 facilitates using a language model 110 to facilitate analysis of customer satisfaction across all conversations. In some embodiments, chatbot component 151 and/or chatbot analysis tool 181 facilitates using a language model 110 to facilitate identification of areas of poor quality across customer support conversations (e.g., AI agent and/or human interactions).

Continuing with FIG. 1, data regarding the conversations can be stored in any suitable storage location, such as storage 130, customer support device 112, server 150, some combination thereof, and/or other locations as communication records files 131.

At a high level, chatbot (e.g., implemented by chatbot component 151) can include a number of agents (e.g., a program that, for each user turn, based on the conversation transcript and/or other factors, computes the next appropriate action to take in the conversation, and performs the action), such as a start agent (e.g., start state chatbot agent component 153) and a feedback agent (e.g., feedback state chatbot agent component 155). In this regard, computing the next action (e.g., a sub procedure of an agent that causes the effect on the conversation and can be implemented in a general programming language, such as Python, and can perform any operation a given language can perform, such as another call to a large language model (LLM), such as GPT3, GPT4, Anthropic's Claude, and/or the like) can be implemented as an LLM call with lightweight post-processing. In some examples, based on the chosen action and a history of previous actions, the computed action is overridden and another action is used. An example of an agent flow can include: (1) user (e.g., customer) sends a message; (2) API endpoint invokes the active agent (e.g., start state chatbot agent component 153 or feedback state chatbot agent component 155) of the conversation; (3) agent computes the best next action (e.g., from predefined set of actions); (4) agent executes the action (e.g., which can include as part of action execution, an agent yielding the control to another agent).

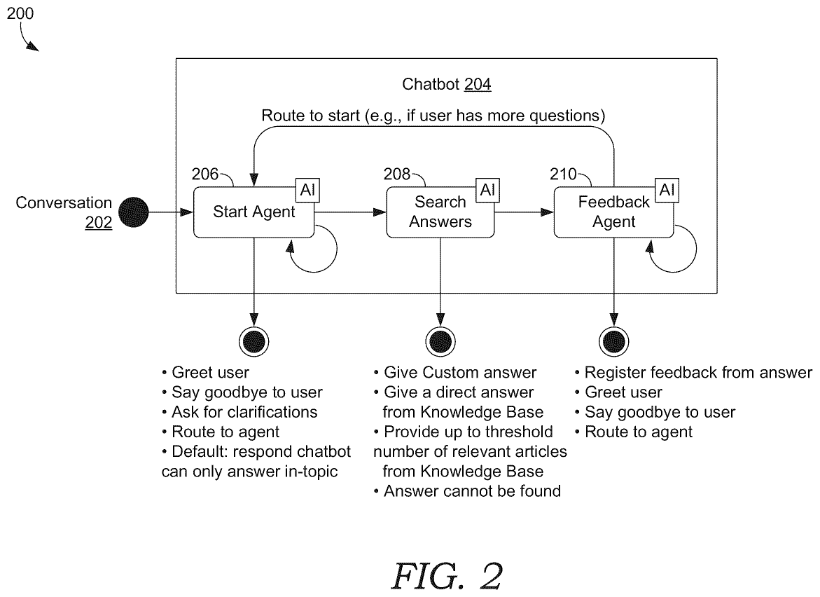

Turning now to FIG. 2 and with continuing reference to FIG. 1, an example diagram 200 of a model implementing a specialized chatbot platform that uses language models to determine answers from knowledge bases is shown in FIG. 2. As shown in FIG. 2, conversation 202 is received by start agent 206 of chatbot 204 (e.g., start state chatbot agent component 153 of FIG. 1). In some embodiments, all conversations between a user and a chatbot begin with start agent 206. For each user turn, based on conversation, start agent 206 chooses one of available actions: greet, goodbye, clarify, route to agent, default, and search for answer. When the search for answer action is triggered, start agent 206 of chatbot 204 initiates a search for answers 208 (e.g., answer search state component 154 of FIG. 1). If search for answers 208 results in a successfully generated answer, conversation control is yielded to the feedback agent 210 (e.g., feedback state chatbot agent component 155 of FIG. 1) of chatbot 204. In this regard, the following conversation turns are going to be processed by the feedback agent 210. In some embodiments, feedback agent 210 is an agent with a simpler set of actions than start agent 206, such route to agent, parse feedback, greet, and bye.

With reference to FIG. 1, to compute the next best action in conversation, the agent leverages an LLM and prompt engineering. Generally, LLMs are generic stateless machines so agent, on each user turn, makes a stateless call to an LLM. In some embodiments, the stateless call includes context, such as the relevant part of the conversation transcript, a list of available actions, explanation of each action and situations in which actions should be used, a set of instructions to choose one of the following actions, and/or the desired format of the output.

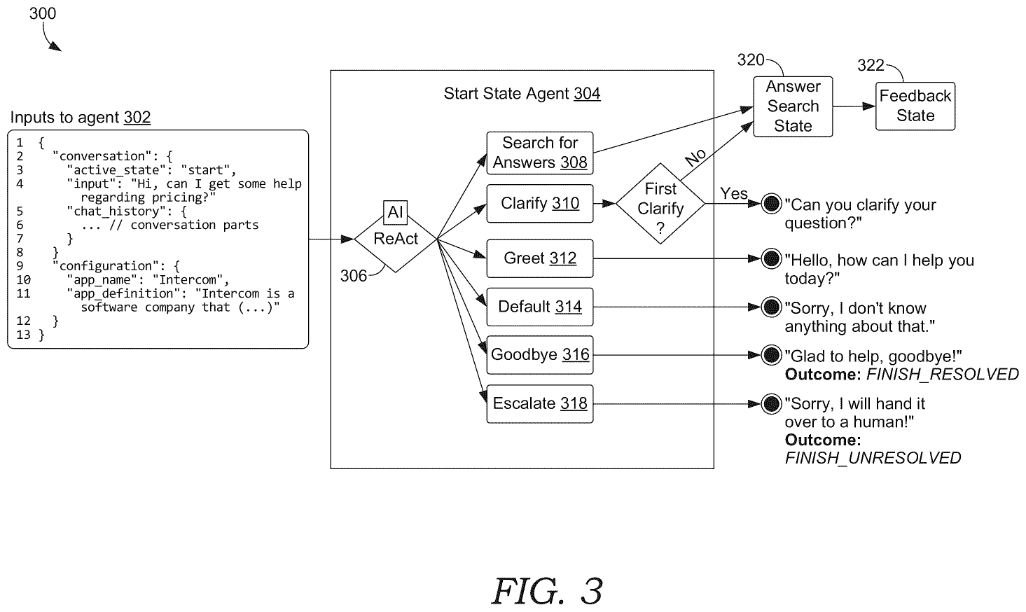

In some embodiments, start state chatbot agent component 153 is programmatically designed to elicit a clear question from the user (e.g., a customer via chat interface 108) and find an answer to the given question. An example diagram 300 of a model implementing a start state agent of a chatbot that uses a language model to determine answers from semantically similar documents of a knowledge base is shown in FIG. 3. As shown in FIG. 3, in some embodiments, input 302 is received that includes conversation data, configuration data, and/or any other input to start state agent 304 (e.g. start state chatbot agent component 153) of the chatbot (e.g., as implemented by chatbot component 151). In some embodiments, as shown in the example in FIG. 3 the start state agent 304 can be implemented as a LangChain ReAct agent 306. In some embodiments, start state agent 304 can implement a number of actions. An example of an action is search for answers action 308 that can initiate an answer search state 320 (e.g., answer search state component 154). In some embodiments, following a response with an answer, start state agent 304 can initiate feedback state 322 (e.g., feedback state chatbot agent component 155). Another example of an action is clarify action 310 that can initiate a request for clarification from the user. In some embodiments, if no further clarification is necessary following a clarification to clarify action 310, start state agent 304 initiates an answer search state 320. Another example of an action is greet action 312 that can initiate a greeting to the user. Another example of an action is goodbye action 316 that can initiate a parting remark to end the conversation (e.g., or a portion of the conversation) with the user. Another example of an action is escalate action 318 that can initiate a handover to a human (e.g., route to agent component 158 of FIG. 1). Each of the examples of actions are described in further detail below with respect to start state chatbot agent component 153 of FIG. 1.

Continuing with reference to FIG. 1, in some embodiments, start state chatbot agent component 153 includes a greet action (e.g., greet action 312 of FIG. 3). Greet action can be instructed to be used by start state chatbot agent component 153 when it is time to greet the user. Generally, the effect of the action is to add a conversation turn of the bot to greet the user. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to greet the user may be provided in a prompt to language model 110 by start state chatbot agent component 153. Language model 110 may return a response to start state chatbot agent component 153 to provide a greeting. Start state chatbot agent component 153 may provide the greeting to the user through chat interface 108. In some embodiments, a hard coded response corresponding to a greet action can be included by start state chatbot agent component 153, for example, in case of the language model 110 failing to follow instructions.

In some embodiments, start state chatbot agent component 153 includes a goodbye action (e.g., goodbye action 316 of FIG. 3). Goodbye action can be instructed to be used by start state chatbot agent component 153 when it is time to say goodbye the user. Generally, the effect of the action is to add a conversation turn of the bot providing a parting remark to end the conversation (e.g., or a portion of the conversation) with the user. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to provide a parting remark to the user may be provided in a prompt to language model 110 by start state chatbot agent component 153. Language model 110 may return a response to start state chatbot agent component 153 to provide a parting remark. Start state chatbot agent component 153 may provide the parting remark to the user through chat interface 108. In some embodiments, a hard coded response corresponding to a goodbye action can be included by start state chatbot agent component 153, for example, in case of the language model 110 failing to follow instructions.

In some embodiments, start state chatbot agent component 153 includes a route to teammate/escalate action (e.g., escalate action 318 of FIG. 3). In some embodiments, route to teammate/escalate action can be instructed based on determining a response from the user requires a human to communicate with the user. For example, route to teammate/escalate action can be instructed to be used when a user explicitly asks to talk to a human. Generally, the effect of the action is to add a conversation turn of the bot to provide a textual response informing the user that they are being redirected to a human (e.g., a CSA) and/or instructing route to agent component 158 of chatbot component 151 to initiate a handover of the conversation to the human. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to provide a textual response informing the user that they are being redirected to a human and/or instructing route to agent component 158 of chatbot component 151 to initiate a handover of the conversation to the human may be provided in a prompt to language model 110 by start state chatbot agent component 153. Language model 110 may return a response to start state chatbot agent component 153 to provide a textual response informing the user that they are being redirected to a human and/or instructing route to agent component 158 of chatbot component 151 to initiate a handover of the conversation to the human. Start state chatbot agent component 153 may provide the textual response informing the user that they are being redirected to a human to the user through chat interface 108. Start state agent may communicate with route to agent component 158 of chatbot component 151 to initiate a handover of the conversation to the human. In some embodiments, a hard coded response corresponding to a route to teammate/escalate action can be included by start state chatbot agent component 153, for example, in case of the language model 110 failing to follow instructions.

In some embodiments, start state chatbot agent component 153 includes a search for answer action (e.g., search for answers action 308 of FIG. 3) that initiates answer search state component 154. Search for answer action can be instructed to be used by start state chatbot agent component 153 in order to search for an answer. In some embodiments, search for answer action is only instructed to be used by start state chatbot agent component 153 when the user's issue is clear and/or worth searching for an answer. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. In some embodiments, textual content of the conversation can be provided to language model 110 to generate a summarized and/or condensed user issue. The summarized and/or condensed user issue can be provided to language model 110 in order to determine whether to implement this action and/or the output answer based on the summarized and/or condensed user issue. The output answer can then be provided by start state chatbot agent component 153 to the user through chat interface 108. Examples of search for answer action is discussed below with respect to answer search state component 154.

In some embodiments, start state chatbot agent component 153 includes a clarify action (e.g., clarify action 310 of FIG. 3). Clarify action can be instructed to be used by start state chatbot agent component 153 when the user's issue is vague and unclear. Generally, the effect of the action is to add a conversation turn of the bot to request clarification from the user, such as a clarifying question. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user. For example, an instruction to request clarification from the user (e.g., when the issue is unclear) may be provided in a prompt to language model 110 by start state chatbot agent component 153. Language model 110 may return a response to start state chatbot agent component 153 to provide a question regarding an aspect of the user's issue in order to clarify the user's issue. Start state chatbot agent component 153 may provide the question to the user through chat interface 108. In some embodiments, if the clarify action is run twice in a row, the search for answer action can be automatically initiated.

In some embodiments, start state chatbot agent component 153 includes a default action (e.g., default action 314 of FIG. 3). Default action can be instructed to be used by start state chatbot agent component 153 when the language model 110 determines that none of the other actions should be used. Generally, default action is a fallback action to make sure that an LLM has an escape hatch, as without an escape hatch LLMs may misuse other actions (e.g., by computing action input with text that is not aligned with the computed action, such as by calling a clarify action, but giving an answer from a search for answer action in action input). The effect of the action is a bot conversation turn, with one of the example texts below. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user. Examples of a textual response of the default action can include information to the user regarding what the chatbot can provide answers about, such as “I can answer questions you'd expect to find in our help center,” “I'm here to answer questions using information from our help center,” and/or “I'm most helpful when you have a question that might be found in our help center.”

A specific example of a prompt provided by start agent (e.g., start state chatbot agent component 153) to a language model 110 (e.g., with a conversation with the customer) is as follows:

“““
Human: You are a friendly and polite customer support bot working for
${customer_name}.
You're identifying the customer issue and searching for an answer.
You have access to the following tools:
- route_to_customer_support_agent: Useful ONLY when the customer explicitly asks
to talk to a customer support agent. Input to this is a polite reply to customer saying that
you're routing them to a customer support agent.
- greet: Useful when you need to greet the customer. Input to this is a greeting to give
to the customer.
- say_goodbye: Useful when customer explicitly says goodbye. Input to this is a polite
reply saying something like goodbye to the customer.
- clarify: Useful in two cases:
1. When what customer is saying is gibberish.
2. When customer is saying they have a question/problem/query/issue/etc, but they
haven't told you what it is.
Input to this is a question that you ask the customer.
- default: Useful if no other action is appropriate.
- search_for_answer: Useful when: customer is asking a question or giving some
information about their issue. Use this tool if it's not clear what other tool to use. If
customer issue is clear, use this tool to summarize the issue and search for the answer.
Input to this tool is what the customer said. Do not attempt to answer the question.
Use the following format:
Customer: the input from the human customer.
Thought: you should always think about what to do.
Action: the action to take, should be one of [route_to_customer_support_agent, greet,
say_goodbye, clarify, default, search_for_answer].
Action Input: the input to the action. The input for this action must be in German.
Observation: the result of the action.
... (this Thought/Action/Action Input/Observation can repeat N times)
Begin!
If customer expressed the issue or what they want you to do, use “search_for_answer”
to search for an answer.
If no mentioned tools are appropriate, use “default” tool as a fallback.
Conversation with customer:
Customer: Hello there
AI: Hi, I'm a customer bot. You can ask me anything about {customer_name}
Customer: I'd like to know when, I'm eligible to get a bonus.
Thought:
”””

A specific example of response to the specific example of the prompt provided by start agent (e.g., start state chatbot agent component 153) by a language model 110 is as follows:

search_for_answer
Action Input: “When I'm eligible to get a bonus?”

In some embodiments, after output from language model 110 is received, the output of the language model can be parsed with regular expressions by chatbot component 151. For example, in the specific example of response to the specific example of the prompt, the returned action (e.g., the search for answer action) is invoked with returned action input (e.g., “When am I eligible to get a bonus?”). Following the returned action and action input, in some embodiments, a programming function (e.g., a python function) representing the action (e.g., the search for answer action) can be called with a textual argument corresponding to the action input (e.g., “When am I eligible to get a bonus?”). In some embodiments, if the output of the language model 110 does not conform to the specifications and/or the returned action name of the language model 110 is not a valid action name, a recovery procedure is started.

In some embodiments, answer search state component 154 facilitates programmatically implementing the search for answer action of start state chatbot agent component 153. Generally, answer search state component 154 facilitates the delivery of truthful and grounded resolution to the user's issue in textual form. As a high level overview, in some embodiments, answer search state component 154 initially determines whether a custom answer (e.g., a manually-defined answer) exists based on aspects of the conversation that triggered the search for answer action (e.g., via custom answers component 160). If no custom answer is determined, an issue summary is generated based on aspects of the conversation with the user. A language model determines whether the answer can be found in portions of documents of the knowledge base (e.g., knowledge base 132 of FIG. 1) that are most similar to the issue summary. For example, the knowledge base can include articles from various sources, a help center, FAQs, public URLs, historical conversation data (e.g., previous conversations between customers and CSAs), snippets of conversations, and multi-source answers may be provided, such as by synthesizing information from various sources of knowledge base. For example, knowledge base 132 of FIG. 1 shows examples of source, including, but not limited to, extracted snippet files 133, manually curated files 134 with public content 135 and private content 136 (e.g., content that is not shared with some or all customers), URLs 137, and historical conversation files 138. In some embodiments, embeddings corresponding to all passages from the knowledge base (e.g., knowledge base 132) are computed and stored during setup and/or are automatically computed and stored whenever knowledge base content changes.

Returning to the high level overview of answer search state component 154, in some embodiments, if the answer can be found, the answer is provided to the user via chat interface 108. If no answer can be found, a set of summaries corresponding to a set of documents that are most similar to the issue summary are provided to the language model to determine whether any of the documents may contain the answer. If the language model determines that documents within the set of documents may contain the answer, a threshold number of document most likely to contain the answer, along with summaries of the documents, are provided to the user via chat interface 108. If the language model determines that documents within the set of documents will not contain the answer, the language model indicates that the answer could not be found. The start state chatbot agent component 153 can then determine the next action, such as a clarify action or escalation action.

In some embodiments, different language models can be utilized for different actions or portions of actions. For example, one language model (e.g., GPT3) can be utilized to summarize the issue by answer search state component 154 whereas a different language model (e.g., GPT4) can be utilized to evaluate whether an article in the knowledge contains the answer by answer search state component 154. In some embodiments, one language model (e.g., GPT3) is utilized to screen articles as an initial check whether a top article contains an answer before asking a different language model (e.g., GPT4) to determine whether the top article contains an answer in order to reduce calls to the different language model (e.g., GPT4). In some embodiments, frequently asked questions (FAQ) are pre-computed using a language model to reduce live calls to the language model. In some embodiments, answer search state component 154 can utilize information from beyond the knowledge base. In some embodiments, answer search state component 154 and other components are multilingual.

In some embodiments, answer search state component 154 can request an issue summary based on the conversation with user (e.g., the customer) from language model 110. In some embodiments, the summary of the user's issue as action input to the search for answer action provided by language model 110 (e.g., the issue summary utilized to determine the appropriate action) is ignored and a second call is provided to the language model to summarize the issue again in order to increase the quality and/or reliability of the summary of the user's issues in certain scenarios. In some embodiments, aspects of the conversation with the user, such as the issue summary generated by language model 110 and/or historical customer data of the user, can be utilized to find the relevant context for searching the knowledge base 132. In some embodiments, the issue summary as generated by language model 110 can be utilized to engineer around an LLM's limitation on input length (e.g., the context window), which can cause the computation of the output to not be based on all parts of the input over a certain length and/or cause certain portions of input over a certain length to get a different level of attention while computing the output. In some embodiments, the issue summary can be used to stuff the prompt when the answer is being extracted by answer search state component 154 by utilizing the retrieved context and the issue summary to answer the user question at hand.

In some embodiments, answer search state component 154 facilitates programmatically finding an answer from a knowledge base. An example diagram 400 of a model implementing a specialized chatbot platform that uses language models to determine answers from knowledge bases is shown in FIG. 4. As shown in FIG. 4, in some embodiments, answer search component 402 (e.g., answer search state component 154 of FIG. 1) receives input 404. In some embodiments, input 404 includes the input from start state chatbot agent component 153. A sentence embedding of input 404, or a portion thereof, is computed. In some embodiments, the sentence embedding is computed using Sentence Bidirectional Encoder Representations from Transformers (SBERT). In some embodiments, historical customer data (e.g., as accessed by customer data accessing component 156 of FIG. 1) for the user chatting with the chatbot (e.g., through chat interface 108) can be utilized to provide contextual information for the input. For example, the contextual information related to the historical customer data can be encoded into the embedding of the input.

At block 406, it is determined whether aspects of the input correspond to a custom answer (e.g., via custom answers component 160 of FIG. 1). In some embodiments, semantic search is used to determine whether aspects of the input correspond to a custom answer based on the semantic similarity of the input, or a portion thereof, to a custom answer. For example, the semantic similarity of an embedding corresponding to the input (e.g., an issue summary of the input) and an embedding corresponding to a customer answer can be computed (e.g., based on a vector search query, a dot product of the embeddings, using Microsoft Machine Reading Comprehension (“MS MARCO”) model as the model is fine-tuned for Q&A asymmetrical search, and/or the like) to determine whether a customer answer corresponds to a user's query/issue of the input. In some embodiments, historical customer data for the user chatting with the chatbot (e.g., through chat interface 108) can be utilized to provide contextual information input. For example, the contextual information related to the historical customer data can be encoded into the embedding of the input.

In some embodiments, at block 410, a call is made to the language model 110 to summarize the issue based on aspects of input 404. A sentence embedding of the issue summary generated from block 410, or a portion thereof, is computed (e.g., utilizing SBERT). In some embodiments, historical customer data for the user chatting with the chatbot (e.g., through chat interface 108) can be utilized to provide contextual information for the issue summary. For example, the contextual information related to the historical customer data can be encoded into the embedding of the issue summary.

A specific example of a prompt (e.g., as provided by answer search state component 154 via start state chatbot agent component 153) to a language model (e.g., language model 110) to request an issue summary (e.g., a summary of an issue within the conversation) is as follows:

“““
You are a customer support AI for ACME CORP, having a conversation with the
ACME CORP's customer.
AI: Hi I'm Fin, an AI-powered support bot that automatically answers questions. Type
your question in the chat below and I'll do what I can to help. Don't worry, if I'm not
able to help you, I'll pass you along to a Live Support agent.
Customer: How did this Event not happen ???
---
This is a chat history of the whole conversation, and Customer could have mentioned
an issue/question/problem or issued a request.
There are two possible scenarios:
1. Customer only mentioned a single issue/problem/question/request.
2. Customer raised multiple completely unrelated issues/problems/questions/requests.
If it's #1, rewrite the customer issue in one sentence.
If it's #2, concentrate only on the last issue/problem/question/request and rewrite it in
one sentence.
Look at the whole conversation and make sure you're picking up the last
issue/problem/question/request fully!
If it's clean, leave it as is.
Customer:
”””

A specific example of response from the language model to the specific example of the prompt requesting an issue summary is as follows:

“““
“How did this Event not happen???”
”””

At block 412, a threshold number of portions from documents of a knowledge base (e.g., knowledge base 132 as accessed by knowledge base accessing component 157 of FIG. 1) that are most similar to the issue summary can be determined. In some embodiments, in block 414, portions of the knowledge base are broken into chunks, such as based on corresponding passages, sections, sentences, and/or the like, and the corresponding embeddings are pre-computed (e.g., using SBERT) and stored in the knowledge base. For example, the knowledge base can include articles from various sources, a help center, FAQs, public URLs, historical conversation data, snippets of conversations, and multi-source answers may be provided, such as by synthesizing information from various sources of knowledge base. For example, knowledge base 132 of FIG. 1 shows examples of source, including, but not limited to, extracted snippet files 133, manually curated files 134 with public content 135 and private content 136, URLs 137, and historical conversation files 138. In some embodiments, all embeddings corresponding to portions (e.g., passages) of the knowledge base (e.g., knowledge base 132) are computed and stored during setup and/or are automatically computed and stored whenever knowledge base content changes.

Returning to FIG. 4, in some embodiments, at block 412, semantic search is used to determine the portions of documents of the knowledge base that are most similar to the issue summary based on the semantic similarity of the issue summary, or a portion thereof, to portions of documents of the knowledge base. For example, the semantic similarity of an embedding corresponding to the issue summary and an embedding corresponding to each portion of documents of the knowledge base customer can be computed (e.g., based on a vector search query, a dot product of the embeddings, using MS MARCO, and/or the like) to determine the portions of documents of the knowledge base most similar to the issue summary. In some embodiments, the threshold number of portions from documents of a knowledge base extracted at block 412 correspond to an amount of tokens that are provided to the LLM (e.g., language model 110 of FIG. 1). For example, portions of documents of a knowledge corresponding to 1500 tokens may be extracted at block 412. In some embodiments, utilizing a Q&A asymmetrical search model (e.g., MS MARCO), the embedding of the issue summary can be utilized as a question and the answer can be found based on embeddings of corresponding portions of the knowledge base. A threshold number of passages (e.g., the 20 most similar passages) can be identified based on the dot product of the embeddings. In some embodiments, the location of the documents, or portions thereof, such as the identification of the article, can be determined.

At block 416, an LLM (e.g., language model 110 of FIG. 1) is prompted to evaluate whether the threshold number of portions of documents of a knowledge base (e.g., as determined at block 412) that are most similar to the issue summary indeed provide an answer to the issue summary. At block 418, if the LLM determines that the answer to the issue summary is found within one or more of the threshold number of portions of documents of the knowledge base, the output the answer is extracted. In some embodiments, the documents utilized to provide the answer are parsed by the LLM to determine the answer. In some embodiments, the document(s) utilized are provided along with the answer in response to the query. At block 420, the answer is then provided to the user (e.g., through chat interface 108 of FIG. 1).

A specific example of a prompt (e.g. as provided by answer search state component 154 via start state chatbot agent component 153 of FIG. 1) to a language model (e.g., language model 110 of FIG. 1) to find an answer given an issue summary and a threshold number of portions of documents of a knowledge base, such as knowledge base 132 of FIG. 1, similar to the issue summary is as follows:

“““
System: You are a customer support answer service for ACME CORP, do not
recommend competitors of ACME CORP. Your job is to answer questions as accurately
and efficiently as possible.
Human: QUESTION: I want to cancel my Pro plan and make sure I will not be charged
for it, and that it will remain active as a free plan.
AI: Here is a list of passages from our knowledge base in descending order of relevance
to your query:
[{‘passage_text’: “How do I cancel my subscription?\n\n Updated over a week
ago\n\nTable of contents\n\n[Steps:](https://help.ACME.com/how-do-i-cancel-my-
subscription)\n\nIf you've tried our paid plans and it wasn't for you, you can downgrade
to the free plan at any time via your Admin page. Once you downgrade, you'll lose
access to all your ...”
Human: Lets refer to those passages as “The information I've found about your query”
Given that information I want you to reasonably reinterpret my query: I want to cancel
my Pro plan and make sure I will not be charged for it, and that it will remain active as
a free plan. and determine if you can answer my question by summarizing the relevant
information into a response to my query.
First, write either <sources_answer_q>YES</sources_answer_q> or
<sources_answer_q>NO</sources_answer_q> to indicate whether the answer to the
question is entirely contained within the source information(s).
Second, list any materially relevant quotes from the information that you used to
generate your answer.
Quote them word-for-word using <quote id=“entity_id”></quote> tags.
Provide the answer between <answer></answer> tags.
Provide as complete a solution as possible, assuming I cannot read or reference the
information to solve my problem.
Make sure to include any caveats mentioned in the information.
You do not need to reference the passages in your response.
Format your answer for optimum scanability and readability (e.g. restate the problem
if helpful, process steps as lists, and use paragraph breaks where needed).
If there are relevant links in the passages, you should include them in your response.
If the passages don't contain enough information to answer the question, you should
say <answer>UNKNOWN</answer>.
”””

A specific example of a response from the language model to the specific example of the prompt to find an answer given an issue summary and a threshold number of portions of documents of a knowledge base similar to the issue summary is as follows:

“““
□<sources_answer_q> YES</sources_answer_q>
<quote id=“129-9354025”>If you've tried our paid plans and it wasn't for you, you can
downgrade to the free plan at any time via your Admin page. Once you downgrade,
you'll lose access to all your upgraded features at the end of your billing cycle.</quote>
<quote id=“129-9354025”>1. In your ACME CORP Admin, select your profile image
(or three horizontal lines if you're on a phone) to find Billing. 2. Hit the Change Plan
button found in the Your Subscription section. 3. In the pop-up, select the plan you'd
like to change to. If you want to cancel your subscription, scroll down below the plan
options where you'll see Downgrade to Free.</quote>
<answer>
To cancel your Pro plan and ensure you will not be charged for it while keeping your
account active as a free plan, follow these steps:
1. Log in to your ACME CORP Admin page.
2. Select your profile image (or three horizontal lines if you're on a phone) to find the
Billing section.
3. Click the “Change Plan” button found in the “Your Subscription” section.
4. In the pop-up, scroll down below the plan options and click “Downgrade to Free.”
Once you downgrade, you'll lose access to all your upgraded features at the end of your
billing cycle, and your account will remain active as a free plan.
</answer>
”””

In some embodiments, if there is an answer tag (e.g., <answer>) present in the response provided by the language model, and is different from “UNKNOWN”, the answer is determined to be found and the answer is delivered to the user. In some embodiments, the answer tag comprises a textual answer corresponding to whatever the language model returned inside answer tag and/or a link to the documents used to form an answer. An example chat interface between a chatbot and a user showing a response from the chatbot with a link to the corresponding source of the response is shown in FIG. 6C.

In some embodiments, if the language model did not find the answer to the issue summary at block 416, at block 422, a threshold number of most similar documents, or portions thereof, are identified. In this regard, if the previous stage didn't find a direct, inline answer, a prompt is provided to the language model to find content that is not directly answering the question, but might be relevant. In some embodiments, semantic search is used to determine the portions of documents of the knowledge base that are most similar to the issue summary based on the semantic similarity of the issue summary, or a portion thereof, to portions of documents of the knowledge base. For example, the semantic similarity of an embedding corresponding to the issue summary and an embedding corresponding to each portion of documents of the knowledge base customer can be computed (e.g., based on a vector search query, a dot product of the embeddings, using MS MARCO, and/or the like) to determine the portions of documents of the knowledge base most similar to the issue summary. In some embodiments, utilizing a Q&A asymmetrical search model (e.g., MS MARCO), the embedding of the issue summary can be utilized as a question and the answer can be found based on embeddings of corresponding portions of the knowledge base. A threshold number of passages (e.g., the 20 most similar passages) can be identified based on the dot product of the embeddings. In some embodiments, the location of the documents, or portions thereof, such as the identification of the article, can be determined.

In some embodiments, at block 424, a prompt is provided to a language model to determine whether an article might contain an answer relevant to the issue based on the issue summary and summaries 426 of each of the threshold number of most similar documents, or portions thereof, as identified at block 422. In some embodiments, the summaries of each of the documents of the knowledge base are precomputed and stored in the knowledge base. At block 428, if the language model determines that documents within the threshold number of documents may contain the answer, a threshold number of document most likely to contain the answer are provided to the user (e.g., via chat interface 108 of FIG. 1) at block 430. For example, if 10 documents are provided to the language model and the language model determines that 5 documents might contain the answer, the top 3 documents most likely to contain the answer are provide to the user. At block 428, if the language model determines that no documents provided likely contain the answer, the language model indicates that the answer could not be found.

A specific example of a prompt (e.g., as provided by answer search state component 154 via start state chatbot agent component 153 of FIG. 1) to a language model (e.g., language model 110 of FIG. 1) to determine documents likely to contain an answer to an issue summary is as follows. In this example, Fin™ refers to a chatbot agent provided by Intercom®.

“““
System: Here is a list of articles. For each, you have: ID, title, short summary:
“““- ID: 0; Title: General FAQs; Summary: The article contains a list of frequently
asked questions about various topics related to Intercom, including installation, access
tokens, Slack integration, ticketing, exporting data, managing teammates, and resolving
login issues.
- ID: 1; Title: Intercom features explained; Summary: This article provides an overview
of the different features offered by Intercom, including the Messenger, Next-Gen Inbox,
Tickets, Fin - The AI-Powered Bot, AI assist Features, Articles, Outbound Messages,
News, Surveys, 2-Way SMS, Product Tours, Checklists, Tooltips, Workflows, Custom
Answers, Custom Actions and Objects, and Switch, as well as information on how to
set up Intercom for your business.
- ID: 2; Title: Workflows explained; Summary: This article explains how to use
Workflows in Intercom to easily build chatbots, automate tasks, and provide support to
customers across multiple channels, with features such as triggers, templates, a visual
builder, omnichannel support, rules, conditions, updating attributes, open tickets,
custom actions, tagging conversations, and passover to other bots, and also provides
information on how to manage Workflows.
- ID: 3; Title: AI assist for Articles [Beta]; Summary: The article introduces AI assist
for Articles, a feature integrated with OpenAI's GPT 3.5 that allows teams to generate
full article versions from summaries, saving time and cognitive load for creating help
center content and providing customers with self-serve resources faster.
- ID: 4; Title: What is Automation?; Summary: Intercom is introducing new automation
features, including an AI-powered bot called Fin, the rebranding of Custom Bots and
Task Bots to Workflows, and the introduction of Basics for simple automations.
Existing features like Resolution Bot and Inbox Rules will still be available but may be
deprecated in the future. The navigation in the workspace will change depending on the
features enabled.
- ID: 5; Title: Using Fin Profiles alongside other automations; Summary: This article
explains how to use Fin Profiles alongside other automations in Intercom, such as
Custom Answers and Workflows, and provides tips for configuring and troubleshooting
conflicts between these features.
- ID: 6; Title: AI assist for Inbox; Summary: The article introduces AI assist for Inbox,
a feature that uses OpenAI's GPT 3.5 to help support reps in writing customer
responses, rephrasing messages, and summarizing conversations, ultimately saving
time and improving the customer experience. The article also provides information on
how Intercom's own support team is using these features and answers frequently asked
questions about the functionality and availability of AI assist for Inbox.
- ID: 7; Title: Custom Actions and Objects explained; Summary: This article explains
how to use Custom Actions and Objects to create personalized self-serve support
experiences in bots and Inbox without any coding.
- ID: 8; Title: 6 great ways to use Surveys; Summary: The article explains 6 great ways
to use surveys to capture and act on customer insights, from customer loyalty and
satisfaction metrics to onboarding discovery, product satisfaction, lead generation, and
understanding customer churn.
- ID: 9; Title: Articles explained; Summary: This article explains how to use Articles
in Intercom to create self-service content, sync with other content, build a knowledge
base, provide faster support, generate AI answers, get feedback, and improve content.
”””
Look at the list above and figure out whether given articles are related to the following
customer query.
Customer: “Can you integrate your AI chatbot with our product search to handle
customer enquiries?”
Please provide the IDs of the articles that are related to the customer query.
Wrap each article returned with <article_id> tag.
If no article is found, return <article_id>-1</article_id>
”””

A specific example of a response from the language model to the specific example of the prompt to determine documents likely to contain an answer to an issue summary is as follows:

“““
article_id>2</article_id>
<article_id>4</article_id>
”””

In some embodiments, article indices are then tied back to article identification from the knowledge base (e.g., knowledge base 132 of FIG. 1). In some embodiments, the chatbot responds with “I can't answer that directly, but I found an article that seems relevant to your question” and provides links to relevant articles. In some embodiments, if no articles are returned, the chatbot responds with “Sorry, I'm not sure how to help you with that,” or a variation thereof. In some embodiments, if the inline answer or relevant contents are found, the chatbot provides a request for feedback (e.g., “was that helpful?”) and transfers the agency over conversation to the feedback agent (e.g., Feedback state chatbot agent component 155 of FIG. 1).

Returning to FIG. 1, in some embodiments, feedback state chatbot agent component 155 facilitates programmatically implementing collecting feedback and/or routing to a human and start state chatbot agent component 153 based on aspects of the conversation with the user. In some embodiments, feedback state chatbot agent component 155 is the same type of agent as start state chatbot agent component 153 where the difference between the two agents are based on the role and conversational context. In some embodiments, feedback state chatbot agent component 155 only receives messages after and/or including the last answer and/or relevant content delivery whereas start state chatbot agent component 153 receives the entire conversation. In this regard, in some embodiments, the entire conversation is not provided to feedback state chatbot agent component 155 in order to ensure that the language model 110 does not focus on some previous feedback to the “was that useful?” message, which may compute the wrong action as the best one.

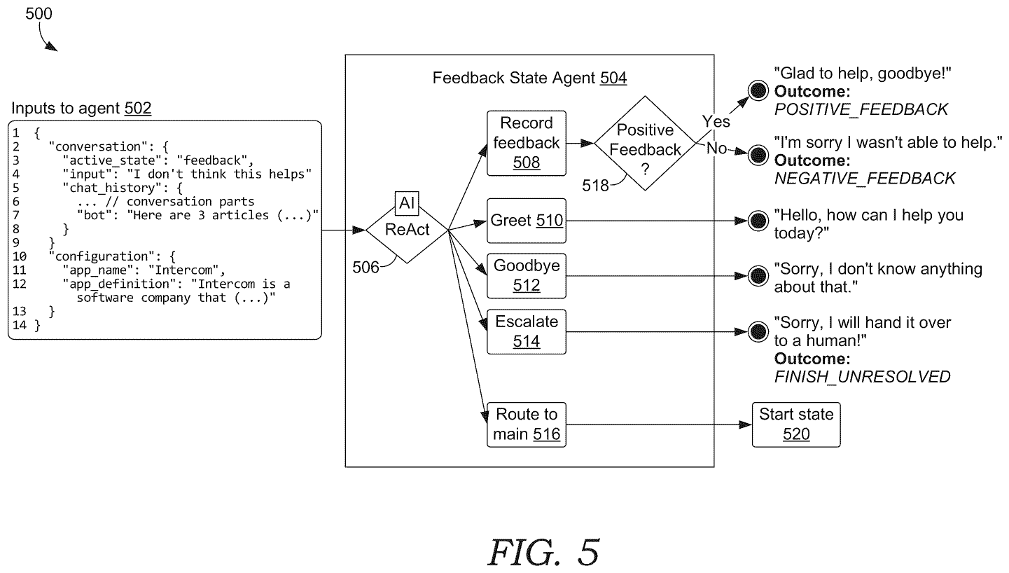

An example diagram 500 of a model implementing a feedback state agent of a chatbot is shown in FIG. 5. As shown in FIG. 5, in some embodiments, input 502 is received that includes conversation data, configuration data, and/or any other input for feedback state agent 504 (e.g. feedback state chatbot agent component 155). In some embodiments, as shown in the example in FIG. 5 the feedback state agent 504 can be implemented as a LangChain ReAct agent 506, which can implement a number of actions. For example, record feedback action 508 initiates a request for feedback. Feedback decision block 518 can then determine the type of response to the feedback based on whether the feedback is positive or negative. Greet action 510 initiates a greeting to the user. Goodbye action 512 initiates a parting remark to end the conversation. Escalate action 514 initiates a handover to a human (e.g., route to agent component 158 of FIG. 1). Route to main action 516 initiates the start state agent 520 (e.g., start state chatbot agent component 153 of FIG. 1). Each of the actions are described in further detail below with respect to feedback state chatbot agent component 155 of FIG. 1.

Returning to FIG. 1, in some embodiments, feedback state chatbot agent component 155 includes a record feedback action. Record feedback can be instructed to be used by feedback state chatbot agent component 155 in order receive feedback from a user. For example, after start state chatbot agent component 153 provides a message to the user requesting feedback (e.g., “was that helpful?”) following an attempt answer a user's query, a user's message replying to the message may trigger the record feedback action. Generally, the effect of the action is to record the feedback and add a conversation turn of the bot to with a response to user feedback appropriate for the given user feedback (e.g., “glad to help, you can ask me more questions”). For example, the feedback can be recorded (e.g., and utilized by chatbot analysis component 161) and/or parsed to determine whether there was feedback. In some embodiments, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to parse the response of the user for feedback may be provided in a prompt to language model 110 by feedback state chatbot agent component 155. Language model 110 may return a response to feedback state chatbot agent component 155 whether there was feedback and to provide a response to the feedback. Feedback state chatbot agent component 155 may record the feedback and provide the response to the feedback to the user through chat interface 108. In some embodiments, a hard coded response corresponding to a positive or negative feedback from a user can be included by feedback state chatbot agent component 155, for example, in case of the language model 110 failing to follow instructions.

In some embodiments, feedback state chatbot agent component 155 includes a greet action (e.g., greet action 510 of FIG. 5). Greet action can be instructed to be used by feedback state chatbot agent component 155 when it is time to greet the user. Generally, the effect of the action is to add a conversation turn of the bot to greet the user. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to greet the user may be provided in a prompt to language model 110 by feedback state chatbot agent component 155. Language model 110 may return a response to feedback state chatbot agent component 155 to provide a greeting. Feedback state chatbot agent component 155 may provide the greeting to the user through chat interface 108. In some embodiments, a hard coded response corresponding to a greet action can be included by feedback state chatbot agent component 155, for example, in case of the language model 110 failing to follow instructions.

In some embodiments, feedback state chatbot agent component 155 includes a goodbye action (e.g., goodbye action 512 of FIG. 5). Goodbye action can be instructed to be used by feedback state chatbot agent component 155 when it is time to say goodbye the user. Generally, the effect of the action is to add a conversation turn of the bot providing a parting remark to end the conversation (e.g., or a portion of the conversation) with the user. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to provide a parting remark to the user may be provided in a prompt to language model 110 by feedback state chatbot agent component 155. Language model 110 may return a response to feedback state chatbot agent component 155 to provide a parting remark. Feedback state chatbot agent component 155 may provide the parting remark to the user through chat interface 108. In some embodiments, a hard coded response corresponding to a goodbye action can be included by feedback state chatbot agent component 155, for example, in case of the language model 110 failing to follow instructions.

In some embodiments, feedback state chatbot agent component 155 includes a route to teammate/escalate action (e.g., escalate action 318 of FIG. 3). In some embodiments, route to teammate/escalate action can be instructed based on determining a response from the user requires a human to communicate with the user. For example, route to teammate/escalate action can be instructed to be used when a user explicitly asks to talk to a human. Generally, the effect of the action is to add a conversation turn of the bot to provide a textual response informing the user that they are being redirected to a human (e.g., a CSA) and/or instructing route to agent component 158 of chatbot component 151 to initiate a handover of the conversation to the human. For example, textual content of the conversation can be provided to language model 110 in order to determine whether to implement this action and/or the output response of the action. In this regard, textual content of the conversation turn of the bot will be the computed action input (e.g., as provided by language model 110). The textual content of the conversation turn of the bot is then provided to the user as output of the action. For example, an instruction to provide a textual response informing the user that they are being redirected to a human and/or instructing route to agent component 158 of chatbot component 151 to initiate a handover of the conversation to the human may be provided in a prompt to language model 110 by feedback state chatbot agent component 155. Language model 110 may return a response to feedback state chatbot agent component 155 to provide a textual response informing the user that they are being redirected to a human and/or instructing route to agent component 158 of chatbot component 151 to initiate a handover of the conversation to the human. Feedback state chatbot agent component 155 may provide the textual response informing the user that they are being redirected to a human to the user through chat interface 108. Feedback state agent may communicate with route to agent component 158 of chatbot component 151 to initiate a handover of the conversation to the human. In some embodiments, a hard coded response corresponding to a route to teammate/escalate action can be included by feedback state chatbot agent component 155, for example, in case of the language model 110 failing to follow instructions.

In some embodiments, feedback state chatbot agent component 155 includes a route to start agent action (e.g., route to main action 516 of FIG. 5). Route to start agent action can be instructed to be used by feedback state chatbot agent component 155 when the user asks another question. In some embodiments, there is no visible effect in the conversation, but agency over conversation is transferred to start state chatbot agent component 153 and start state chatbot agent component 153 processes the last user message in order to determine the appropriate action.

Data regarding the prompts utilized by chatbot component 151 and/or data communicated to/from the language model 110, customer device 102, and/or customer support device 112 can be stored in any suitable storage location, such as storage 130, customer support device 112, server 150, some combination thereof, and/or other locations as communication records files 131 and/or chatbot configuration files 140.

In an example implementation, chat interface 108 provides interface functionality that allows a user (e.g., a customer) to communicate with a chatbot and/or a CSA. Generally, chat interface 108 presents one or more interaction elements that provide various interaction modalities for chatting with a chatbot and/or a CSA. In various embodiments, these tools are implemented using code that causes a presentation of a corresponding interaction element(s), and detects and interprets inputs interacting with the interaction element(s).

In an example implementation, chatbot preview tool 128 provides interface functionality that allows a user (e.g., CSA) to communicate with a chatbot, for example, to preview the functionality of the chatbot. Generally, chatbot preview tool 128 presents one or more interaction elements that provide various interaction modalities for chatting with a chatbot. In various embodiments, these tools are implemented using code that causes a presentation of a corresponding interaction element(s), and detects and interprets inputs interacting with the interaction element(s).

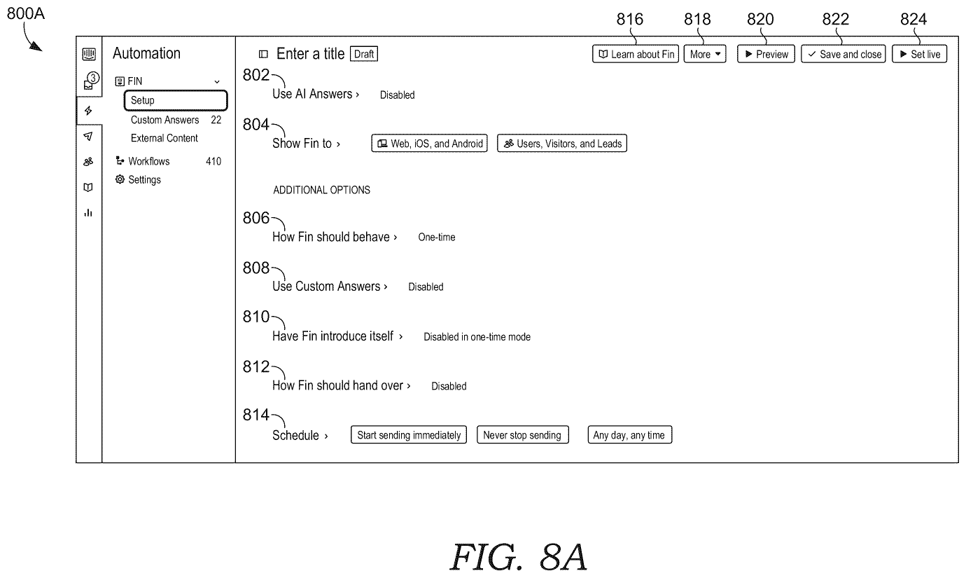

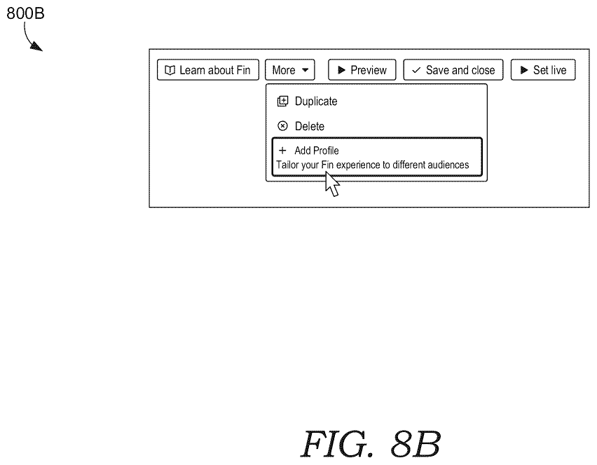

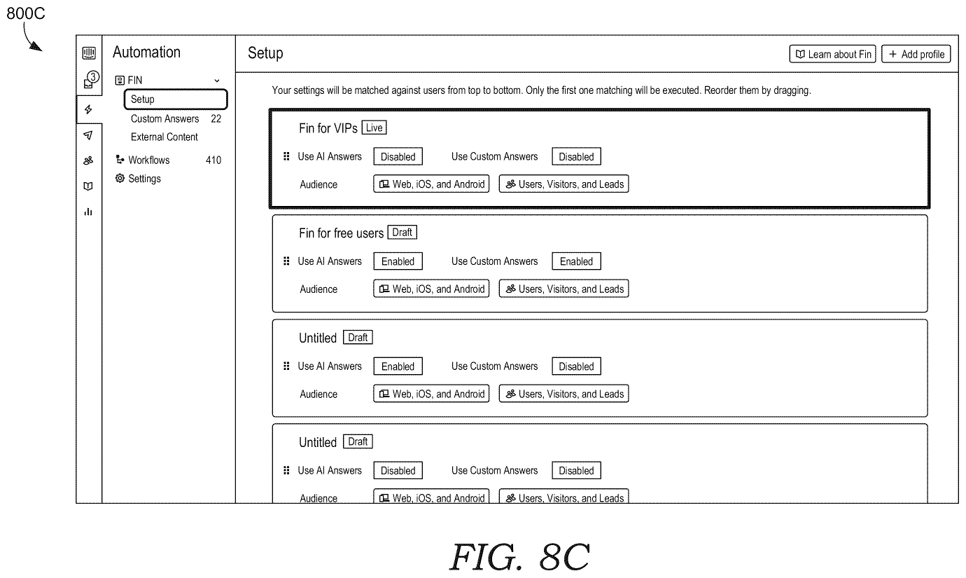

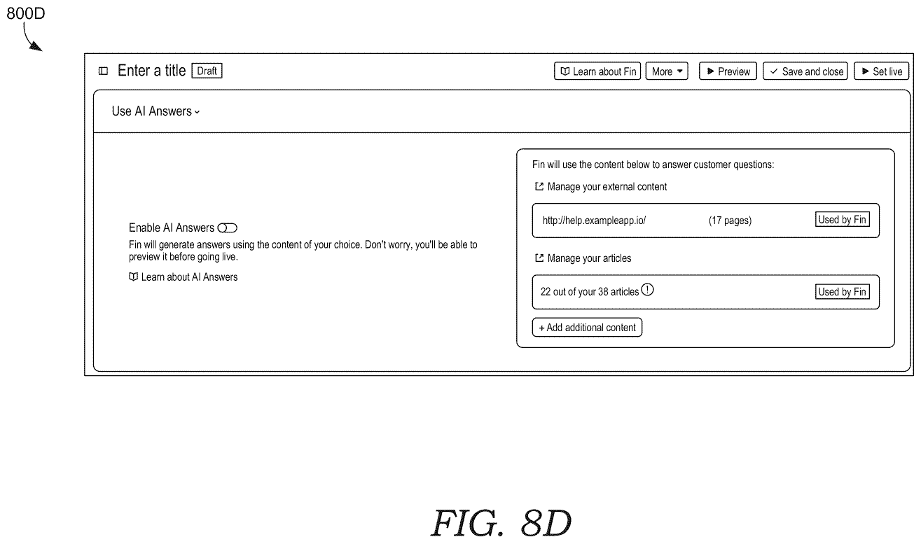

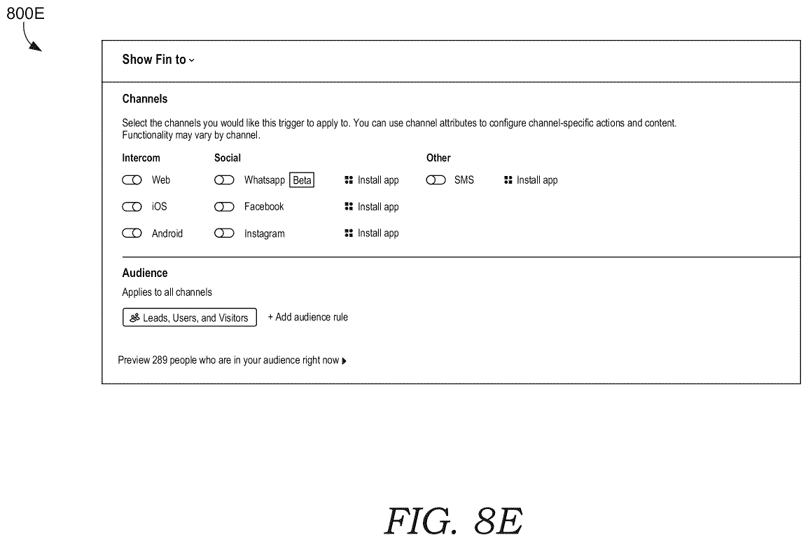

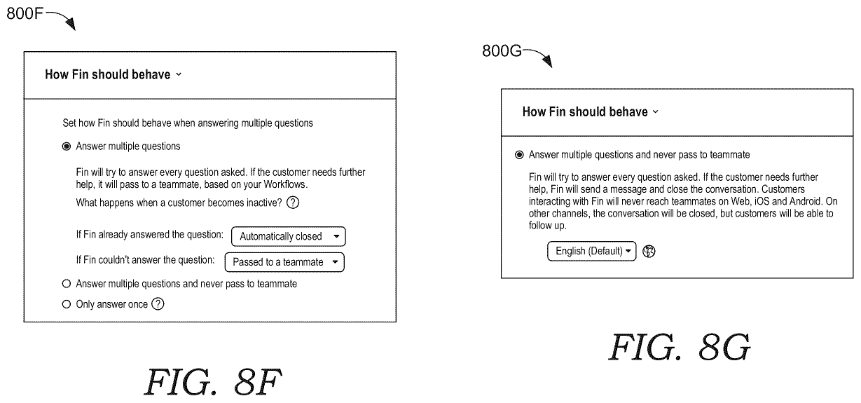

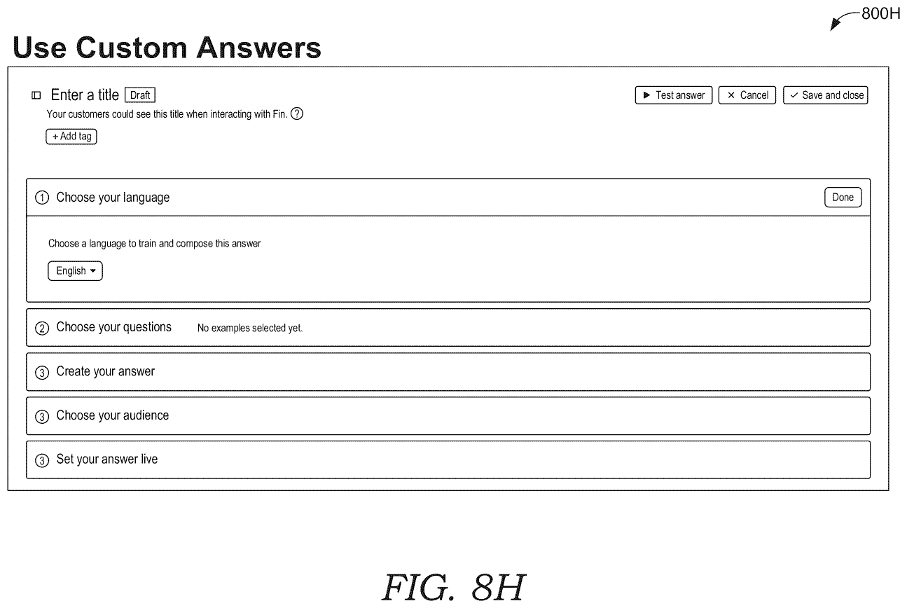

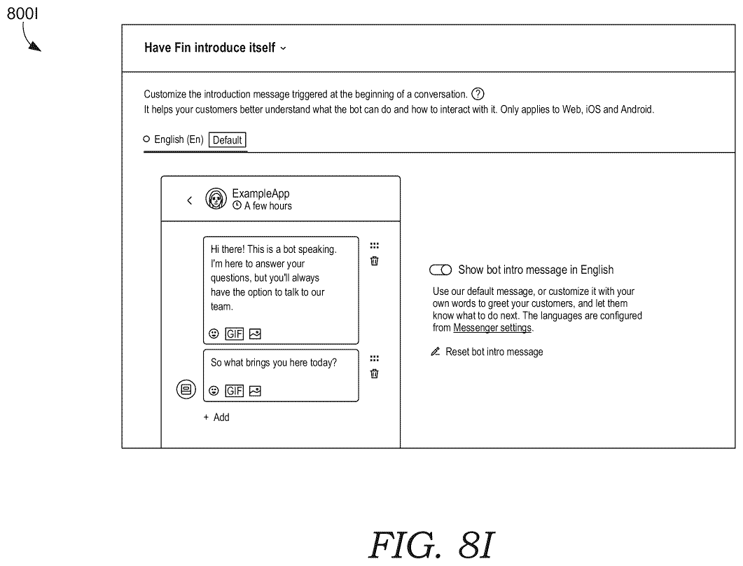

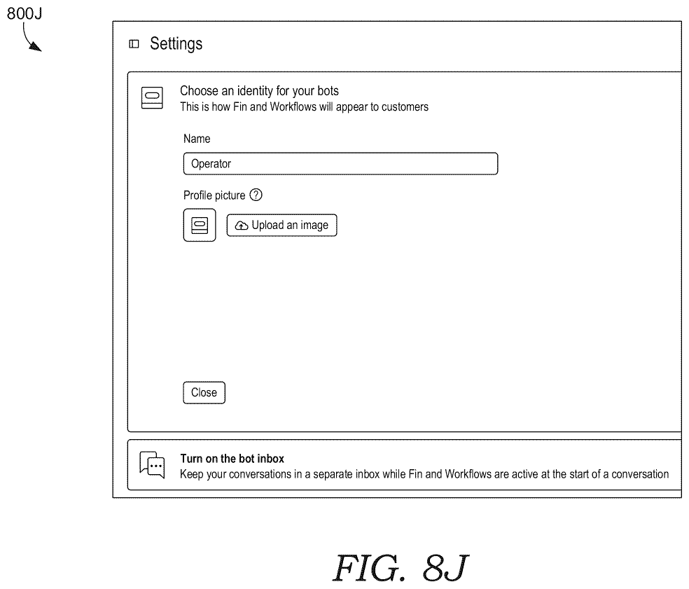

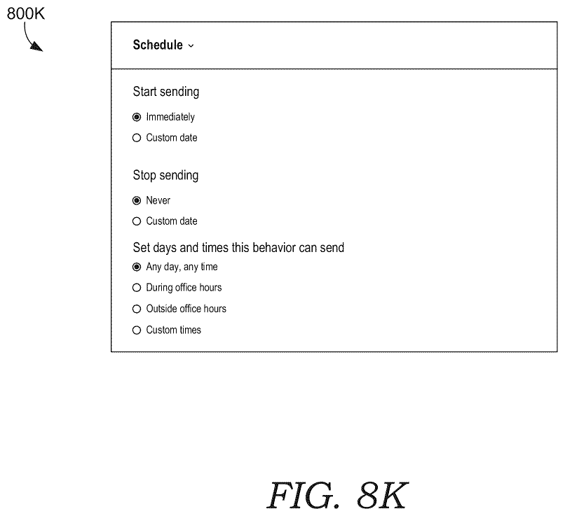

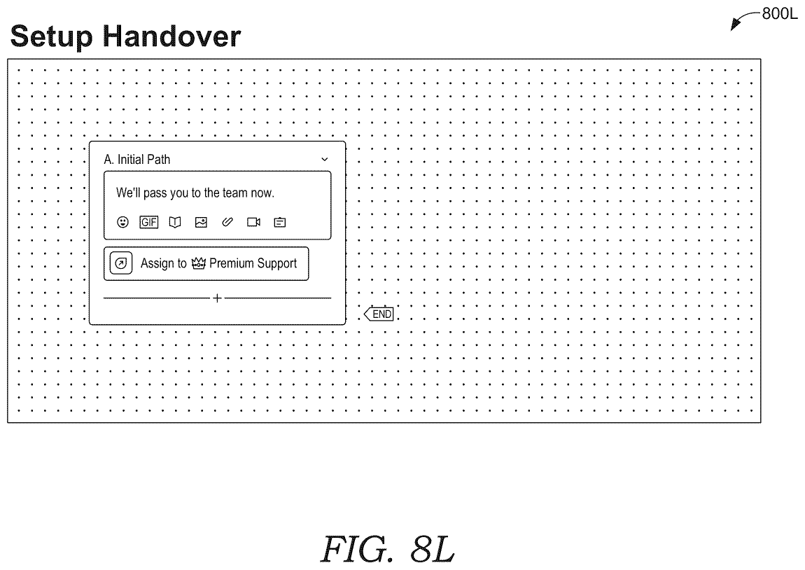

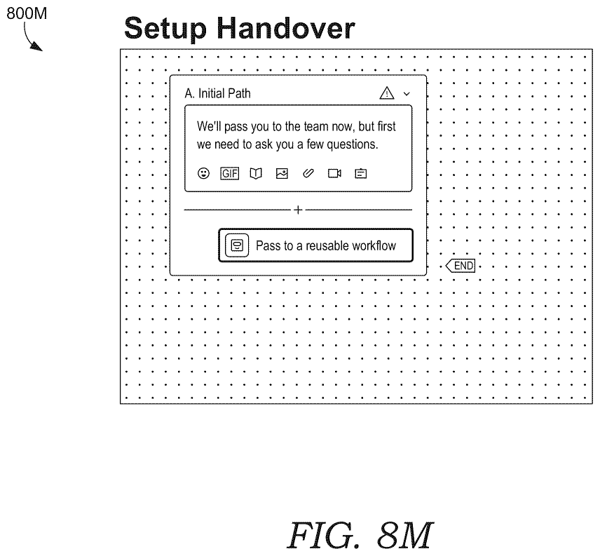

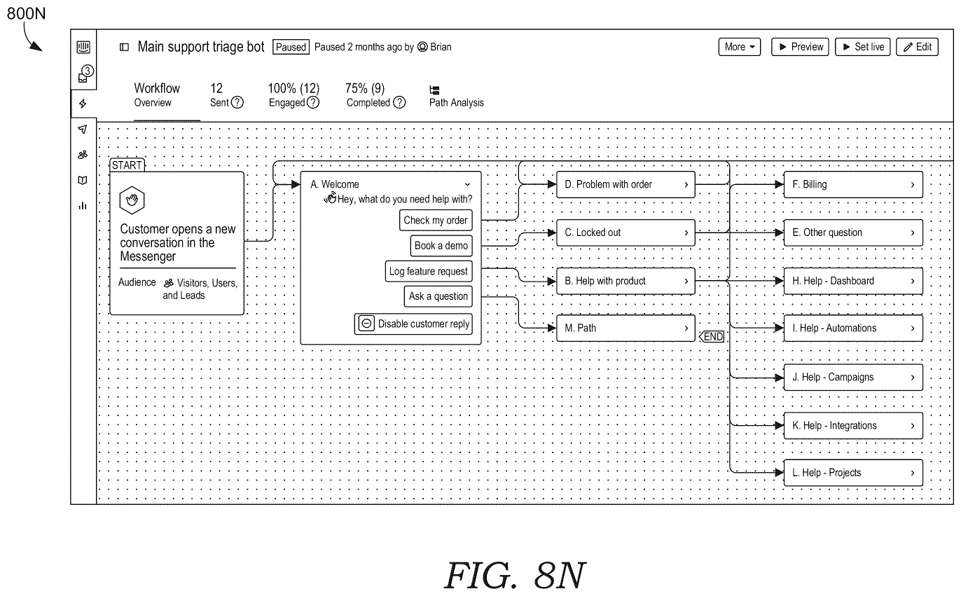

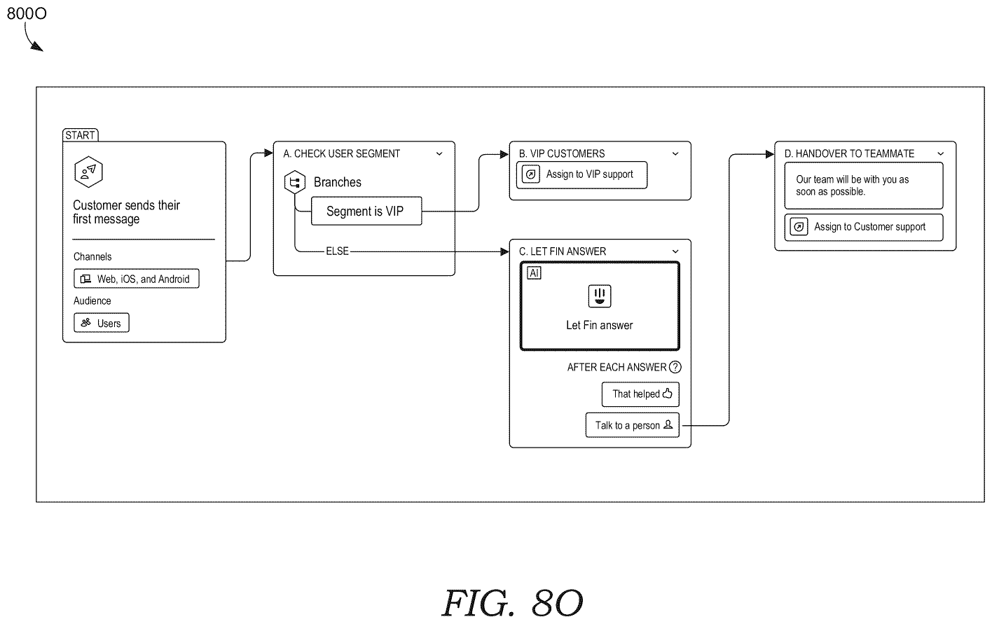

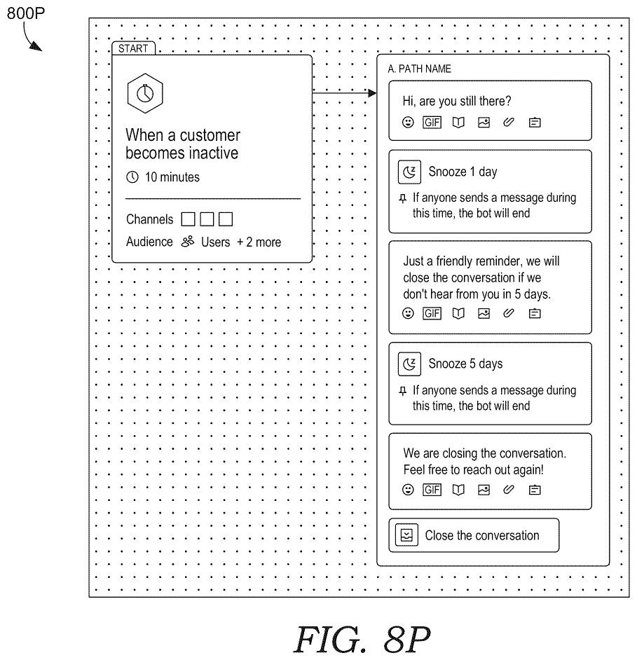

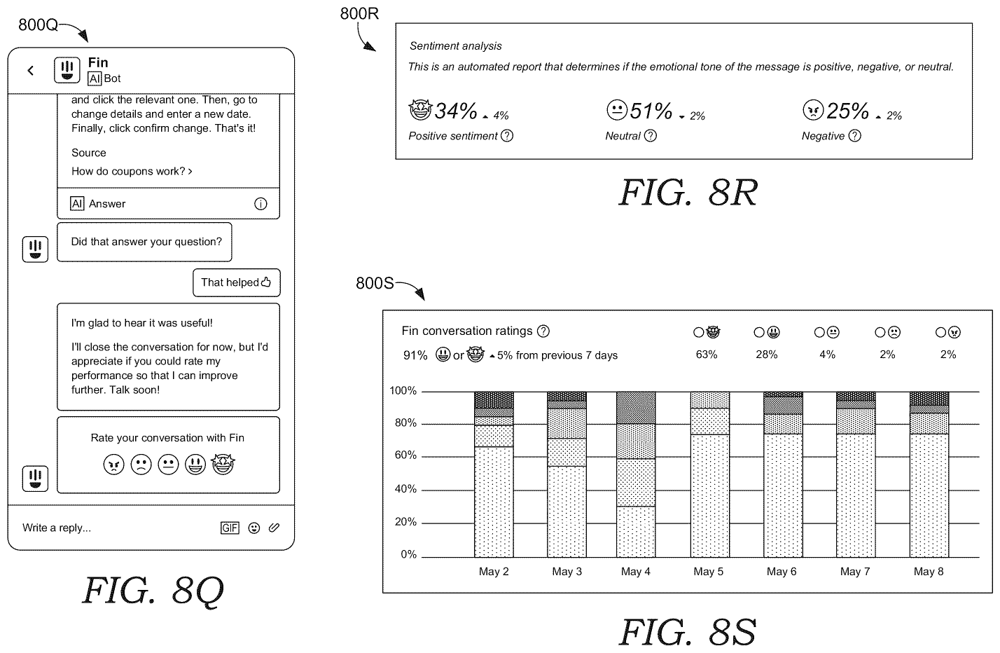

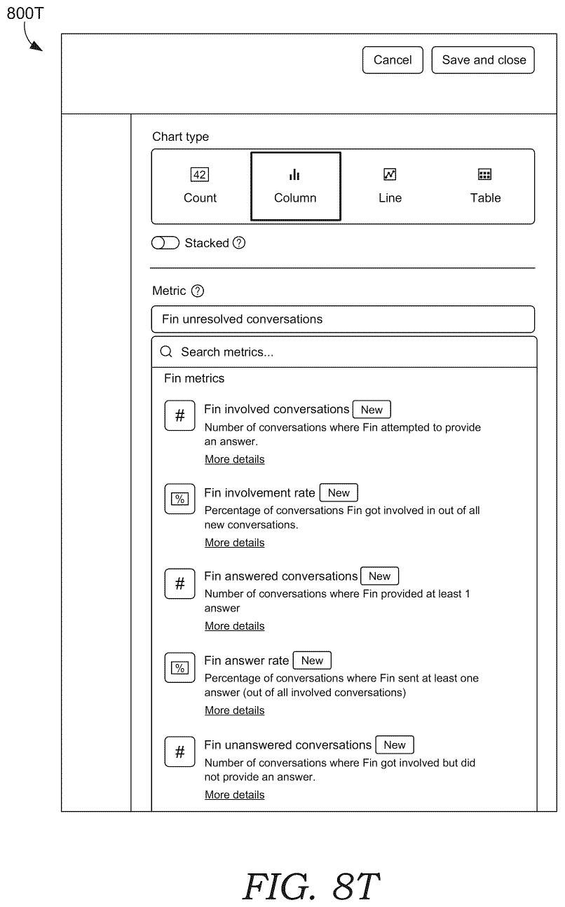

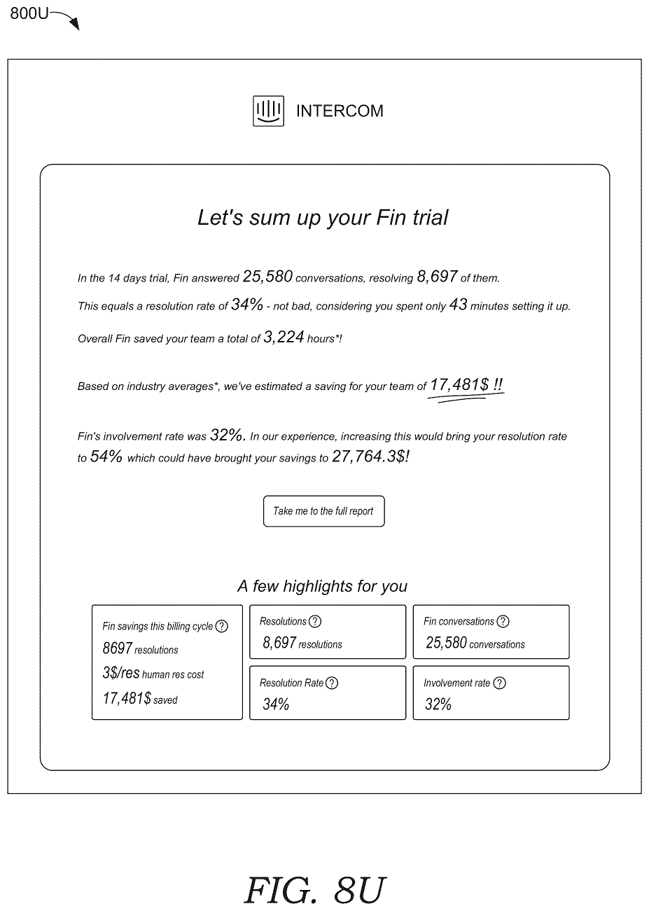

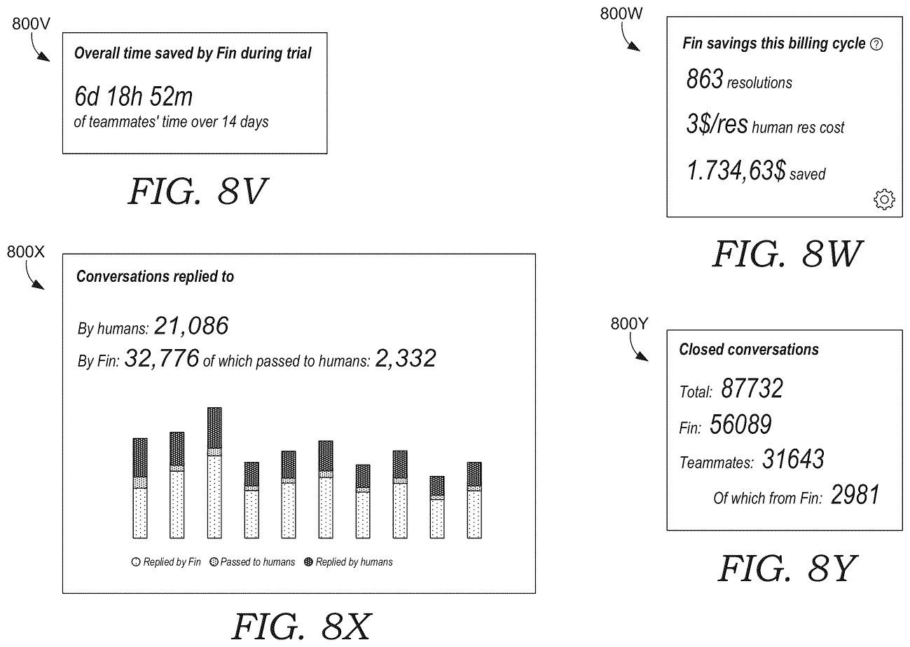

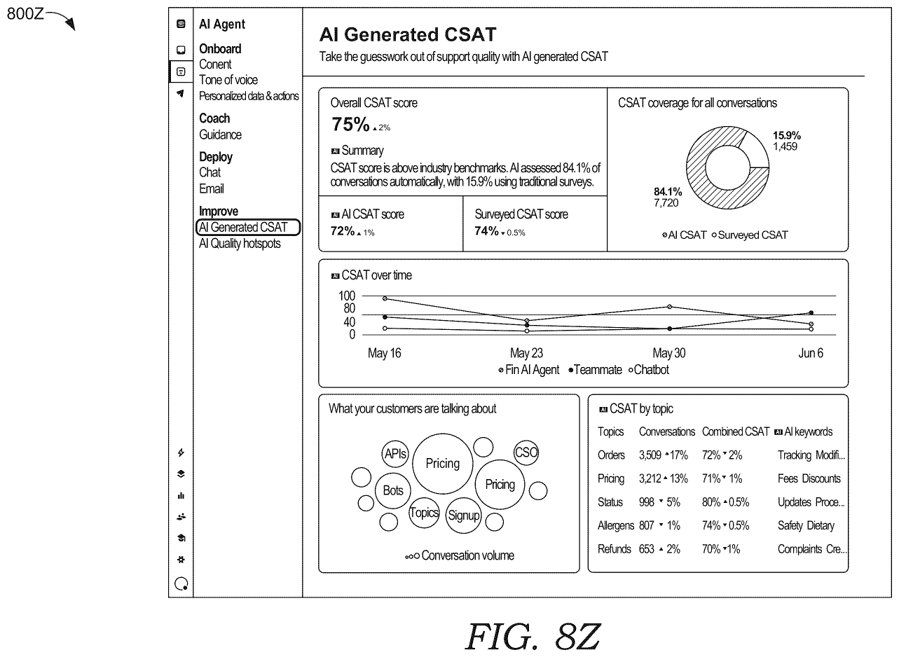

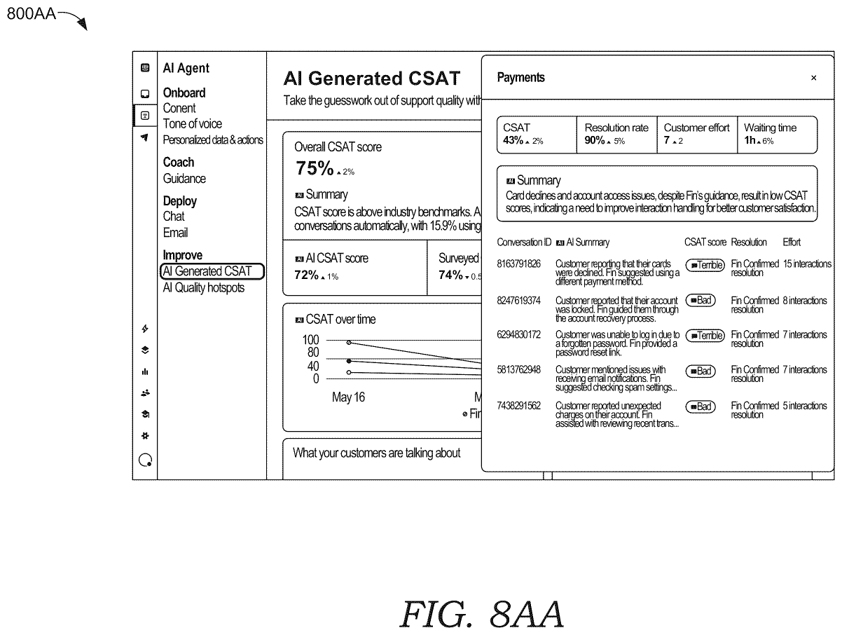

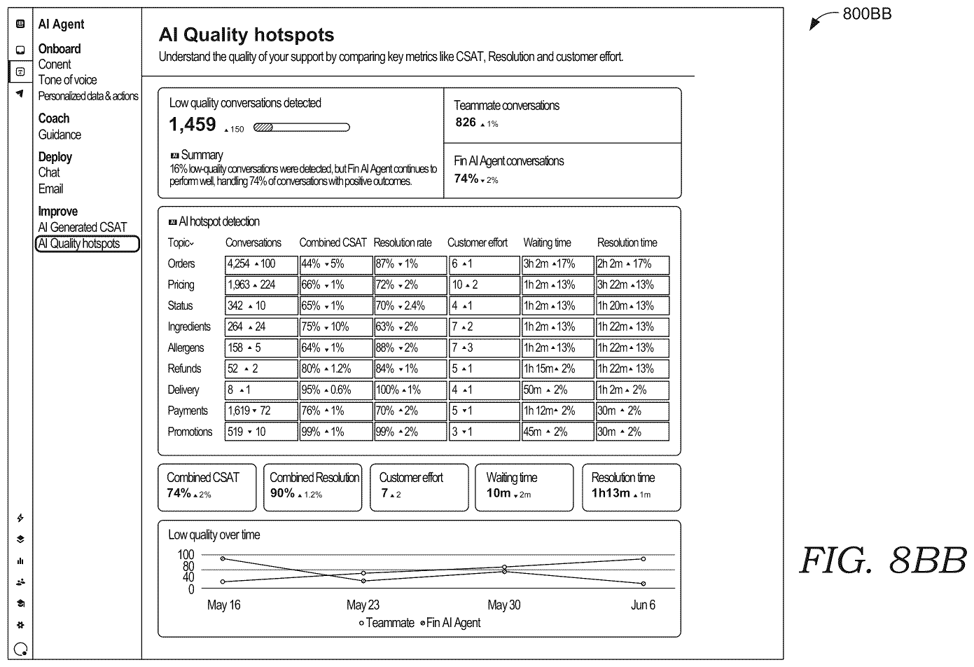

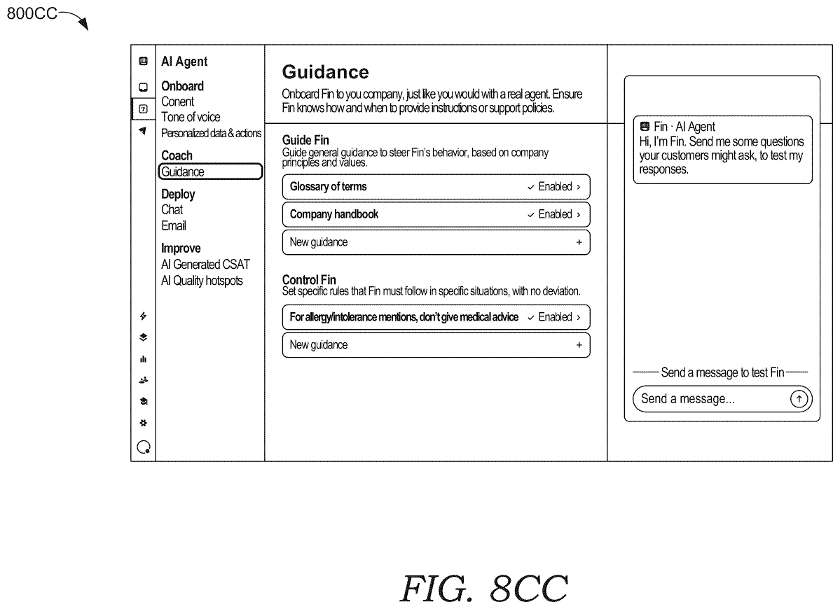

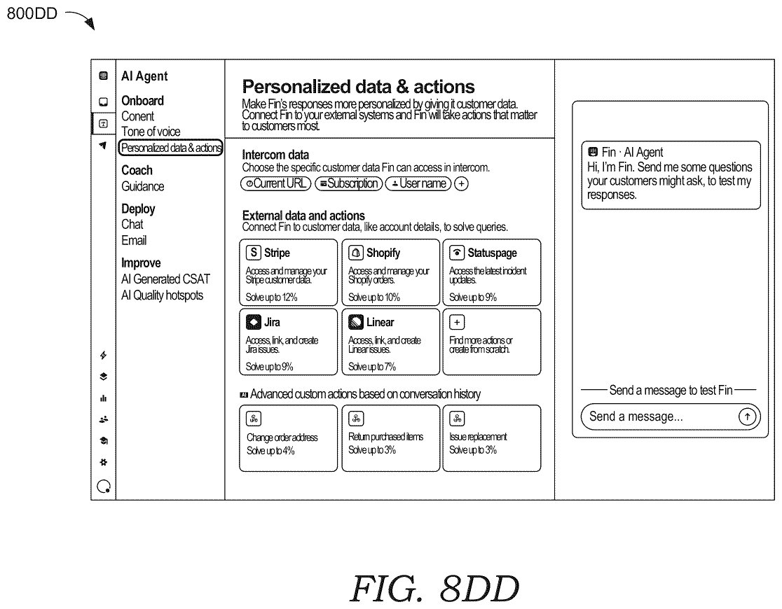

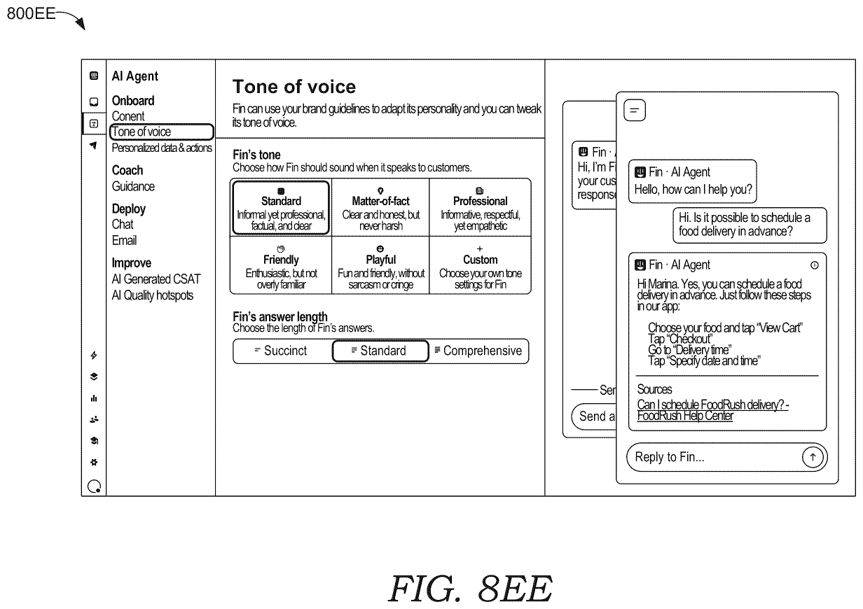

Examples of a chat interface displayed to a customer (e.g., via chat interface 108) and/or CSA (e.g., via chatbot preview tool 128) are shown in FIGS. 6A-6E and 8Q.

### Example Chatbot Configuration Environment

Returning to FIG. 1, chatbot configuration component 152 facilitates programmatically implementing settings and/or configuration of the chatbot in order to customize the chatbot of chatbot component 151 with chat interface 108 of application 106 of customer device 102. Examples of details regarding settings and/or configuration of the chatbot implemented by chatbot configuration component 152 are discussed in further detail with respect to chatbot tool 170. For example, a chatbot implemented by chatbot component may have a specific configuration based on the type of customer, such as different sets of documents in a knowledge base or different language settings. In some embodiments, multiple chatbots with different configurations can be implemented, for example, in order to address different types of customers. Data regarding the configuration of the chatbot can be stored in any suitable storage location, such as storage 130, customer support device 112, server 150, some combination thereof, and/or other locations as chatbot configuration files 140, workflow configuration files 142, language configuration files 143, and/or third-party application configuration files 144.

Customer data accessing component 156 facilitates programmatically accessing customer data (e.g., customer data files 141) in order to implement a chatbot configuration of a chatbot implemented by chatbot component 151 based on the customer data of the customer. For example, a chatbot may access certain portions of the knowledge based on the status of the customer as a VIP. Customer data can be stored in any suitable storage location, such as storage 130, customer support device 112, server 150, some combination thereof, and/or other locations as customer data files 141. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, sports data, health data, and nearly any other source of data that may be used to identify the customer.

Knowledge base accessing component 157 facilitates programmatically implementing access to the knowledge base. In some embodiments, knowledge base accessing component 157 accesses portions of the knowledge base based on the configuration of the chatbot implemented by chatbot component 151. For example, the configuration of chatbot component 151 may indicate that only a specific set of documents of the knowledge base should be searched by the chatbot. In some embodiments, knowledge base accessing component 157 automatically syncs content (e.g., such as content provided by content management tool 173 and/or snippets tool 129) provided by the customer support application 116 and/or stored in knowledge base 132. Data regarding the configuration of the chatbot facilitating access to different portions of the knowledge base can be stored in any suitable storage location, such as storage 130, customer support device 112, server 150, some combination thereof, and/or other locations as chatbot configuration files 140.

Route to agent component 158 facilitates programmatically implementing routing of a conversation from a chatbot to a CSA via the customer support component 165 to the communication tool 120 of the customer support application 116. For example, if a customer request to speak to a person or the chatbot decides to route to teammate/escalation action, route to agent component 158 automatically implements the routing of the conversation from the chatbot to a CSA. Data regarding the configuration of the chatbot to route to a CSA can be stored in any suitable storage location, such as storage 130, customer support device 112, server 150, some combination thereof, and/or other locations as chatbot configuration files 140.

Chat workflow implementation component 159 facilitates programmatically implementing chat workflows designed to implement bots, triggers, conditions, and/or rules for chats. For example, a CSA can designed a chat workflow through cat workflow design tool so that the chatbot automatically implements certain actions, such as asking for specific information, before routing to a CSA. Data regarding chat workflows of the chatbot can be stored in any suitable storage location, such as storage 130, customer support device 112, server 150, some combination thereof, and/or other locations as workflow configuration files 142.

Custom answers component 160 facilitates programmatically implementing manually written answers and/or chat workflows to specific questions from customers by prioritizing the custom answers over AI-generated answers from the chatbot. In some embodiments, custom answers are searched using SBERT directly. For example, an embedding generated based on the customer's query can be searched against embeddings of one or more example questions corresponding to a custom answer (e.g., a user of customer support application 116 can input multiple examples of a single question. In some embodiments, the custom answer can include examples of questions, keywords, and/or phrases to automatically call a chat workflow designed in chat workflow design tool 180 and implemented by chat workflow implementation component 159. For example, if a customer requests a refund through chat interface 108, the custom answer for a refund can be determined through SBERT, which implements a chat workflow that automatically calls an API to trigger a refund. Data regarding custom answers can be stored in any suitable storage location, such as storage 130, customer support device 112, server 150, some combination thereof, and/or other locations as custom answer files 139.

Chatbot analysis component 161 facilitates programmatically generating reports by analyzing chatbot performance chatbot conversation monitoring, chatbot customer satisfaction score (CSAT), usage metrics, usage limits notifications, performance/return on investment (ROI) metrics, custom reports, and/or content-level metrics regarding access to content. Data regarding analysis of chatbots can be stored in any suitable storage location, such as storage 130, customer support device 112, server 150, some combination thereof, and/or other locations as metrics files 145.

In an example implementation, chatbot tool 170 provides interface functionality that allows a user (e.g., a CSA) of customer support application 116 to implement settings and/or configuration of the chatbot in order to customize the chatbot of chatbot component. Generally, chatbot tool 170 presents one or more interaction elements that provide various interaction modalities for customizing the chatbot. In various embodiments, these tools are implemented using code that causes a presentation of a corresponding interaction element(s), and detects and interprets inputs interacting with the interaction element(s). An example of chatbot tool 170 is shown in FIG. 8A.

In the example implementation in FIG. 1, chatbot tool 170 includes chatbot introduction customization tool 171 that allows the user to provide a custom introduction for the chatbot, which can be stored in chatbot configuration files 140. An example of chatbot introduction customization tool 171 is shown in FIG. 8I.

Chatbot tool 170 includes chatbot identity customization tool 172 that allows the user to rename the chatbot and/or change the image/icon for the chatbot, which can be stored in chatbot configuration files 140. An example of chatbot identity customization tool 172 is shown in FIG. 8J.

Chatbot tool 170 includes content management tool 173 that allows the selection of content of the knowledge base 132 that the chatbot uses to search for answers. For example, the CSA may not want to utilize certain content as the content may be outdated. As another example, different content can be utilized for different audiences to target the chatbot to different audiences, such as based on customer data or customer segment (e.g., VIP customer). In some embodiments, knowledge base accessing component 157 automatically syncs any content (e.g., such as content provided by content management tool 173) provided by the customer support application 116 and/or stored in knowledge base 132. In some embodiments, content management tool 173 allows the selection of multimodal content stored in knowledge base 132 in order for the chatbot to provide multimodal answers, such as images, audio, and/or video in responses. In some embodiments, content management tool 173 allows the selection of external systems, such as an external application (e.g., an ecommerce store and/or system) through third-party application configuration files 144, in order for the chatbot to utilize external systems to provide answers. An example of content management tool 173 is shown in FIG. 8D.

Chatbot tool 170 includes audience selection tool 174 that allows the selection of audience to target the chatbot, such as based on customer data or customer segment (e.g., VIP customer) based on customer data stored in customer data files 141. Examples of audience selection tool 174 are shown in FIGS. 8B and 8C.

Chatbot tool 170 includes communication channel selection tool 175 that allows the selection of various communication channels, such as Web, mobile, application, telephonic, SMS, messaging applications, social media, email, and/or any communication channel (e.g., as stored in third-party application configuration files 144). In some embodiments, the chatbots can be deployed on any number of communication channels. In some embodiments, different settings/configuration of the chatbot can be applied to different communication channels. For example, only some content of knowledge base 132 may be utilized by chatbot for customers communicating through a specific communication channel. In some embodiments, communication channel selection tool 175 allows the selection of multimodal receiving input user queries and/or outputting responses by the chatbot via audio. An example of communication channel selection tool 175 is shown in FIG. 8E.

Chatbot tool 170 includes chatbot behavior settings tool 176 that allows a user to provide settings for the chatbot regarding how the chatbot should behave when answering multiple questions and/or when to handover the chatbot to a teammate, which can be stored in chatbot configuration files 140. Examples of chatbot behavior settings tool 176 are shown in FIGS. 8F and 8G.

Chatbot tool 170 includes inactive conversations settings tool 177 that allows a user of customer support application 116 to set automatic replies to inactive conversations, which can be stored in chatbot configuration files 140 and/or workflow configuration files 142. For example, inactive conversations settings tool 177 can send auto-replies to snoozed conversations. As another example, inactive conversations settings tool 177 can automate snoozing and set conversation pacing with new actions. As yet another example, inactive conversations settings tool 177 can automatically reroute conversations that receive no response to a human, such as a CSA. In some embodiments, inactive conversations settings tool 177 is implemented through chat workflow design tool 180 as a part of a chat workflow. An example of inactive conversations settings tool 177 is shown in FIG. 8P.

Chatbot tool 170 includes language settings tool 178 allows the chatbot to be multilingual and/or target the chatbot differently to customers in different languages, which can be stored in language configuration files 143. For example, only some content of knowledge base 132 may be utilized by chatbot for customers communicating in a specific language. Example of language settings tool 178 are shown in FIGS. 8G and 8I.

Chatbot tool 170 includes scheduling settings tool 179 that allows a user to provide settings as to when to enable a chatbot, which can be stored in chatbot configuration files 140. For example, the chatbot can be implemented only for certain timeframe. An example of scheduling settings tool 179 is shown in FIG. 8K.

Chatbot tool 170 includes chat workflow design tool 180 allows the user of the customer support application 116 to design chat workflows, which can be stored as workflow configuration files 142. For example, the user can design chat workflows to handoff to support teams or to other bots. For example, a chatbot can include a chat workflow can be designed to automatically handover to a CSA when the chatbot cannot answer the question. As another example, a chat workflow can be designed to automatically implement a chat workflow to request additional information from the customer before handing the chat over to a CSA when the chatbot cannot answer a question. In some embodiments, the chatbot that uses a language model to determine answers from a knowledge base (e.g., knowledge base 132 of FIG. 1) can be implemented in an initial block of the chat workflow. In some embodiments, a chat workflow can be designed to implement the chatbot that uses a language model to determine answers from a knowledge base at a later block in the workflow. For example, the chatbot may determine whether the customer data indicates the customer is not a VIP customer that is automatically assigned to a CSA before implementing the chatbot that uses a language model to determine answers from a knowledge base. Examples of chat workflow design tool 180 are shown in FIGS. 8L, 8M, 8N, 8O, and 8P.

Chatbot tool 170 includes chatbot analysis tool 181 that provides an interface for generating reports analyzing chatbot performance, such as through chatbot conversation monitoring, chatbot CSAT, usage metrics, usage limits notifications, performance/ROI metrics, custom reports, and/or content-level metrics, which can be stored as metrics files 145. Examples of chatbot analysis tool 181 and output of chatbot analysis tool 181 are shown in FIGS. 8Q, 8R, 8S, 8T, 8U, 8V, 8W, 8X, and 8Y.

Chatbot tool 170 includes custom answers tool 182 that provides an interface for a user to implement manually written answers and/or chat workflows to specific questions from customers. For example, a user of the customer support application 116 may provide a specific written answer and examples of potential customer questions that would require the specific written answer so that specific written answer is provided without requiring the chatbot to call the language model. In some embodiments, the custom answer can include examples of questions, keywords, and/or phrases to automatically call a chat workflow designed in chat workflow design tool 180 and implemented by chat workflow implementation component 159. For example, if a customer requests a refund through chat interface 108, the custom answer for a refund can be determined through SBERT based on aspects of the conversation, which implements a chat workflow that automatically calls an API to trigger a refund. An example of custom answers tool 182 is shown in FIG. 8H.

### Example Customer Support Communication Environment

Continuing with FIG. 1, in some embodiments, customer support component 165 provides functionality to enable communication between customer support application 116 and chat interface 108. Data regarding conversations between customers and CSA can be stored in any suitable storage location, such as storage 130, customer support device 112, server 150, some combination thereof, and/or other locations as communication records files 131.

In some embodiments, messages routing component 166 routes messages from conversations from customers, such as conversations between a customer and a chatbot (e.g., through route to agent component 158 of chatbot component 151). In some embodiments, messages routing component 166 routes messages to and/or from customers from various communication channels, such as Web, mobile, application, telephonic, SMS, messaging applications, social media, email, and/or any communication channel. Messages routing component 166 can route messages to messages inbox interface 122 and/or chat interface 124 of a customer support application 116 of a CSA.

In some embodiments, AI-assisted chat component 167 assists customer support in responding to customers in chats using AI. For example, a language model may be called to revise an initial response drafted by the CSA to expand the response, rephrase the response, make the response more formal, make the response friendlier, and/or the like. As another example, using a similar process as the answer search state component 154 of chatbot component 151, the AI-assisted chat component 167 can determine answers to customer queries and provide the answers as suggestions to the CSA to respond to the customer query.

In some embodiments, snippets component 168 can programmatically extract conversational snippets from conversations between a customer and a CSA (e.g., from a communication record of communication records files 131, such as a chat log, chat transcript, meeting transcript, email, or other communication between a customer and a CSA). For example, a customer initiates a chat with a CSA through a chat interface 108 of application 106 executing on customer device 102. During the chat, the customer asks the CSA a series of questions and the CSA provides answers to each question through chat interface 124 of application 116 executing on customer support device 112 before the chat is ended. After the chat ends, the chat is stored (e.g., communication records files 131) so that the chat can be accessed in order to extract each question and corresponding answer (“Q&A pairs”) from the chat in a subsequent block. In some embodiments, the conversation can be accessed from the communication record by snippets component 168 during the conversation (e.g., chat) between the customer and the CSA in order to extract Q&A pairs from the conversation during the conversation. Snippets component 168 generates a prompt to language model 110 in order to extract Q&A pairs from the portion of the conversation record and to generate a single, summarized Q&A pair based on the Q&A pairs extracted from the conversation record. In some embodiments, snippets component generates a prompt to language model 110 to tag each Q&A pair of the conversation with contextual metadata corresponding to each of the Q&A pairs and filter irrelevant Q&A pairs of the conversation based on the metadata of each Q&A pair before generating a single, summarized Q&A pair based on the remaining Q&A pairs extracted from the conversation record. Examples of contextual metadata include: (1) contextual metadata corresponding to whether the question was answered by a human (e.g., a CSA) or a bot (e.g., the chatbot); (2) contextual metadata corresponding to the topic of the Q&A pair; (3) contextual metadata corresponding to a score indicating the relevance of the Q&A pair to other customers; and/or (4) contextual metadata corresponding to a dialog classification corresponding to a category of the type of dialogue. Examples of the type of dialogue can include: (a) informational content where an answer in the Q&A pair is directed to general information, knowledge and/or instructions; (b) a clarification where an answer in the Q&A pair is a request for clarification from the user; (c) a CSA action where an answer in the Q&A pair required the CSA to take some action on the background of the conversation; (d) a feature request where an answer in the Q&A pair is directed to future product improvements or feature requests; and/or (e) other categories or a category for an answer in the Q&A pair does not fit into the previous specified types of dialogue.

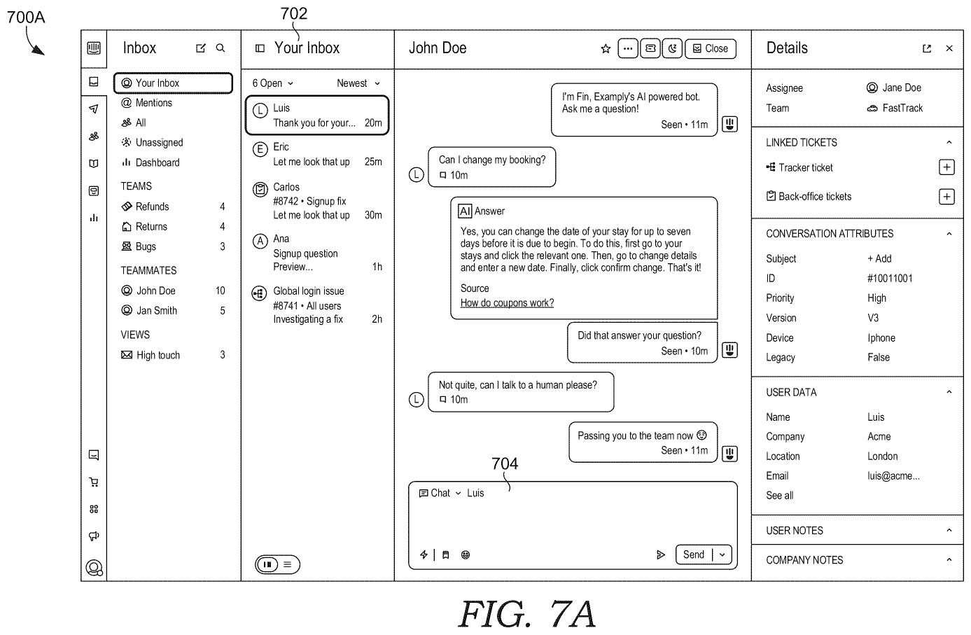

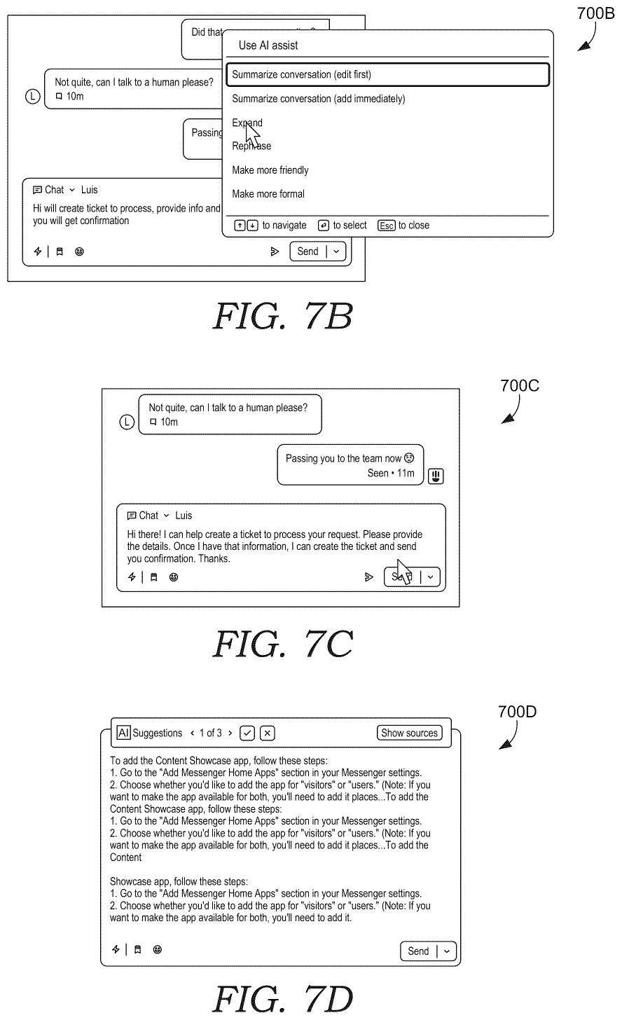

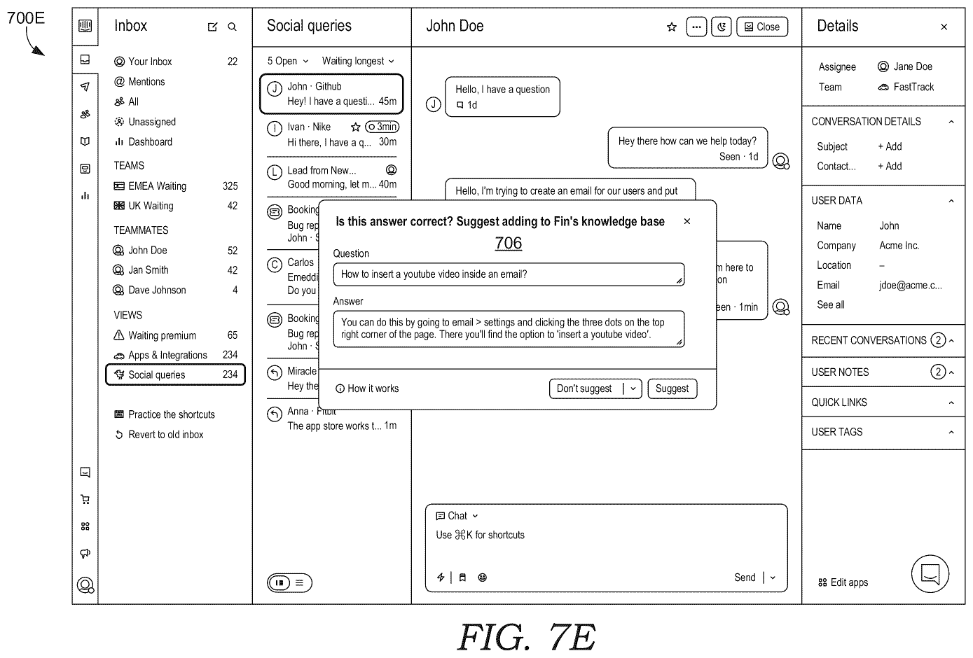

In an example implementation, communication tool 120 provides interface functionality that allows a user (e.g., a CSA) to chat with a customer, chat with a customer with AI-assisted chat capabilities, trigger extractions of snippets, interact with messages from various customers and/or communication channels through their inbox, and/or preview a chatbot through interactions with an interface controlled by communication tool 120. Generally, communication tool 120 presents one or more interaction elements that provide various interaction modalities for its functionality. In various embodiments, these tools are implemented using code that causes a presentation of a corresponding interaction element(s), and detects and interprets inputs interacting with the interaction element(s). An example of communication tool 120 is shown in FIG. 7A.

In the example implementation in FIG. 1, communication tool 120 includes messages inbox interface 122 that allows a user of customer support application 116 to view conversations from various customers and/or communication channels. An example of messages inbox interface 122 is shown in FIG. 7A. Communication tool 120 includes chat interface 124 that allows a user to communicate and/or view a chat with a customer, such as a conversation between a customer and a CSA and/or a chatbot. An example of chat interface 124 is shown in FIG. 7A. Communication tool 120 includes AI-assisted chat tool 126 that assists customer support in responding to customers in chats using AI. Examples of AI-assisted chat tool 126 is shown in FIGS. 7B, 7C, and 7D.

Communication tool 120 includes chatbot preview tool 128 allows the user of the customer support application 116 to preview the chatbot, such as before setting the chatbot live for customers. An example of chatbot preview tool 128 is shown in FIGS. 6A, 6B, 6C, 6D, and 6E.

Communication tool 120 includes snippets tool 129 that provides an interface so that users of customer support application 116 can add snippets determined from conversational data (e.g., communication records files 131) by snippets component 168 to add to the knowledge base 132 (e.g., snippets files 133). In this regard, the answers in snippets of snippets files 133 can be edited, targeted (e.g., by content management tool 173), and managed in the knowledge base utilized by the chatbot to provide answers. An example of snippets tool 129 is shown in FIG. 7E.

### Example Chat Interface

FIG. 6A provides an example chat interface 600A between a chatbot and a user, in accordance with embodiments of the present disclosure. FIG. 6B provides an example chat interface 600B between a chatbot and a user showing the delivery of responses word by word from the chatbot to the user, in accordance with embodiments of the present disclosure. As can be understood, in some embodiments, responses (e.g., answers) from the chatbot are deliver word by word to the end user in order to reduce answer latency. FIG. 6C provides an example chat interface 600C between a chatbot and a user showing a response from the chatbot with a corresponding source of the response, in accordance with embodiments of the present disclosure.

FIG. 6D provides an example chat interface 600D between a chatbot and a user showing responses from the chatbot including a request for feedback, request for clarification, and a response with a prompt to route to a human, in accordance with embodiments of the present disclosure. FIG. 6E provides an example chat interface 600E between a chatbot and a user showing a response from the chatbot that routes the chat with the user to a human, in accordance with embodiments of the present disclosure.

### Example Customer Support Application Interface

FIG. 7A provides an example interface 700A of a customer support application, including, among other things, an inbox and a chat interface, in accordance with embodiments of the present disclosure. As can be understood, example interface 700A provides inbox 702 with a number of messages from various communication channels and chat interface 704 for communicating with customers. FIG. 7B provides an example chat interface 700B of a customer support application, including an AI-assisted chat tool, in accordance with embodiments of the present disclosure. FIG. 7C provides an example chat interface 700C of a customer support application implementing the AI-assisted chat tool on the chat interface of FIG. 7B, in accordance with embodiments of the present disclosure. As can be understood, as the CSA selects expand, the language model is called to automatically expand the response provided by the CSA in example chat interface 700B of FIG. 7B to a longer response in the example chat interface 700C of FIG. 7C

FIG. 7D provides an example chat interface 700D of a customer support application implementing an AI-assisted chat tool to search for answers in knowledge base using a language model, in accordance with embodiments of the present disclosure. As can be understood, the language model is called to provide a suggested response for the CSA to send to the customer based on the conversation between the CSA and the customer.

FIG. 7E provides an example interface 700E for adding a conversational snippet from a communication record to a knowledge base, in accordance with embodiments of the present disclosure. In this example, interface 700E provides a list of chats with a selected chat. As can be understood, the suggestion element 706 of the single, summarized Q&A pair corresponding to the extracted conversational snippet from the conversation of selected chat is displayed to the end user (e.g., the CSA). The end user can then select whether to suggest adding the single, summarized Q&A pair to the knowledge base to store the Q&A pair through suggestion element 706.

### Example Embodiments of Chatbot Configuration Interface

FIG. 8A provides an example interface 800A of a chatbot tool of a customer support application, in accordance with embodiments of the present disclosure. In this example, interface 800A allows the CSA to customize the settings/configuration of the chatbot. For example, interface 800A provides a tool 802 to implement a chatbot using a language model to provide answers from a knowledge base. Interface 800A provides tool 804 including an audience selection tool, such as audience selection tool 174, and a communication channel selection tool. Interface 800A provides tool 806 including a chatbot behavior tool. Interface 800A provides tool 808 for custom answers. Interface 800A provides tool 810 for introduction customization. Interface 800A provides tool 812 for handover. Interface 800A provides tool 814 for scheduling. Interface 800A provides tool 816 for help with the chatbot configuration. Interface 800A provides tool 818 for additional options shown in example interface 800B of FIG. 8B. Interface 800A provides tool 820 as a chatbot preview. Interface 800A provides tool for saving and/or closing out of the chatbot configuration. Interface 800A provides tool 824 to set the chatbot live.

FIG. 8B provides an example interface 800B of an audience selection tool of a chatbot tool of a customer support application, in accordance with embodiments of the present disclosure. FIG. 8C provides another example interface 800C of an audience selection tool of a chatbot tool of a customer support application, in accordance with embodiments of the present disclosure. In the examples, interface 800B of FIG. 8B and interface 800C of FIG. 8C provide tools to tailor the chatbot to different audiences. For example, different chatbots and/or content utilized by the chatbots can be utilized for different audiences to target the chatbot to different audiences, such as based on customer data or customer segment (e.g., VIP customer).

FIG. 8D provides an example interface 800D of a content management tool of a chatbot tool of a customer support application, in accordance with embodiments of the present disclosure. In this example, interface 800D provides at tool to manage the content utilized by the chatbot to provide answers. For example, the CSA may not want to utilize certain content as the content may be outdated. As another example, different content can be utilized for different audiences to target the chatbot to different audiences, such as based on customer data or customer segment (e.g., VIP customer).

FIG. 8E provides an example interface 800E of a communication channel selection tool of a chatbot tool of a customer support application, in accordance with embodiments of the present disclosure. In this example, interface 800E provides a tool to customize the communication channels and audience for which the chatbot is implemented. For example, different settings/configuration of the chatbot can be applied to different communication channels. In this regard, only some content of the knowledge base may be utilized by the chatbot for customers communicating through a specific communication channel.

FIG. 8F provides an example interface 800F of a chatbot behavior settings tool of a chatbot tool of a customer support application, in accordance with embodiments of the present disclosure. In this example, interface 800F provides a tool to determine whether the chatbot should answer multiple questions and when to close and/or handoff to a human. FIG. 8G provides another example interface 800G of a chatbot behavior settings tool of a chatbot tool of a customer support application, in accordance with embodiments of the present disclosure. In this example, interface 800G provides a tool to include a setting for the chatbot to never handover to a human.

FIG. 8H provides an example interface 800H of a custom answers tool of a chatbot tool of a customer support application, in accordance with embodiments of the present disclosure. In this example, interface 800H provides a tool to manually implement written answers and/or chat workflows to specific questions from customers. For example, a CSA may provide a specific written answer and examples of potential customer questions that would require the specific written answer so that specific written answer is provided without requiring the chatbot to call the language model. In some embodiments, the custom answer can include examples of questions, keywords, and/or phrases to automatically call a chat workflow (e.g., as designed in chat workflow design tool of example interface 800N of FIG. 8N).

FIG. 8I provides an example interface 800I of a chatbot introduction customization tool and a language settings tool of a chatbot tool of a customer support application, in accordance with embodiments of the present disclosure. In this example, interface 800I provides to customize introduction of the chatbot. FIG. 8J provides an example interface 800J of a chatbot identity customization tool of a chatbot tool of a customer support application, in accordance with embodiments of the present disclosure. In this example, interface 800J provides a tool to customize the name and image/icon of the chatbot.

FIG. 8K provides an example interface 800K of a scheduling tool of a chatbot tool of a customer support application, in accordance with embodiments of the present disclosure. In this example, interface 800K provides a tool to determine when to implement the chatbot. For example, the chatbot can be implemented only for certain timeframe.

FIG. 8L provides an example interface 800L of a chat workflow design tool of a chatbot tool of a customer support application for setting up a handover from the chatbot to human support, in accordance with embodiments of the present disclosure. In this example, interface 800L provides a chat workflow design tool to hand off the chatbot to a human. For example, a chatbot can include can be designed to automatically handover to a CSA when the chatbot cannot answer the question.

FIG. 8M provides another example interface 800M of a chat workflow design tool of a chatbot tool of a customer support application for setting up a handover from the chatbot to a chat workflow, in accordance with embodiments of the present disclosure. In this example, interface 800M provides a chat workflow design tool to hand off the chatbot to a workflow. For example, a chat workflow can be designed to automatically implement a chat workflow (e.g., as designed in chat workflow design tool of example interface 800N of FIG. 8N) to request additional information from the customer before handing the chat over to a CSA when the chatbot cannot answer a question.

FIG. 8N provides another example interface 800N of a chat workflow design tool of a chatbot tool of a customer support application for designing a chat workflow, in accordance with embodiments of the present disclosure. In this example, interface 800N provides a chat workflow design tool following the hand off to a workflow of interface 800M of FIG. 8M. As can be understood, following handoff from the chatbot, a number of bots, triggers, conditions, and/or rules can be triggered to request additional information from the customer before passing the customer to a CSA.

FIG. 8O provides another example interface 800O of a chat workflow design tool of a chatbot tool of a customer support application for designing a chat workflow that implements the chatbot at a later block in the chat workflow instead of an initial block of a chat workflow, in accordance with embodiments of the present disclosure. In this example, interface 800O provides an example chat workflow implementing the chatbot that uses a language model to determine answers from a knowledge base at a later block in the workflow. For example, the chat workflow may determine whether the customer data indicates the customer is not a VIP customer that is automatically assigned to a CSA before implementing the chatbot that uses a language model to determine answers from a knowledge base.

FIG. 8P provides an example interface 800P of an inactive conversations settings tool, such as inactive conversations settings tool 177, of a chat workflow design tool of a chatbot tool of a customer support application for designing a chat workflow, in accordance with embodiments of the present disclosure. In this example, interface 800P provides an example inactive conversations settings. For example, inactive conversations settings may cause the chatbot to send auto-replies to snoozed conversations. As another example, inactive conversations settings may cause the chatbot to automate snoozing and set conversation pacing with new actions. As yet another example, inactive conversations settings may cause the chatbot to automatically reroute conversations that receive no response to a human, such as a CSA.

FIG. 8Q provides an example chat interface 800Q between a chatbot and a user showing a request for feedback, in accordance with embodiments of the present disclosure. In this example, chat interface 800Q provides a rating scale for a customer to rate the chatbot. FIG. 8R provides an example interface 800R of output from a chatbot analysis tool of a chatbot tool of a customer support application, in accordance with embodiments of the present disclosure. In this example, interface 800R utilizes the ratings from customers to provide overall CSAT and/or sentiment analysis of the chatbot. FIG. 8S provides another example interface 800S of output from a chatbot analysis tool of a chatbot tool of a customer support application, in accordance with embodiments of the present disclosure. In this example, interface 800S utilizes the ratings from customers to provide CSAT and/or sentiment analysis of the chatbot over a period of time.

FIG. 8T provides another example interface 800T of a chatbot analysis tool of a chatbot tool of a customer support application, in accordance with embodiments of the present disclosure. In this example, interface 800T enables a user to generate reports providing various metrics of the chatbot. For example, chatbot analysis tool of example interface 800T provides an interface for generating reports analyzing chatbot performance, such as through chatbot conversation monitoring, chatbot CSAT, usage metrics, usage limits notifications, performance/ROI metrics, custom reports, and/or content-level metrics

FIGS. 8U-Y provide example interfaces 800U-800Y of output from a chatbot analysis tool of a chatbot tool of a customer support application, in accordance with embodiments of the present disclosure. As can be understood, interfaces 800U-800Y provide output of various metrics regarding the ROI of the chatbot.

FIGS. 8Z-8AA provides example interfaces 800Z and 800AA of output from a chatbot analysis tool of a chatbot tool of a customer support application, in accordance with embodiments of the present disclosure. As can be understood, interfaces 800Z and 800AA provides results of performing AI analysis of customer support of an organization to analyze coverage of their customer satisfaction across all conversations.

FIG. 8BB provides example interface 800BB of output from a chatbot analysis tool of a chatbot tool of a customer support application, in accordance with embodiments of the present disclosure. As can be understood, interface 800BB provides results of performing AI analysis of customer support of an organization to identify areas of poor quality across all support for an organization to understand where improvement is needed for an AI agent and/or human interactions. In this regard, poor quality in conversations can be spotted across specific topics, channel, and/or teammates. Further, the analysis leverages AI analysis along with selected customer metrics (e.g., customer effort, waiting time, resolution time) to identify problem areas.

FIG. 8CC provides an example interface 800CC for general guidance of a chatbot tool of a customer support application, in accordance with embodiments of the present disclosure. As can be understood, interface 800CC allows a business to provide general guidance to a chatbot's behavior (e.g., chatbot component 151), such as based on company principles and values. For example, a company can upload a glossary of terms or a company handbook.

FIG. 8DD provides an example interface 800DD for external systems configuration of a chatbot tool of a customer support application, in accordance with embodiments of the present disclosure. As can be understood, interface 800DD allows businesses to integrate external systems for read and/or write operations by the chatbot (e.g., chatbot component 151).

FIG. 8EE provides an example interface 800EE for tone of voice configuration of a chatbot tool of a customer support application, in accordance with embodiments of the present disclosure. As can be understood, interface 800EE allows businesses to specify the tone of voice of the chatbot (e.g., chatbot component 151).

### Example Embodiments of Process Flows

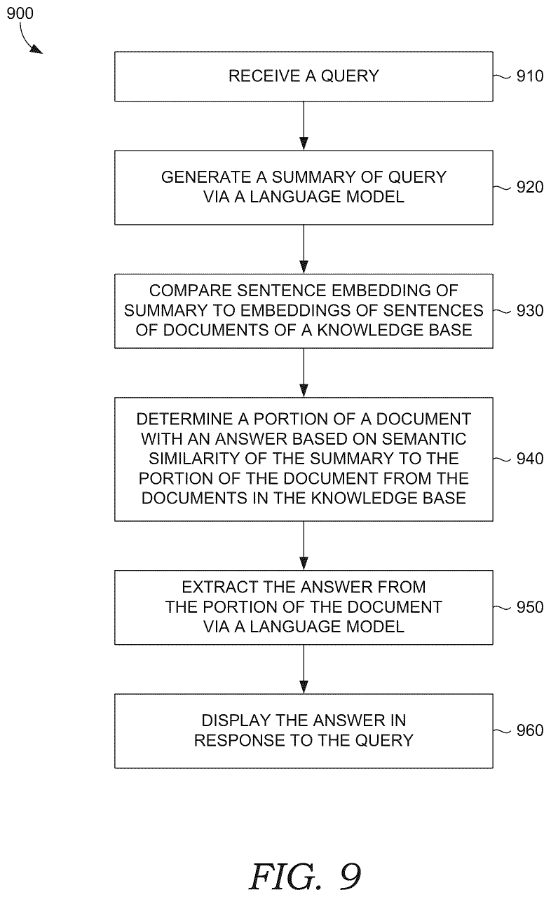

With reference now to FIGS. 9-13, flow diagrams are provided illustrating various methods. Each block of the methods 900-1300 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

FIG. 9 is a flow diagram showing a method 900 for implementing a specialized chatbot platform that uses language models to determine answers from knowledge bases, in accordance with embodiments of the present disclosure, in accordance with embodiments of the present disclosure. Initially, at block 910, a query is received. At block 920, a summary of the query is generated via language model. At block 930, a sentence embedding of the summary is compared with sentence embeddings of sentences of documents of a knowledge base. At block 940, a portion of a document with an answer is determined based on semantic similarity of the summary to the portion of the document from the documents in the knowledge base. At block 950, the answer is extracted from the portion of the document via the language model. At block 960, the answer is displayed in response to the query.

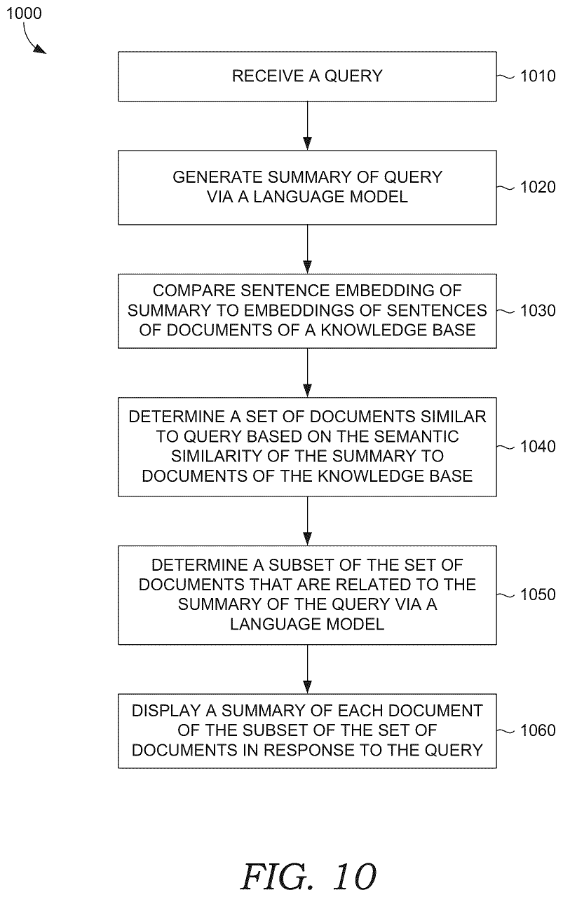

FIG. 10 is a flow diagram showing a method 1000 for implementing a chatbot using a language model to determine a subset of documents from a knowledge base in response to a user's query, in accordance with embodiments of the present disclosure. Initially, at block 1010, a query is received. At block 1020, a summary of the query is generated via language model. At block 1030, a sentence embedding of the summary is compared with sentence embeddings of sentences of documents of a knowledge base. At block 1040, a set of documents similar to the query is determined based on the semantic similarity of the summary to documents of the knowledge base. At block 1050, a subset of the set of documents that are related to the summary of the query are determined by the language model. At block 1060, a summary of each document of the subset of documents is displayed in response to the query.

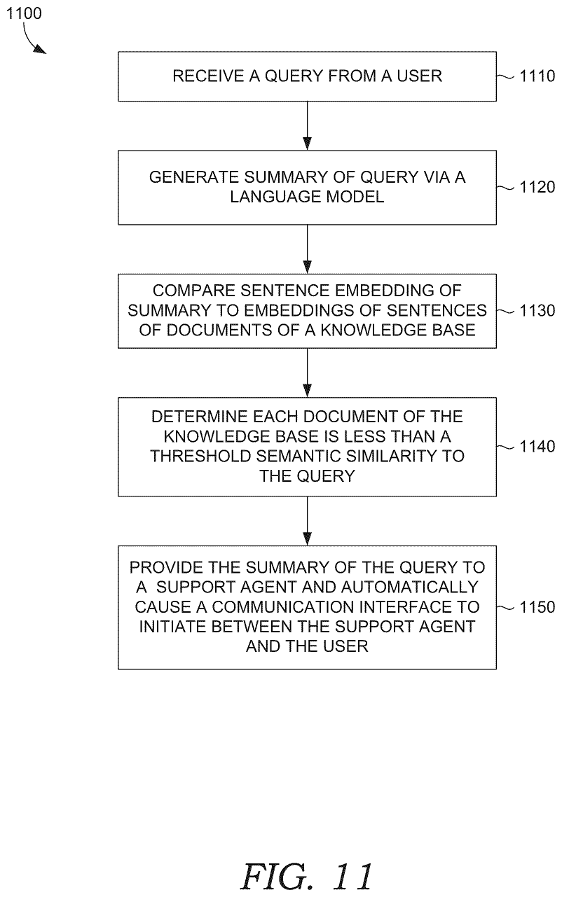

FIG. 11 is a flow diagram showing a method 1100 for implementing a specialized chatbot platform that uses language models to determine answers from knowledge bases and handing off the conversation to a human, in accordance with embodiments of the present disclosure. Initially, at block 1110, a query is received. At block 1120, a summary of the query is generated via language model. At block 1130, a sentence embedding of the summary is compared with sentence embeddings of sentences of documents of a knowledge base. At block 1140, each document of the knowledge base is determined to be less than a threshold semantic similarity to the query. At block 1150, a summary of the query is provided to a support agent and a communication interface is automatically initiated between the support agent and the user.

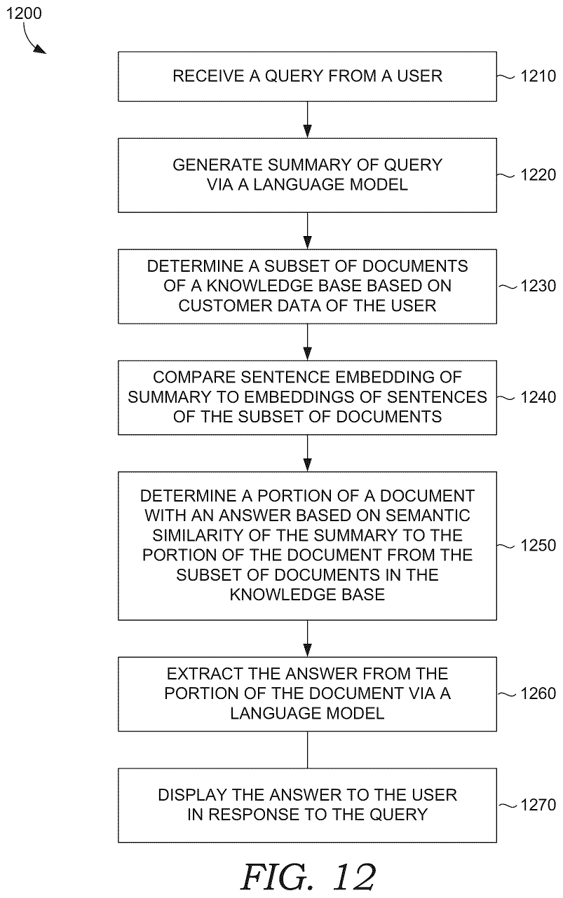

FIG. 12 is a flow diagram showing a method 1200 for implementing a specialized chatbot platform that uses language models to determine answers from knowledge bases based on customer data of the user, in accordance with embodiments of the present disclosure. Initially, at block 1210, a query is received from a user. At block 1220, a summary of the query is generated via language model. At block 1230, a subset of documents of a knowledge base is determined based on customer data of the user. At block 1240, a sentence embedding of the summary is compared with sentence embeddings of sentences of the subset of documents of the knowledge base. At block 1250, a portion of a document with an answer is determined based on semantic similarity of the summary to the portion of the document from the subset of documents in the knowledge base. At block 1260, the answer is extracted from the portion of the document via the language model. At block 1270, the answer is displayed to the user in response to the query.

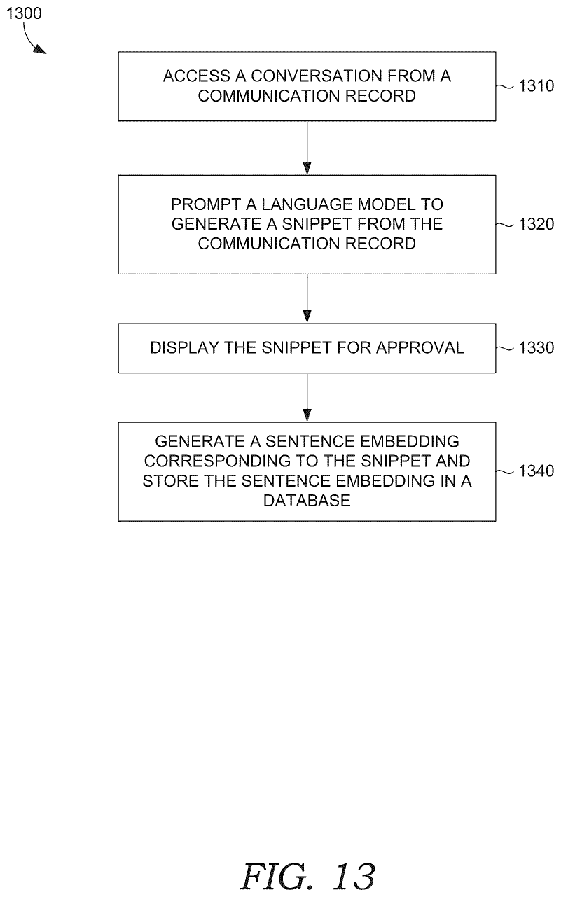

FIG. 13 is a flow diagram showing a method 1300 for using a language model to extract conversational snippets, in accordance with embodiments of the present disclosure. Initially, at block 1310, a conversation is accessed from a communication record. At block 1320, a language model is prompted to generate a snippet from the communication record. At block 1330, the snippet is displayed for approval. At block 1340, a sentence embedding corresponding to the snipped is generated and stored in a database.

### Example Operating Environments

Having briefly described an overview of aspects of the technology described herein, an exemplary operating environment in which aspects of the technology described herein may be implemented is described below in order to provide a general context for various aspects of the technology described herein. Referring to the drawings in general, and initially to FIG. 14 in particular, an exemplary operating environment for implementing aspects of the technology described herein is shown and designated generally as computing device 1400. Computing device 1400 is just one example of a suitable computing environment and is not intended to suggest any limitation as to the scope of use or functionality of the technology described herein. Neither should the computing device 1400 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 14, computing device 1400 includes a bus 1410 that directly or indirectly couples the following devices: memory 1412, one or more processors 1414, one or more presentation components 1416, input/output (I/O) ports 1418, I/O components 1420, an illustrative power supply 1422, and a radio(s) 1424. Bus 1410 represents what may be one or more busses (such as an address bus, data bus, or combination thereof). Although the various blocks of FIG. 14 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 14 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 14 and refer to “computer” or “computing device.”

Computing device 1400 typically includes a variety of computer-readable media. Computer-readable media can be any available media that can be accessed by computing device 1400 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1412 includes computer storage media in the form of volatile and/or nonvolatile memory. The memory 1412 may be removable, non-removable, or a combination thereof. Exemplary memory includes solid-state memory, hard drives, and optical-disc drives. Computing device 1400 includes one or more processors 1414 that read data from various entities such as bus 1410, memory 1412, or I/O components 1420. Presentation component(s) 1416 present data indications to a user or other device. Exemplary presentation components 1416 include a display device, speaker, printing component, and vibrating component. I/O port(s) 1418 allow computing device 1400 to be logically coupled to other devices including I/O components 1420, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1414 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 1400. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1400. The computing device 1400 may be equipped with depth cameras, such as stereoscopic camera systems, infrared camera systems, RGB camera systems, and combinations of these, for gesture detection and recognition. Additionally, the computing device 1400 may be equipped with accelerometers or gyroscopes that enable detection of motion. The output of the accelerometers or gyroscopes may be provided to the display of the computing device 1400 to render immersive augmented reality or virtual reality.

A computing device may include radio(s) 1424. The radio 1424 transmits and receives radio communications. The computing device may be a wireless terminal adapted to receive communications and media over various wireless networks. Computing device 1400 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computer-implemented method comprising:
accessing a conversation with a user;
determining, based on applying at least a portion of the conversation and a list of available actions of a start state agent to a language model, to initiate a search for answers state by:
generating, based on applying at least the portion of the conversation to the language model, a representation summarizing at least the portion of the conversation; and
generating an embedding corresponding to the representation; determining a response based on computing similarity of the embedding corresponding to the representation to each of a plurality of embeddings corresponding to a plurality of sentences of a plurality of documents in a knowledge base;
subsequent to causing communication of a corresponding representation of the response, causing communication of a request for feedback; and
determining, based on applying a corresponding response to the request for feedback and a different list of available actions of a feedback state agent to the language model, to end the conversation with the user, re-initiate the start-state agent or initiate a chat between a support agent and the user.

2. The computer-implemented method of claim 1, further comprising:
extracting the response from at least one of the plurality of sentences of the plurality of documents in the knowledge base, wherein the corresponding representation of the response comprises the extracted response.

3. The computer-implemented method of claim 1, further comprising:
extracting the response from at least one of the plurality of sentences of the plurality of documents in the knowledge base, wherein the corresponding representation of the response comprises the extracted response and a link to a corresponding document from the plurality of documents.

4. The computer-implemented method of claim 1, further comprising:
extracting the response from at least one of the plurality of sentences of the plurality of documents in the knowledge base; and
generating, based on applying at least a portion of the response to the language model, the corresponding representation of the response summarizing the response.

5. The computer-implemented method of claim 1, further comprising:
determining the plurality of documents in the knowledge from a larger set of documents in the knowledge base based on customer data for the user.

6. The computer-implemented method of claim 1, further comprising:
subsequent to causing communication of the corresponding representation of the response, receiving a subsequent communication from the user; and
responsive to determining an updated embedding corresponding to the subsequent communication is less than a threshold semantic similarity to each of the plurality of embeddings, causing communication of a request for clarification.

7. The computer-implemented method of claim 1, further comprising:
subsequent to causing communication of the corresponding representation of the response, receiving a subsequent communication from the user; and
responsive to determining an updated embedding corresponding to the subsequent communication is less than a threshold semantic similarity to each of the plurality of embeddings, causing communication of a prompt to initiate the chat between the support agent and the user.

8. The computer-implemented method of claim 1, wherein the request for feedback comprises a corresponding request to rate the conversation.

9. The computer-implemented method of claim 1, wherein the embedding is generated using Sentence Bidirectional Encoder Representations from Transformers (“SBERT”).

10. A non-transitory computer-readable medium storing executable instructions, which when executed by a processing device, cause the processing device to perform operations comprising:
accessing a conversation with a user;
determining, based on applying at least a portion of the conversation and a list of available actions of a start state agent to a language model, to initiate a search for answers state by:
generating, based on applying at least the portion of the conversation to a language model, a representation summarizing at least the portion of the conversation;
generating an embedding corresponding to the representation; and
determining a subset of documents within a threshold similarity to the representation based on computing similarity of the embedding corresponding to the representation to each of a plurality of embeddings corresponding to a plurality of sentences of a plurality of documents in a knowledge base;
subsequent to causing communication of a corresponding representation of each document of the subset of documents, causing communication of a request for feedback; and
determining, based on applying a corresponding response to the request for feedback and a different list of available actions of a feedback state agent to the language model, to end the conversation with the user, re-initiate the start-state agent or initiate a chat between a support agent and the user.

11. The media of claim 10, the operations further comprising:
extracting at least a portion of each document of the subset of documents, wherein the corresponding representation of the response comprises at least the portion of each document of the subset of documents.

12. The media of claim 10, the operations further comprising:
extracting at least a portion of each document of the subset of documents, wherein the corresponding representation of the response comprises at least the portion of each document of the subset of documents and a link to each document of the subset of documents.

13. The media of claim 10, the operations further comprising:
extracting at least a portion of each document of the subset of documents; and
generating, based on applying at least the portion of each document of the subset of documents to the language model, the corresponding representation of each document of the subset of documents summarizing at least the portion of each document of the subset of documents.

14. The media of claim 10, the operations further comprising:
determining the plurality of documents in the knowledge from a larger set of documents in the knowledge base based on customer data for the user.

15. The media of claim 10, the operations further comprising:
determining the subset of documents from a larger set of documents of the plurality of documents in the knowledge base based on applying at least the portion of each document of the larger set of documents to the language model.

16. The media of claim 10, wherein the embedding is generated using Sentence Bidirectional Encoder Representations from Transformers (“SBERT”).

17. A computing system comprising:
a processor; and
a non-transitory computer-readable medium having stored thereon instructions that when executed by the processor, cause the processor to perform operations including:
accessing a conversation with a user;
determining, based on applying at least a portion of the conversation and a list of available actions to a language model, to initiate a search for answers state by:
generating, based on applying at least the portion of the conversation to a language model, a representation summarizing at least the portion of the conversation;
generating an embedding corresponding to the representation; and
computing a similarity of the embedding corresponding to the representation to each of a plurality of embeddings corresponding to a plurality of sentences of a plurality of documents in a knowledge base; and
responsive to determining the similarity of the embedding corresponding to the representation to each of the plurality of embeddings is less than a threshold similarity, causing communication of a request for clarification.

18. The system of claim 17, the instructions that when executed by the processor, cause the processor to perform the operations further including:
subsequent to causing communication of the request for clarification, receiving a subsequent communication from the user; and
responsive to determining an updated embedding corresponding to the subsequent communication is within a threshold semantic similarity to at least one of the plurality of embeddings:
determining a response based on at least one of the plurality of embeddings and causing communication of the response;
causing communication of a request for feedback; and
determining, based on applying a corresponding response to the request for feedback and a different list of available actions to the language model, to end the conversation with the user, re-initiate a start-state agent or initiate a chat between a support agent and the user.

19. The system of claim 17, the instructions that when executed by the processor, cause the processor to perform the operations further including:
subsequent to causing communication of the request for clarification, receiving a subsequent communication from the user; and
responsive to determining an updated embedding corresponding to the subsequent communication is less than a threshold semantic similarity to each of the plurality of embeddings, causing communication of a prompt to initiate a chat between a support agent and the user.

20. The system of claim 17, wherein the embedding is generated using Sentence Bidirectional Encoder Representations from Transformers (“SBERT”).
